(19) United States
(12) Patent Application Publication
(10) Pub. No.: US 2026/0310382 A1
(43) Pub. Date: Oct. 8, 2026

(54) METHODS AND APPARATUS FOR MEMORY DEVICES AND MEMORY CONTROLLERS

(71) Applicant: Intel Products IP LLC, Santa Clara, CA (US)

(72) Inventors: Saravanan SETHURAMAN, Portland, OR (US); James Alexander MCCALL, Portland, OR (US); Christopher P. MOZAK, Portland, OR (US); Alex Peter THOMAS, Folsom, CA (US)

(21) Appl. No.: 19/697,637

(22) Filed: Jun. 4, 2026

Related U.S. Application Data
(60) Provisional application No. 64/045,060, filed on Apr. 21, 2026.

(51) Int. Cl. G06F 3/06

(52) U.S. Cl. CPC G06F 3/0659; G06F 3/0604; G06F 3/0679

(57) ABSTRACT

A memory device, including: a plurality of data lanes configured to receive write data from a memory controller; processing circuitry configured to compare, for each data lane of the plurality of data lanes, write data received on the data lane against a respective expected data pattern to determine a respective per-lane error indication; and one or more status registers configured to store the per-lane error indications, wherein the per-lane error indications are accessible to the memory controller.

### CROSS-REFERENCE TO RELATED APPLICATIONS

This application claims priority to U.S. Provisional Application No. 64/045,060 filed on Apr. 21, 2026, which is incorporated by reference herein in its entirety.

### BACKGROUND

Computing systems rely on main memory (e.g., a volatile memory) to store instruction streams and data operands that are processed by one or more processor cores. A memory controller, which may be integrated into a processor die or implemented as a discrete component of the system, issues read operations and write operations to one or more memory devices over a physical memory channel. The physical channel comprises a set of signal conductors that carry data, addressing information, and control signals between the memory controller and each memory device. As operating data rates increase, the electrical characteristics of the physical channel, including signal attenuation, timing variation across conductors, and noise coupling between adjacent conductors, impose constraints on the reliable transfer of data. To achieve reliable data transfer at high data rates, calibration of transmission parameters used by the memory controller for the physical channel between the memory controller and the memory device may be desirable, especially when driving write data onto the channel.

Calibration of the physical write data link can be performed by having the memory controller transmit known data patterns to the memory device while sweeping one or more controller-side transmission parameters across a range of candidate settings, and by observing whether the memory device correctly receives the transmitted data at each parameter setting. The parameter setting or settings associated with reliable reception may then be retained for use during normal system operation. Existing training schemes can present limitations in the granularity of error visibility available to the memory controller, in the flexibility with which calibration can be applied across different phases of memory device operation, and in the efficiency with which calibration sequences can be re-invoked after initial system startup.

### BRIEF DESCRIPTION OF FIGURES

In the drawings, like reference characters generally refer to the same parts throughout the different views. The drawings are not necessarily to scale, emphasis instead generally being placed upon illustrating the principles of the disclosure. In the following description, various aspects of the disclosure are described with reference to the following drawings, in which:

FIG. 1 illustrates an example of a computing system;

FIG. 2 illustrates an example of a memory controller;

FIG. 3 illustrates an example of a memory device;

FIG. 4 illustrates an example of a physical receive interface of a DRAM device;

FIG. 5 illustrates an example internal architecture of a DRAM device;

FIG. 6 illustrates an example of a write data training mode sequence as described herein;

FIG. 7 illustrates a timing diagram with respect to the pattern associated with the write data training mode described herein;

FIG. 8 illustrates an example of mode register layout;

FIG. 9 illustrates an example of mode register layout;

FIG. 10 illustrates an example 24-bit Galois LFSR circuit and its corresponding timing diagram;

FIG. 11 illustrates an example of an LFSR circuit;

FIG. 12 shows an example of Fibonacci LFSR-24 pattern details;

FIG. 13A and FIG. 13B show an example of a Fibonacci LFSR circuit;

FIG. 14A and FIG. 14B show an example of Write DQ Training Mode Timing.

FIG. 15 shows an example of Fibonacci LFSR-24 pattern details for the HTM;

FIG. 16A and FIG. 16B show an example of HRT timing;

FIG. 17 shows an example of HRT timing;

FIG. 18 shows an example of a method;

FIG. 19 shows an example of a method;

FIG. 20 shows an example of a method;

FIG. 21 shows an example of a method.

### DESCRIPTION

The present disclosure relates generally to memory systems and, more particularly, to methods and devices of memory systems, and to the training and calibration of a write data link between a memory controller and a memory device. Aspects described herein can address mechanisms by which a memory device participates in the calibration process through error detection during training, providing the memory controller with visibility into the quality of data received over the write data link.

A memory system may comprise a memory controller and one or more memory devices coupled to the memory controller via a physical memory channel. The memory controller may be integrated into a processor or system-on-chip (SoC) die, in which case the memory controller may be referred to as an integrated memory controller, or the memory controller may be implemented as a discrete component. A memory device may be organized internally into a plurality of banks, each bank comprising a two-dimensional array of memory cells addressed by rows and columns. Selected memory cells (e.g., a selected row of memory cells) may be activated into a row buffer comprising sense amplifiers, from which column-level access operations may subsequently read or write data. The memory device may further be organized into bank groups, allowing interleaved access across multiple banks, which may contribute to reducing the effect of per-bank timing constraints on overall data throughput.

Data transfer between a memory controller and a memory device may be conducted over an interface (e.g., a parallel source-synchronous interface) comprising a plurality of data conductors and one or more strobe or clock conductors. Each data conductor may carry one bit of data per unit interval (UI), where a UI corresponds to one bit period at the operating data rate of the interface. A group of consecutive UIs carrying data from the memory controller to the memory device can constitute a burst of write data, and the number of UIs in such a burst is referred to as the burst length. The strobe or clock conductor provides a timing reference that the memory device uses to sample incoming data at each UI boundary. Modern memory interfaces operate at data rates of multiple gigatransfers per second, so that each UI spans a fraction of a nanosecond and the timing relationship between each data conductor and the strobe or clock conductor must be maintained within tight margins.

At multi-gigatransfer-per-second data rates, the physical channel between the memory controller and the memory device can introduce signal integrity effects that degrade the quality of received signals. These effects include insertion loss due to conductor resistance and dielectric absorption, inter-symbol interference arising from the finite bandwidth of the channel, crosstalk from electromagnetic coupling between adjacent conductors, and reflection from impedance discontinuities in the transmission path. The resulting effect of these phenomena can be a reduction in the voltage and timing margins available at the receiver of the memory device, commonly described in terms of the opening of the signal eye at the sampling point. To maintain adequate margins at high data rates, the physical layer of the memory device may incorporate equalization circuits, such as decision feedback equalization, and the memory controller transmitter may apply equalization techniques, such as pre-emphasis, de-emphasis, or other equalization techniques. The settings of these equalization circuits and of other transmitter parameters, including drive strength, reference voltage, and transmit timing offset, may be calibrated to the electrical characteristics of the specific physical channel present in a given computing system.

Memory devices include one or more configuration registers, which may be referred to as mode registers. Mode registers may govern operating modes and parameters of the memory device. Mode registers may also store device status information. The memory controller may write to a configuration register by issuing a configuration-register command of a write type, and may read from a configuration register by issuing a configuration-register command of a read type. In DDR-class memory devices, these commands may be referred to as mode register write (MRW) and mode register read (MRR) commands, respectively. Configuration-register commands can be transmitted over the command and address conductors (e.g., lines) of the memory channel and are decoded by the memory device independently of data transfers on the data conductors. Memory systems may be deployed with a direct coupling between the memory controller and the memory device, or with one or more intermediate components, such as a registering clock driver or a data buffer, interposed between the memory controller and the memory device on the memory channel. Such intermediate components may relay or re-drive signals between the memory controller and the memory device without altering the logical content of configuration-register commands or write data bursts.

The term “memory device” may refer to any electronic component configured to store data and to respond to read and write access commands issued by a memory controller. A memory device may be, or may include, a dynamic random-access memory (DRAM) device. A DRAM device may be, or may include, a DDR5 DRAM device, an LPDDR5 DRAM device, a DDR6 DRAM device, an LPDDR6 DRAM device, or a future version of DDR DRAM device (e.g., DDR7 DRAM device).

The term “memory controller” may refer to any circuitry configured to issue read operations, write operations, and configuration-register commands to a memory device over a physical memory channel. A memory controller may be, or may include, an integrated memory controller implemented on a processor die or a system-on-chip die, or a discrete memory controller component.

The term “computing system” may refer to any system including at least one memory controller and at least one memory device coupled to the memory controller. A computing system may be, or may include, a server system, a client computing system, a mobile computing system, or an embedded computing system. In various aspects described herein, the memory device may be a DDR6 DRAM device, the memory controller may be an integrated memory controller on a processor or SoC die, and the computing system may include one or more such memory controllers and one or more such memory devices coupled via a physical memory channel.

The term “data lane” may refer to any signal-carrying path between a memory controller and a memory device that is used for the transfer of one or more bits of data per unit interval in at least one direction. A plurality of data lanes may together constitute a parallel data interface between the memory controller and the memory device. In various aspects described herein, a data lane may further be, or may include, a DQ lane, for example a signal path associated with a DQ pin of a DDR-class DRAM device. A plurality of data lanes may form a sub-channel of the memory interface, for example a 24-bit sub-channel in which twenty-four data lanes transfer data in parallel per unit interval. The plurality of data lanes may be organized into one or more sub-channels, and a memory device may expose one or more sub-channels to the memory controller.

The term “write data” may refer to data transmitted by a memory controller to a memory device over a plurality of data lanes for the purpose of storing the data in the memory device or for the purpose of calibrating the write data link during a training operation. The term “burst of write data” may refer to a sequence of write data transmitted over a plurality of data lanes across a plurality of consecutive unit intervals. The term “unit interval” (UI) may refer to one bit period at the operating data rate of the interface between the memory controller and the memory device, corresponding to the time allocated to the transfer of one bit on a data lane. The term “burst length” (BL) may refer to the number of unit intervals including a burst. In various aspects described herein, the burst length may be 24 (BL24), and write data may be transferred as a burst of write data during a write data training mode of the memory device.

The term “write data training mode” (abbreviated as WDTM or WTM) may refer to a designated operating mode of a memory device. In this mode, the memory device may participate in calibration of the write data link from a memory controller to the memory device. In various aspects described herein, the write data training mode may further be entered and exited by one or more configuration-register commands issued by the memory controller to the memory device. The write data training mode may coexist with normal memory operation by means of explicit mode transitions, and may be invoked during an initialization phase of a computing system or during a mission mode of the memory device.

In some further aspects described herein, the term “host receiver training mode” may refer to a designated operating mode of a memory device in which the memory device drives training pattern data onto a plurality of data lanes. The memory device may drive the training pattern data in response to one or more read commands received from a memory controller. In the host receiver training mode, the memory controller may receive the training pattern data driven by the memory device and may determine, within the memory controller, whether the received training pattern data matches an expected data pattern. In an example, the host receiver training mode may be entered and exited by one or more configuration-register commands issued by the memory controller to the memory device. The host receiver training mode may coexist with normal memory operation by means of explicit mode transitions, and may be invoked during an initialization phase of a computing system or during a mission mode of the memory device.

In some further aspects described herein, training mode, as used broadly herein, may be, or may include, the write data training mode, the host receiver training mode, or both. The host receiver training mode may be implemented in combination with the write data training mode in a single memory device, or may be implemented independently of the write data training mode. Similarly, a memory controller may include circuitry supporting the write data training mode, the host receiver training mode, or both. The host receiver training mode addresses calibration of the read data link from the memory device to the memory controller, whereas the write data training mode addresses calibration of the write data link from the memory controller to the memory device. In various aspects described herein, the host receiver training mode may further be referred to as HRT mode, and the memory device may be a DDR6 DRAM device supporting the host receiver training mode as described herein.

In some further aspects described herein, the term “training pattern data” may refer to data generated within a memory device and driven by the memory device onto a plurality of data lanes during the host receiver training mode. The memory controller may evaluate reception quality at the receiver circuits of the memory controller based on the training pattern data. Training pattern data may be, or may include, a pseudo-random bit sequence generated by pattern-generation circuitry within the memory device, or a user-defined read pattern stored in one or more configuration registers of the memory device. The term “user-defined read pattern” may refer to a data pattern stored in one or more configuration registers of the memory device and driven onto the data lanes during the host receiver training mode when selected in preference to the pseudo-random bit sequence. A user-defined read pattern may be, or may include, a clock pattern.

In some further aspects described herein, In various aspects described herein, write data may be transmitted by the memory controller to the memory device over the plurality of data lanes, whereas training pattern data may be driven by the memory device to the memory controller over the plurality of data lanes. In some aspects, the expected data pattern may be a reference pattern against which received data is compared to determine an error indication, whereas training pattern data may be the data actually driven on the data lanes during the host receiver training mode. In various aspects described herein, when the host receiver training mode uses a pseudo-random bit sequence as the training pattern data, the memory controller may hold or generate a corresponding expected data pattern within the memory controller for comparison against the received training pattern data.

The term “expected data pattern” may refer to a data pattern that is known within the memory device, against which write data received on a data lane may be evaluated to determine whether the received data matches the expected data pattern. The matching may correspond to being equal to, having the best correlation among a set of candidate data, or similar metrics representing similarity. An expected data pattern may be generated internally to the memory device, which may be common across a plurality of data lanes, or may differ between data lanes of the plurality of data lanes. In various aspects described herein, an expected data pattern may be, or may include, a pseudo-random bit sequence or a clock pattern. An expected data pattern that is common to all data lanes may be used, for example, when a clock pattern is selected. An expected data pattern that differs between data lanes may be used, for example, when a pseudo-random bit sequence is generated from different combinations of outputs of a shared pattern-generation circuit.

The term “error indication” may refer to any signal, flag, count, status bit, register field, or equivalent representation that indicates a detected mismatch between write data received on a data lane and an expected data pattern. The term “phase-specific error indication” may refer to an error indication associated with a specified subset of unit intervals within a burst of write data, the subset corresponding to a particular phase or timing position within the burst. A per-lane error indication may refer to an error indication corresponding to a respective data lane of the plurality of data lanes, determined based on a comparison of write data received on that data lane with a respective expected data pattern. In various aspects described herein, an error indication may include a plurality of per-lane error indications, each corresponding to a respective data lane of the plurality of data lanes. Each per-lane error indication may further include a plurality of phase-specific error indications, each associated with a respective subset of unit intervals of a burst of write data. An error indication may be represented as a status bit, an error count value, or a combination thereof, and may be made accessible to the memory controller by any suitable mechanism.

The term “configuration register” may refer to an addressable register within a memory device that stores information governing an operating mode or parameter of the memory device, or that stores status information produced by the memory device. The term “configuration-register command” may refer to a command issued by a memory controller to read from or write to a configuration register of the memory device. A configuration-register command may be, or may include, an MRW command or an MRR command, as used in DDR-class DRAM devices. The term “configuration-register read command” may refer to a configuration-register command that causes the memory device to provide the contents of a configuration register to the memory controller. In various aspects described herein, configuration-register commands may be used to enter or exit the write data training mode, to select or program pattern-generation parameters, to read out error indications, and to clear error indications stored in the memory device.

The term “pseudo-random bit sequence” (PRBS) may refer to a deterministic sequence of bits that exhibits statistical properties approximating those of a random binary sequence over the period of the sequence, while being reproducible from a known initial state. In various aspects described herein, a pseudo-random bit sequence may be generated by a LFSR configured with a specified characteristic polynomial and initial state. A pseudo-random bit sequence may have a period determined by the degree and polynomial of the LFSR generating the sequence, for example a period of 2¹⁶−1 for a 16-bit LFSR or a period of 2²⁴−1 for a 24-bit LFSR.

The term “linear feedback shift register” (LFSR) may refer to a shift register whose input bit is a linear function of its previous state. The LFSR may be a shift register of n flip-flops whose next-state function is computed as a linear combination, using exclusive-OR (XOR) operations, of selected flip-flop outputs, referred to as taps, as defined by a characteristic polynomial of degree n. A Fibonacci LFSR may refer to an implementation in which the XOR operations are applied to selected tap outputs and the result is fed back to the input of the shift register. A Galois LFSR may refer to an alternative implementation in which the feedback is distributed across intermediate stages. A Fibonacci LFSR and a Galois LFSR can implement the same characteristic polynomial produce equivalent output sequences up to a state mapping. In various aspects described herein, the LFSR may be a 24-bit LFSR implementing the polynomial X²⁴+X²⁰+X¹¹+X⁵+1, or may be a 16-bit LFSR. The LFSR may be a Fibonacci LFSR. The LFSR may be shared among a plurality of data lanes, and different data lanes may receive expected data patterns derived from different XOR combinations of taps of the shared LFSR.

The term “clock pattern” may refer to a periodic alternating bit sequence, for example a sequence of the form 010101 . . . or 101010 . . . , used as a calibration stimulus on one or more data lanes during a write data training mode. The term “transmit parameter setting” may refer to a setting of a transmitter of the memory controller that influences a characteristic of a signal transmitted on a data lane, including but not limited to transmitter drive strength, pre-emphasis coefficient, de-emphasis coefficient, equalization coefficient, reference voltage, transmit phase or timing offset, and output impedance. In various aspects described herein, a memory controller may iterate over a plurality of transmit parameter settings and, for each transmit parameter setting, cause a burst of write data to be transmitted to the memory device and read a corresponding error indication from the memory device, so as to identify a transmit parameter setting associated with reliable data reception at the memory device.

In some further aspects described herein, the term “receiver parameter setting” may refer to a setting of a receiver of the memory controller that influences a characteristic of a signal received on a data lane, including but not limited to receiver timing offset, reference voltage, decision feedback equalization coefficient, receiver bias current, and input termination impedance. A receiver parameter setting may be, or may include, a setting of the receiver circuits within the physical layer circuit of the memory controller.

In some further aspects described herein, the memory controller may iterate over a plurality of receiver parameter settings during the host receiver training mode and, for each receiver parameter setting, issue one or more read commands to the memory device to cause the memory device to drive training pattern data, receive the training pattern data at the receiver circuits, and determine a corresponding error indication within the memory controller, so as to identify a receiver parameter setting associated with reliable data reception at the memory controller. For example, in the write data training mode, the memory controller iterates over transmit parameter settings and accesses error indications from the memory device, whereas in the host receiver training mode, the memory controller iterates over receiver parameter settings and determines error indications within the memory controller. A receiver parameter setting may be adjusted on a per-lane basis or on a per-sub-channel basis within the physical layer circuit of the memory controller.

In some further aspects described herein, various aspects described herein address the calibration of the read data link from a memory device to a memory controller, complementary to the calibration of the write data link addressed by the write data training mode. In the write data training mode, the memory controller transmits write data to the memory device and the memory device determines an error indication based on the received write data and an expected data pattern, as described herein. In the host receiver training mode, the memory device drives training pattern data onto the plurality of data lanes in response to read commands issued by the memory controller, and the memory controller receives the training pattern data and determines, within the memory controller, an error indication based on the received training pattern data and an expected data pattern. The memory controller may adjust receiver parameter settings of the memory controller based on the error indication determined during the host receiver training mode. By sweeping across a plurality of receiver parameter settings and collecting corresponding error indications, the memory controller may identify receiver parameter settings associated with reliable reception of training pattern data over the read data link and may retain those settings for use during normal system operation. The host receiver training mode may be invoked during an initialization phase of a computing system to establish initial receiver parameter settings, and may additionally or alternatively be invoked during a mission mode of the memory device, for example to compensate for receiver drift during sustained operation. The host receiver training mode may support robust link performance across multiple operating modes and may contribute to reduced overall training time by enabling calibration of both the write data link and the read data link.

In some further aspects described herein, a memory device may implement only the write data training mode, only the host receiver training mode, or both the write data training mode and the host receiver training mode. A memory controller may implement circuitry for the write data training mode, circuitry for the host receiver training mode, or circuitry for both. A computing system may include a memory device and a memory controller that both support both modes, or that each support only one of the two modes. The circuitry of the memory device configured to drive training pattern data onto the data lanes in the host receiver training mode may operate independently of any circuitry configured to determine an error indication based on write data received from the memory controller in the write data training mode. The pattern-generation circuitry, the serializer, the driver circuits, and the configuration registers associated with the host receiver training mode within the memory device may be present and operational regardless of whether the memory device additionally includes comparison circuitry for the write data training mode. Similarly, the circuitry (i.e., the processing circuitry) of the memory controller configured to receive training pattern data and determine an error indication within the memory controller during the host receiver training mode may operate independently of any circuitry configured to transmit write data and access an error indication from the memory device during the write data training mode. The receiver parameter control logic, the expected data pattern source, and the comparison logic associated with the host receiver training mode within the memory controller may be present and operational regardless of whether the memory controller additionally includes transmit parameter sweep logic for the write data training mode.

The technical background includes the following:
Initial DQ link training is critical in multiple aspects:
   Link perf with multiple modes to enhance input-output (IO) scaling
   Training time in system
DDR6 requires pattern capability for initial IO settings from DDR5/LPDDR6:
   Pattern type needs to increase robustness for signal integrity (SI)/power delivery (PD)/silicon (Si) interactions
   Flexibility in depth and error averaging (to optimized accuracy/time)
DQ LFSR (16-bit) is different from command/address (CA) LFSR (16-bit) and is not shared:
   x3 will share LFSR pattern to reduce DRAM overhead.

Various aspects described herein address the determination, within a memory device, of an error indication based on write data received on a data lane and an expected data pattern, such that the error indication is accessible to the memory controller. When a memory controller transmits write data to a memory device over a plurality of data lanes, the memory controller does not, in general, have direct visibility into the quality of reception at the memory device side of each data lane. The memory controller is limited in its ability to identify which data lanes or which transmit parameter settings are associated with reception errors, and in what granularity such errors can be localized. In aspects described herein, the memory device includes processing circuitry configured to determine, for a data lane of the plurality of data lanes, an error indication based on write data received on that data lane and an expected data pattern known within the memory device. The processing circuitry may compare, for each data lane of the plurality of data lanes, write data received on that data lane against a respective expected data pattern, and to determine a respective per-lane error indication. The per-lane error indications may be stored in one or more status registers of the memory device and are accessible to the memory controller. The expected data pattern may be common across the plurality of data lanes, for example when a clock pattern is used as the calibration stimulus, or may differ between data lanes, for example when different combinations of outputs of a shared pattern-generation circuit are applied to respective data lanes. The error indication is made accessible to the memory controller by any suitable mechanism, enabling the memory controller to obtain per-data-lane information regarding the quality of write data reception at the memory device and to use that information when selecting transmit parameter settings for the write data link.

Various aspects can address the structure of a write data training mode that can be entered and exited under control of the memory controller using configuration-register commands. These aspects can support iterative sweeping of transmit parameter settings with per-lane error readout and clearing, during either an initialization phase or a mission mode of the memory device. A training mechanism that employs dedicated physical signaling paths or that can only be invoked at system startup imposes constraints on system design and limits the ability to compensate for link parameter drift that may occur during sustained operation. In aspects described herein, an operation mode, which is referred to as the write data training mode, is entered by one or more configuration-register commands issued by the memory controller to the memory device, and is exited by one or more configuration-register commands. During the write data training mode, the memory controller may select an expected data pattern type, program pattern-generation parameters, and transmit successive bursts of write data indicative of corresponding data patterns to the memory device using different respective transmit parameter settings. The memory device can determine error indications on a per-lane basis and make those error indications accessible to the memory controller, which may read and subsequently clear them via configuration-register commands before proceeding to the next transmit parameter setting. The write data training mode may be invoked during an initialization phase of a computing system and may also be invoked periodically during a mission mode of the memory device, for example to compensate for drift in link parameters or end-of-life degradation of the physical channel.

Various aspects described herein address the generation, within the memory device, of expected data patterns for a plurality of data lanes from a single shared pattern-generation circuit whose outputs are combined differently per data lane. Providing independent expected data patterns to each of a plurality of data lanes by instantiating a separate pattern-generation circuit per data lane results in a proportional increase in circuit area, power consumption, and gate count within the memory device. In aspects described herein, the memory device includes pattern-generation circuitry shared among the plurality of data lanes, configured to provide respective expected data patterns to different data lanes based on different respective combinations of outputs of the pattern-generation circuitry. In one embodiment, the pattern-generation circuitry may include a LFSR, as defined above, having a width of 16 bits, 24 bits, or another suitable width. The LFSR may be a Fibonacci LFSR, and taps of the LFSR may be combined by XOR operations in different combinations for different data lanes, exploiting the property that for a Fibonacci LFSR, the XOR of any two tap outputs produces another tap output of the same characteristic polynomial. This arrangement allows a single LFSR per sub-channel domain to supply independent pseudo-random bit sequence patterns to multiple data lanes without requiring separate LFSR instances per data lane, reducing gate count and die area within the memory device.

Various aspects described herein address the partitioning of a per-lane error indication into a plurality of phase-specific error indications, each associated with a respective subset of unit intervals within a burst of write data, combined with iterative sweeping of transmit parameter settings by the memory controller. In aspects described herein, each per-lane error indication includes a plurality of phase-specific error indications, where each phase-specific error indication is associated with a respective subset of the unit intervals of the burst of write data. The memory controller may transmit a plurality of successive bursts of write data to the memory device, each burst corresponding to a different transmit parameter setting, and may access respective error indications from the memory device after each burst, so as to build a phase-resolved map of reception quality as a function of the transmit parameter setting. This phase-resolved information enables the memory controller to identify failing phases with higher resolution than a single aggregate error indication would permit, and supports accurate calibration of per-phase sampling points within the memory device. The write data training mode supporting this aspect may be invoked during an initialization phase of a computing system and additionally during a mission mode of the memory device.

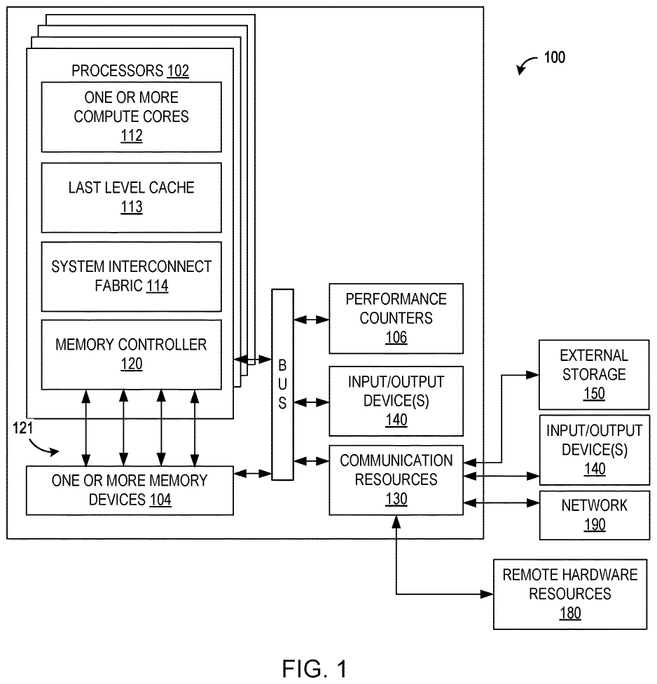

FIG. 1 illustrates a computing system 100 in accordance with various aspects described herein. The computing system 100 typically includes a system of interconnected hardware and software resources configured to execute instructions, process data, and manage the allocation of computational capabilities. The computing system 100 may be a server, a workstation, a cluster of servers, a data center, a mobile computing platform, a client computing device, or a cloud computing infrastructure. External storage 150, network 190, external input and output devices 140, and remote hardware resources 180 connect to the hardware resources via the communication resources 130 and input and output devices 140.

The computing system 100 includes a processor 102, a memory controller 120, and one or more memory devices 104 coupled to the memory controller 120 via a physical memory channel 121. The computing system 100 may further include a bus, communication resources 130, and one or more input/output devices 140. The processors 102 represent the computational core of the computing system 100 and each processor among the processors 102 may integrate a cache hierarchy and a memory controller interface through which the processor 102 initiates memory transactions directed to the one or more memory devices 104.

The processors 102 may include one or more physical processing units. Each processing unit among the processors 102 may constitute a central processing unit, a microprocessor, a digital signal processor, or a graphics processing unit configured to perform general-purpose computing tasks. The processors 102 may include, for example, one or a combination of: a central processing unit (CPU), a reduced instruction set computing (RISC) processor, a complex instruction set computing (CISC) processor, a graphics processing unit (GPU), a DSP, an ASIC, an FPGA, a microprocessor or controller, a multi-core processor, a multithreaded processor, an ultra-low voltage processor, an embedded processor, an xPU, a data processing unit (DPU), an Infrastructure Processing Unit (IPU), a network processing unit (NPU), another processor (including any of those discussed herein), and/or any suitable combination thereof.

Each processor among the processors 102 communicates with the one or more memory devices 104 through a memory controller that manages command scheduling, address mapping, rank selection, refresh management, and coordination of data transfers, incorporating timing control logic that enforces the temporal constraints imposed by the memory interface specification. The memory controller may include a data interface having a designated data width and a read data strobe input through which the memory controller receives timing reference signals from the one or more memory devices 104, using those timing reference signals to determine the correct sampling instants for data received on the data interface.

In some examples, the one or more processors 102 may execute instructions (e.g., non-transitory computer-readable instructions). Instructions may include software, program code, application(s), applet(s), an app(s), firmware, microcode, machine code, and/or other executable code for causing at least any one of the processors 102 to perform a method. The instructions may reside, completely or partially, within at least one of the processors 102 (e.g., within the processor's cache memory), the memory devices 104, or any suitable combination thereof. Furthermore, any portion of the instructions may be transferred to the computing system 100 from any combination of the input and/or output devices 140 or the external storage 150.

The memory controller 120 may be integrated into the processor 102, in which case the memory controller 120 may be referred to as an integrated memory controller, or the memory controller 120 may be implemented as a component that is separate from the processor 102. The computing system 100 may take the form of a server system, a client computing system, a mobile computing system, or an embedded computing system. The computing system 100 of FIG. 1 is a non-limiting example of an environment in which the memory controller 120 and the memory device 104 may be deployed; other configurations of the computing system 100 are within the scope of the present disclosure.

The processor 102 of the computing system 100 may include one or more compute cores 112, each compute core 112 being a processing unit configured to fetch, decode, and execute instructions and to operate on data operands. Each compute core 112 may be associated with a first-level data cache (L1 cache) and a second-level cache (L2 cache) that store recently accessed instructions and data at low latency. The processor 102 may further include a last-level cache 113, such as a shared third-level cache (L3 cache), that is accessible to multiple compute cores 112 and that stores data and instructions that have been evicted from the per-core caches. When a compute core 112 requires data that is not present in any level of the cache hierarchy, the compute core 112 generates a memory access request directed to the memory controller 120. The processor 102 may additionally include one or more graphics processing units or other accelerator cores that generate memory access requests to the memory controller 120.

The processor 102 may include a system interconnect fabric 114 that routes memory access requests from the compute cores 112 and other requestors to the memory controller 120. The system interconnect fabric 114 may be implemented as a ring bus, a mesh network, a crossbar, or another topology, and may implement a coherence protocol that ensures that data held in the caches of different compute cores 112 remains consistent. The system interconnect fabric 114 may conform to a standardized on-chip interconnect protocol, such as the ARM Advanced Microcontroller Bus Architecture AXI protocol, or may be a proprietary fabric, such as a processor vendor's ring bus or a multi-die interconnect fabric. The system interconnect fabric 114 presents memory access requests to the memory controller 120 in a format that the memory controller 120 translates into commands conforming to the protocol of the physical memory channel 121.

The memory controller 120 is positioned between the system interconnect fabric 114 and the physical memory channel 121. The memory controller 120 receives memory access requests from the system interconnect fabric 114, schedules those requests according to the timing constraints of the physical memory channel 121, and issues the corresponding read, write, and maintenance commands to the memory device 104. The memory controller 120 may be implemented as dedicated logic on the processor die, or as logic on a separate die within the same package as the processor 102, or as a discrete integrated circuit. The memory controller 120 interfaces upstream with the system interconnect fabric 114 and downstream with a physical layer (PHY) circuit that drives and receives signals on the physical memory channel 121.

The physical memory channel 121 may be organized into one or more sub-channels, each sub-channel including a respective group of data lanes, one or more strobe or write-clock conductors, and a set of command and address conductors. In one example, the physical memory channel 121 may include four sub-channels, each sub-channel carrying twenty-four data lanes, yielding an aggregate data bus width of ninety-six data lanes across the four sub-channels. Each sub-channel may be operated independently, so that the memory controller 120 may issue commands and transfer data on one sub-channel independently of the state of another sub-channel. Other sub-channel organizations, including a single sub-channel or two sub-channels, are within the scope of the present disclosure.

The processor 102 may include a physical layer circuit on the processor die that converts logical command and data signals produced by the memory controller 120 into analog electrical signals suitable for transmission on the physical memory channel 121, and that converts analog electrical signals received from the physical memory channel 121 into logical signals for the memory controller 120. The physical layer circuit may include transmitter circuits, receiver circuits, and serializer and deserializer circuits for each data lane and strobe or clock conductor of the physical memory channel 121. Signals produced by the physical layer circuit exit the processor 102 through the processor package, for example via ball grid array (BGA) solder balls that connect the processor die to the processor package substrate, and from the processor package to the motherboard via a processor socket.

The computing system 100 may include a motherboard on which the processor 102 and the memory device 104 are mounted. The physical memory channel 121 may traverse the motherboard as a set of copper traces routed between the processor socket and the interface at which the memory device 104 or a memory module carrying the memory device 104 is attached. In an example, the bus may be disposed on the motherboard and may include the physical memory channel. The copper traces may be length-matched so that signals on different conductors of the same sub-channel arrive at the memory device 104 within a specified skew budget, and are routed and terminated to maintain a specified characteristic impedance throughout their length. The motherboard may support a Compression Attached Memory Module 2 (CAMM2) form factor, a dual in-line memory module (DIMM) form factor, a small outline dual in-line memory module (SO-DIMM) form factor, or another memory module form factor.

The physical memory channel 121 between the memory controller 120 and the memory device 104 may be a direct channel in which the copper traces of the motherboard connect the physical layer circuit of the processor 102 directly to the memory device 104 or to a memory module carrying the memory device 104. Alternatively, the physical memory channel 121 may include one or more intermediate components interposed between the memory controller 120 and the memory device 104. Such intermediate components may include a registering clock driver (RCD), which receives and re-drives command and address signals from the memory controller 120 to the memory device 104, and may further include a data buffer (DB), which receives and re-drives data signals between the memory controller 120 and the memory device 104. The logical content of signals carried on the physical memory channel 121, including write data and configuration-register commands, is preserved by any such intermediate components.

The one or more memory devices 104 provide the main storage for data and instructions that are actively used by the processors 102. The one or more memory devices 104 may include volatile memory technologies, such as dynamic random access memory, synchronous dynamic random access memory, or static random access memory. In some configurations, the one or more memory devices 104 include low-power double data rate memory devices coupled to the memory controller of the processor 102 over one or more memory channels, with each memory channel including a set of data lines, a write clock line, a command and address bus, one or more chip select lines, and a read data strobe line.

As examples, the memory devices 104 can be or can include random access memory (RAM), static RAM (SRAM), dynamic RAM (DRAM), synchronous DRAM (SDRAM), magnetoresistive RAM (MRAM), conductive bridge Random Access Memory (CB-RAM), phase change RAM (PRAM), core memory, dual inline memory modules (DIMMs), microDIMMs, MiniDIMMs, block addressable memory device(s) (e.g., those based on NAND or NOR technologies (e.g., single-level cell (SLC), multi-level cell (MLC), quad-level cell (QLC), tri-level cell (TLC), or some other NAND), read-only memory (ROM), programmable ROM (PROM), erasable PROM (EPROM), electrically EPROM (EEPROM), flash memory, non-volatile RAM (NVRAM), solid-state storage, magnetic disk storage mediums, optical storage mediums, memory devices that use chalcogenide glass, multi-threshold level NAND flash memory, NOR flash memory, single or multi-level phase change memory (PCM) and/or phase change memory with a switch (PCMS), NVM devices that use chalcogenide phase change material (e.g., chalcogenide glass), a resistive memory, nanowire memory, ferroelectric transistor random access memory (FeTRAM), anti-ferroelectric memory, magnetoresistive random access memory (MRAM) memory that incorporates memristor technology, resistive memory including the metal oxide base, the oxygen vacancy base and the conductive bridge random access memory (CB-RAM), or spin transfer torque (STT)-MRAM, a spintronic magnetic junction memory based device, a magnetic tunneling junction (MTJ) based device, a domain wall (DW) and spin orbit transfer (SOT) based device, a thyristor based memory device, and/or a combination of any of the aforementioned memory devices, and/or other memory. Each memory device 104 may be packaged individually or in a vertically stacked arrangement within a common package, and may include one or more independently addressable ranks accessible via respective chip select signals.

The memory device 104 or a memory module carrying the memory device 104 may be attached to the motherboard via a module interface. The module interface may be implemented as a Land Grid Array (LGA) compression interface, as used in the CAMM2 form factor, in which the memory module lies flat against the motherboard and is pressed onto a grid of contact pads by a mechanical bracket, eliminating electrical stubs associated with edge-connector insertion slots. The module interface may alternatively be implemented as an edge connector, as used in DIMM and SO-DIMM form factors, in which the memory module is inserted vertically or at an angle into a connector slot on the motherboard. The choice of module interface affects the signal integrity characteristics of the physical memory channel 121 at the point of attachment, and influences the maximum operating data rate achievable on the physical memory channel 121.

A memory module attached to the motherboard via the module interface may carry one or more memory devices 104, one or more optional buffer components such as an RCD or a DB, and optional supporting components. On-module components may include a power management integrated circuit (PMIC) that receives a bulk supply voltage from the motherboard and regulates one or more supply voltages for the memory device 104 and other on-module components. The memory module may further include a sideband communication interface that carries low-speed control and status signals between the memory controller 120 and the on-module components, including the memory device 104 and the PMIC, independently of the high-speed data and command conductors of the physical memory channel 121.

The PMIC on the memory module receives a bulk supply voltage, for example a five-volt or twelve-volt rail, from the motherboard via the module interface, and steps the bulk voltage down to one or more regulated voltages required by the memory device 104. The memory device 104 may operate at a core supply voltage below 1.1 V, and the PMIC may be configured to supply this voltage with a tolerance specified by the memory interface standard. By locating the PMIC on the memory module in close physical proximity to the memory device 104, the voltage droop on the supply rail between the regulator output and the memory device 104 supply pins is reduced relative to a configuration in which the supply voltage is regulated on the motherboard at a greater physical distance from the memory device 104. The sideband communication interface may carry telemetry from thermal sensors within the memory device 104 to the memory controller 120, and may carry voltage and frequency control signals from the memory controller 120 to the PMIC.

The physical memory channel 121 may operate at a data rate of multiple gigatransfers per second. In one example, the physical memory channel 121 may operate at a data rate in a range from 8,800 megatransfers per second to 17,600 megatransfers per second, as defined by a memory interface standard for a DDR6 DRAM device. Other data rates, including data rates defined by DDR5, LPDDR5, LPDDR6, or other memory interface standards, are within the scope of the present disclosure. Write data and read data are transferred on the data lanes of each sub-channel in bursts, where each burst includes a number of unit intervals defined by the burst length parameter of the interface. In one example, the burst length may be 16 unit intervals (BL16), 24 unit intervals (BL24), or 32 unit intervals (BL32). The memory controller 120 generates a write clock or data strobe signal on a dedicated conductor of each sub-channel to provide a sampling reference for the memory device 104.

In normal operation of the computing system 100, a compute core 112 that experiences a cache miss at the last-level cache 113 may generate a memory access request that travels across the system interconnect fabric 114 to the memory controller 120. The memory controller 120 schedules the request, generates the corresponding memory commands, and passes the commands and any associated write data to the physical layer circuit. The physical layer circuit drives the commands and write data onto the physical memory channel 121 via the copper traces of the motherboard and the module interface to the memory device 104. For a read operation, the memory device 104 retrieves the requested data from its internal array and drives the data back onto the physical memory channel 121, where the physical layer circuit receives and forwards the data to the memory controller 120 and thence to the system interconnect fabric 114 and the requesting compute core 112.

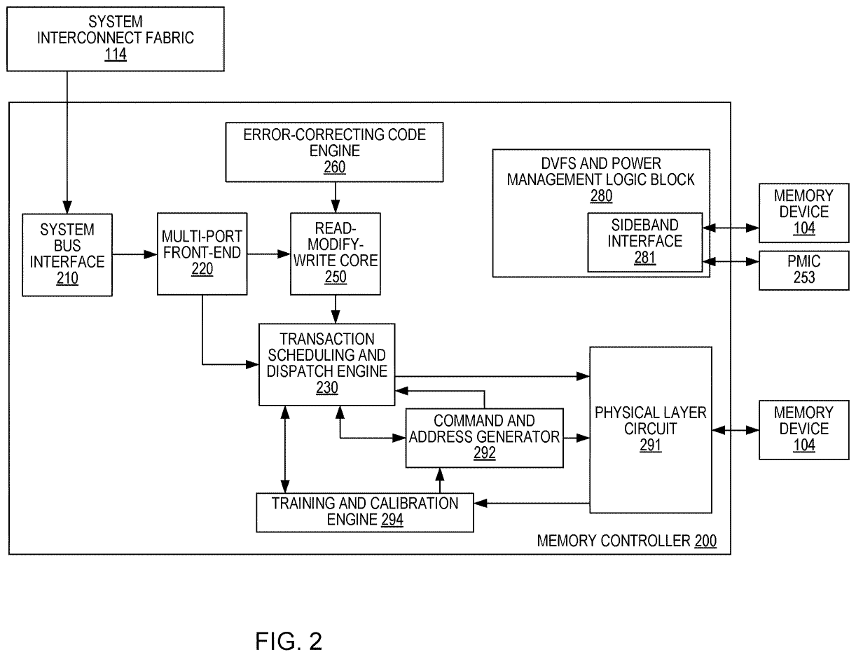

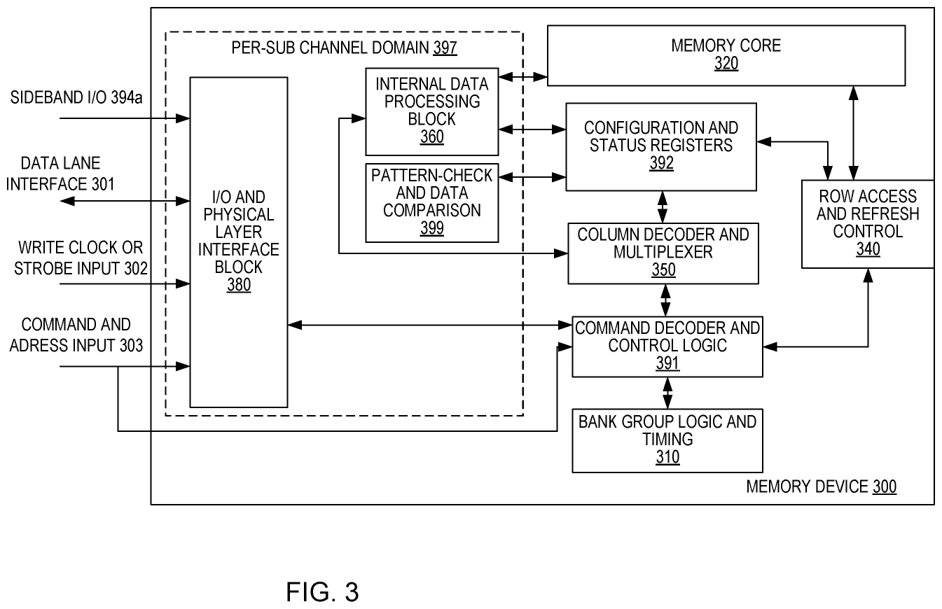

The computing system 100 passes through an initialization phase during system startup, during which the physical memory channel 121 and the memory device 104 are configured and calibrated before the computing system 100 enters a mission mode in which normal memory access operations are performed. During the initialization phase, the memory controller 120 may issue configuration-register commands to the memory device 104 to set operating parameters, and may perform link calibration sequences to establish transmit parameter settings suitable for reliable data transfer at the operating data rate of the physical memory channel 121. Following the initialization phase, the computing system 100 operates in the mission mode, during which the compute cores 112 issue memory access requests and the memory controller 120 services those requests. The distinction between the initialization phase and the mission mode is relevant to the scope of link calibration operations, as further described with reference to FIGS. 2 and 3.

The communication resources 130 enable the computing system 100 to exchange data with external entities. The communication resources 130 may include one or more network interface controllers, host bus adapters, or input/output fabric interfaces. The network interface controllers may support various communication standards, such as Ethernet, InfiniBand, or Fibre Channel. The communication resources 130 manage the physical and data link layers of the communication protocols, handling the transmission and reception of data packets. The communication resources 130 connect the computing system 100 to a network 190. The network 190 may be a local area network, a wide area network, the internet, or a dedicated storage area network. Through the network 190, the computing system 100 may access remote hardware resources 180 and external storage 150. For example, the communication resources 130 may include wired communication components, cellular communication components, Wi-Fi components, and other communication components

The input/output devices 140 associated with the computing system 100 represent local peripheral interfaces and devices. These may include storage controllers, such as redundant array of independent disks controllers, universal serial bus controllers, and interfaces for human interaction devices like keyboards and monitors if the system is configured for direct user interaction. The input/output devices 140 may also include hardware accelerators, such as field-programmable gate arrays or application-specific integrated circuits, installed to offload specific processing tasks from the processors 102. The bus facilitates the communication between the processors 102 and the input/output devices 140, often utilizing standards like peripheral component interconnect express. FIG. 1 also illustrates input/output devices 140 external to the computing system 100, which may represent peripherals connected via the communication resources 130 or the network 190, providing flexibility in system configuration.

The external storage 150 represents persistent data storage repositories located outside the immediate physical chassis of the computing system 100. The external storage 150 may include storage area networks, network-attached storage systems, or cloud-based storage services. The external storage 150 may store application data and operating system files that are loaded into the one or more memory devices 104 during operation. The connection to the external storage 150 allows for centralized data management and facilitates features such as high availability, where a workload can be restarted on different hardware resources if the primary hardware fails. Access to the external storage 150 is mediated by the communication resources 130 and the protocols of the network 190, such as internet small computer systems interface or non-volatile memory express over fabrics.

The remote hardware resources 180 generally represent other computing nodes or clusters available via the network 190. In a distributed computing system 100, the computing system 100 may function as one physical node in a larger cluster, with the remote hardware resources 180 constituting the other physical nodes. The remote hardware resources 180 may possess similar or different configurations compared to the computing system 100. The ability to communicate with the remote hardware resources 180 enables distributed processing, where a single large task is decomposed into smaller sub-tasks executed in parallel across multiple machines.

FIG. 1 represents one non-limiting example of a computing system 100 in which the memory controller 120 and the memory device 104 may be implemented. The aspects described herein are applicable to computing systems 100 in which the memory device 104 is a DDR6 DRAM device, a DDR5 DRAM device, an LPDDR5 DRAM device, an LPDDR6 DRAM device, or any other memory device that communicates with a memory controller via a source-synchronous parallel write data interface including a plurality of data lanes. The aspects described herein are further applicable to memory systems employing any of the module interface types described above.

FIG. 2 illustrates a memory controller 200. The memory controller 200 may be the memory controller 120 described in accordance with FIG. 1. The memory controller may include a system bus interface 210 at an upstream side, a physical layer circuit 291 at a downstream side, and a plurality of internal logic blocks that translate memory access requests received from the system bus interface 210 into command and data transfers on a physical memory channel (e.g., the physical memory channel 121 of the computing system 100). The memory controller 200 may be implemented as logic integrated on the processor die, as logic on a separate die in the same package as the processor 102, or as a discrete integrated circuit. The internal logic blocks of the memory controller 200 illustrated in FIG. 2 are described in the following paragraphs. The arrangement of logic blocks shown in FIG. 2 is a non-limiting example; implementations may combine, subdivide, or reorder these blocks. Description of some aspects may refer to components introduced in accordance with FIG. 1 instead of reintroducing that component for brevity.

The system bus interface 210 of the memory controller 200 provides the upstream connection between the memory controller 200 and the system interconnect fabric 114 of the processor 102. The system bus interface 210 receives memory access requests from the system interconnect fabric 114 in a format defined by the on-chip interconnect protocol in use, which may be the ARM Advanced Microcontroller Bus Architecture AXI protocol, a proprietary ring bus protocol, a multi-die fabric protocol, or another on-chip interconnect protocol. The system bus interface 210 translates these incoming requests into an internal transaction format used by the downstream logic blocks of the memory controller 200. The system bus interface 210 may handle multiple outstanding transactions simultaneously, presenting pending requests to the downstream logic blocks in a manner that permits out-of-order processing.

The memory controller 200 may include a multi-port front end 220 coupled between the system bus interface 210 and a transaction scheduling and dispatch engine. The multi-port front end 220 accepts memory access requests from the system bus interface 210 and from other request sources within the computing system 100, such as direct memory access engines or graphics processing units, and deposits those requests into an internal request queue within the transaction scheduling and dispatch engine. The multi-port front end 220 may apply initial quality-of-service tagging to each request, associating with each request a priority level that reflects the latency sensitivity of the originating request source. For example, requests generated by a compute core 112 executing a latency-critical thread may receive a higher quality-of-service tag than requests generated by a background bulk data transfer. The quality-of-service tags assigned by the multi-port front end 220 influence the scheduling decisions made by the transaction scheduling and dispatch engine.

The memory controller 200 may include a transaction scheduling and dispatch engine 230 coupled between the multi-port front end 220 and the physical layer circuit 291. The transaction scheduling and dispatch engine 230 may be configured for the complete pipeline from request intake through scheduling, timing enforcement, and per-sub-channel dispatch to the physical layer circuit 291. The transaction scheduling and dispatch engine 230 maintains an internal request queue into which the multi-port front end 220 deposits incoming requests, and evaluates pending requests in the queue to determine the order in which those requests are issued to the memory device 104. The transaction scheduling and dispatch engine 230 may issue requests out of the order in which they were received, subject to correctness and quality-of-service constraints, in order to improve utilization of the physical memory channel 121.

The transaction scheduling and dispatch engine 230 may perform open-page scheduling. The transaction scheduling and dispatch engine 230 maintains a real-time record of the state of each bank within the memory device 104, tracking which row, if any, is currently open in the row buffer of each bank, and whether a bank is in an active, precharged, or precharging state. When evaluating a pending request, the transaction scheduling and dispatch engine 230 determines whether the targeted row is already open in the row buffer of the targeted bank. If the targeted row is open, the transaction scheduling and dispatch engine 230 may elevate the priority of that request so that a column access command is issued without first performing a row precharge and activation sequence. If the targeted row is not open, the transaction scheduling and dispatch engine 230 calculates the appropriate time to issue a precharge command followed by a row activation command, taking into account the current state of the targeted bank and the timing constraints applicable to that bank. The transaction scheduling and dispatch engine may further perform read-write grouping. Because switching the data lanes of the physical memory channel 121 between write and read directions incurs a turnaround penalty, the transaction scheduling and dispatch engine 230 may group consecutive write requests and consecutive read requests to minimize the frequency of direction changes.

The transaction scheduling and dispatch engine 230 may further perform timing enforcement and per-sub-channel dispatch. Before any command is released to the physical layer circuit 291, the transaction scheduling and dispatch engine 230 verifies that the command complies with all applicable timing parameters specified by the memory interface standard in use. Timing parameters enforced in this manner may include the minimum row-to-row activation delay within the same bank group, the minimum row-to-row activation delay across bank groups, the four-bank activation window constraint, the CAS latency, and the write-to-read and read-to-write bus turnaround delays. If a command would violate a timing constraint, the transaction scheduling and dispatch engine 230 holds the command until the constraint is satisfied. Following timing verification, the transaction scheduling and dispatch engine 230 divides the command and data payload into a number of independent streams, one per sub-channel of the physical memory channel 121, and dispatches each stream to the corresponding instance of the physical layer circuit 291 independently of the other streams. In one example, four independent streams may be dispatched corresponding to four sub-channels, each carrying twenty-four data lanes.

The memory controller 200 may further include a read-modify-write core 250 coupled between the multi-port front end 220 and the transaction scheduling and dispatch engine 230. The read-modify-write core 250 handles write requests that target a subset of the bytes within a naturally aligned block of memory corresponding to a full burst of write data on the physical memory channel 121. Because the memory controller 200 transfers data to the memory device 104 in bursts covering a fixed number of unit intervals, a write request that modifies fewer bytes than are transferred in a single burst requires the memory controller 200 to first read the existing contents of the targeted block, merge the new bytes into the existing data, and then write the complete merged block back to the memory device 104. The read-modify-write core 250 orchestrates this sequence by issuing a read command for the targeted block, receiving the returned data, performing the byte-level merge with the incoming write data, and queuing a full-block write command carrying the merged payload to the transaction scheduling and dispatch engine 230.

The memory controller 200 may further include a (system-level) error-correcting code engine 260 coupled to the read-modify-write core 250 and to the read and write data paths of the memory controller 200. The system-level error-correcting code engine 260 may be distinct from any on-die error-correcting code logic that may be present within the memory device 104 itself. The system-level error-correcting code engine 260 generates error-correcting code parity bits for outbound write data before that data is transmitted to the memory device 104, appending the parity bits to the data payload in a manner determined by the error-correcting code scheme in use. For inbound read data returned by the memory device 104, the system-level error-correcting code engine 260 checks the received parity bits against the received data, corrects single-bit errors where the error-correcting code scheme permits correction, and reports uncorrectable multi-bit errors to the operating system or to a system management interface.

The memory controller 200 may further include a dynamic voltage and frequency scaling (DVFS) and power management logic block 280 and an associated sideband interface 281. The dynamic voltage and frequency scaling and power management logic block 280 monitors the depth of the internal request queue of the transaction scheduling and dispatch engine 230 and the utilization of the physical memory channel 121, and adjusts the operating frequency and supply voltage of the memory controller 200 and the memory device 104 in response to changes in workload intensity. During periods of high memory access demand, the dynamic voltage and frequency scaling and power management logic block 280 commands the physical layer circuit 291 to operate at the maximum specified data rate and nominal supply voltage. During periods of low memory access demand, the dynamic voltage and frequency scaling and power management logic block 280 may transition the memory controller 200 and the memory device 104 into one or more low-power states. Transitions between power states are communicated to the memory device 104 and to the PMIC 253 via the sideband interface 281, which operates on dedicated conductors of the physical memory channel 121 independently of the high-speed data lanes.

The memory controller 200 includes a physical layer circuit 291 coupled between the transaction scheduling and dispatch engine 230 and the physical memory channel 121. The physical layer circuit 291 includes transmitter circuits that convert logical write data and command signals produced by the transaction scheduling and dispatch engine 230 into analog electrical signals suitable for transmission on the physical memory channel 121, and receiver circuits that convert analog electrical signals received from the physical memory channel 121 into logical read data and status signals for the upstream logic blocks. The physical layer circuit 291 may instantiate one transmitter and one receiver circuit per data lane of each sub-channel of the physical memory channel 121, so that each data lane is driven and sampled independently. The transmitter circuits of the physical layer circuit 291 may transmit data using non-return-to-zero signaling, in which each data lane carries one of two voltage levels representing a logic one or a logic zero during each unit interval.

The physical layer circuit 291 further includes serializer and deserializer circuits that convert between the parallel internal data representation used within the memory controller 200 and the serial-per-lane representation used on the physical memory channel 121. The physical layer circuit 291 generates a write clock signal on the write clock conductor of each sub-channel, providing the memory device 104 with a timing reference for sampling incoming write data at each unit interval boundary. The receiver circuits within the physical layer circuit 291 may incorporate equalization circuits to compensate for signal degradation on inbound read data paths. The physical layer circuit 291 may instantiate one independent instance per sub-channel of the physical memory channel 121, allowing each sub-channel to be operated at an independently configured data rate and voltage level under the control of the dynamic voltage and frequency scaling and power management logic block 280.

The memory controller 200 includes a command and address generator 292 coupled to the transaction scheduling and dispatch engine 230 and to the physical layer circuit 291. The command and address generator 292 produces the command and address signals that are transmitted to the memory device 104 over the command and address conductors of each sub-channel. The command and address generator 292 is capable of generating the full set of commands defined by the memory interface standard in use, including row activation commands, column read and write commands, precharge commands, refresh commands, and configuration-register commands. Configuration-register commands generated by the command and address generator 292 include commands of a write type, which cause the memory device 104 to update the contents of a specified configuration register, and commands of a read type, which cause the memory device 104 to return the contents of a specified configuration register to the memory controller 200 as a data payload on the data lanes of the relevant sub-channel.

The memory controller 200 may include a training and calibration engine 294 coupled to the command and address generator 292 and to the physical layer circuit 291. The training and calibration engine 294 consolidates the functions of transmit parameter control, calibration sequence orchestration, response capture, and calibration result storage into a single logic block. The training and calibration engine 294 may include a finite-state machine, implemented in hardware or in a combination of hardware and firmware, that orchestrates link calibration sequences on the physical memory channel 121 by coordinating the command and address generator 292, the transmit parameter control circuits within the physical layer circuit 291, and the data path between the physical layer circuit 291 and the upstream logic blocks of the memory controller 200.

The training and calibration engine 294 may include internal transmit parameter control logic that sets the electrical characteristics of the transmitter circuits within the physical layer circuit 291 on a per-lane or per-sub-channel basis. Parameters that the transmit parameter control logic may configure include transmitter drive strength, pre-emphasis coefficient, de-emphasis coefficient, equalization coefficient, reference voltage applied at the memory device 104 receiver, transmit phase or timing offset relative to the write clock signal, and output impedance. The training and calibration engine 294 may further include a response capture path that receives configuration-register read response data returned by the memory device 104 via the physical layer circuit 291 and makes that data available to the finite-state machine for evaluation. When the command and address generator 292 issues a configuration-register read command to the memory device 104, the memory device 104 returns the contents of the addressed configuration register as a data payload on the data lanes of the relevant sub-channel, and the response capture path within the training and calibration engine 294 captures and decodes this payload into a logical register value.

In some further aspects described herein, the training and calibration engine 294 may further include receiver parameter control logic that is configured to set the electrical characteristics of the receiver circuits within the physical layer circuit 291. Parameters that the receiver parameter control logic may configure include at least one or a combination of: receiver timing offset relative to a data strobe signal received from the memory device, reference voltage applied at the receiver sampling point, decision feedback equalization coefficients that compensate for inter-symbol interference on inbound data paths, receiver bias current, and input termination impedance. In an example, the receiver parameter control logic may set these parameters on a per-lane basis. Correspondingly, each receiver circuit may be associated with a respective data lane of the physical memory channel 121 may be configured independently, or on a per-sub-channel basis, so that all receiver circuits within a sub-channel share a common parameter setting. The receiver parameter control logic may store calibration results identifying receiver parameter settings associated with reliable reception in an internal result storage structure within the training and calibration engine 294. The receiver parameter control logic may be invoked by the finite-state machine of the training and calibration engine 294 during the host receiver training mode independently of, or in sequence with, the transmit parameter control logic used during the write data training mode. Following completion of the host receiver training mode, the receiver parameter settings stored in the internal result storage structure may be applied to the receiver circuits of the physical layer circuit 291 for use during normal operation of the physical memory channel 121.

In some further aspects described herein, the training and calibration engine 294 may further include an expected data pattern source and comparison logic for determining, by the memory controller 200, an error indication based on training pattern data received during the host receiver training mode. The expected data pattern source may be, or may include, a pattern-generation circuit, such as a LFSR implementing the same characteristic polynomial as the LFSR within the memory device, initialized with the same seed value that the memory controller 200 has programmed into the memory device via configuration-register commands. Alternatively, the expected data pattern source may be a memory (e.g., a register file) within the training and calibration engine 294 storing a copy of the user-defined read pattern that the memory controller 200 has loaded into the configuration registers of the memory device. The comparison logic within the training and calibration engine 294 may compare the training pattern data captured by the receiver circuits of the physical layer circuit 291 against the expected data pattern provided by the expected data pattern source. In some examples, the error indication produced by the comparison logic may be determined on a per-lane basis, and may include phase-specific error information identifying which subset of unit intervals within a burst of training pattern data exhibited a mismatch. The error indication may be stored within the training and calibration engine 294.

To perform a calibration sequence, the training and calibration engine 294 may cause the command and address generator 292 to issue configuration-register commands to the memory device 104, may set one or more transmit parameter settings via the transmit parameter control logic, may cause write data to be transmitted on the physical memory channel 121, and may subsequently cause the command and address generator 292 to issue configuration-register read commands to retrieve status information from the memory device 104 via the response capture path. The training and calibration engine 294 may iterate over a plurality of transmit parameter settings in succession, collecting status information from the memory device 104 after each setting. Calibration results identified by this iterative process are stored in an internal result storage structure within the training and calibration engine 294, which may be implemented as a register file or a static random-access memory array, and the stored settings are subsequently applied to the transmit parameter control logic for use during normal operation of the physical memory channel 121.

The data flow through the memory controller 200 during normal operation proceeds as follows. A memory access request arrives at the system bus interface 210 from the system interconnect fabric 114, is ingested and tagged by the multi-port front end 220, and is deposited into the internal request queue of the transaction scheduling and dispatch engine 230. The transaction scheduling and dispatch engine 230 evaluates the request in the context of other pending requests and the current state of the memory device 104, applies timing enforcement, and dispatches the resulting command and associated data to the physical layer circuit 291 via the appropriate sub-channel stream. The physical layer circuit 291 converts the command and data to analog signals and drives them onto the physical memory channel 121. For write operations, the read-modify-write core 250 and the system-level error-correcting code engine 260 may be engaged upstream of the transaction scheduling and dispatch engine 230 to ensure that full-block, parity-protected write payloads are presented to the physical layer circuit 291. During calibration sequences, the training and calibration engine 294 directs the command and address generator 292 and the physical layer circuit 291 independently of the normal transaction flow.

The logic blocks illustrated in FIG. 2 and described in the preceding paragraphs of this section represent a non-limiting example of the internal organization of the memory controller 200. In various implementations, two or more of the described logic blocks may be combined into a single hardware block, a single described logic block may be distributed across multiple hardware instances, or one or more logic blocks may be implemented partly or wholly in firmware executing on a microcontroller embedded within the memory controller 200. The memory controller 200 may include additional logic blocks not shown in FIG. 2, such as refresh scheduling logic, rank management logic, or thermal management logic, without departing from the scope of the present disclosure.

FIG. 3 illustrates a memory device 300. The memory device 300 may be one of the one or more memory devices 104 (i.e., the memory device 104). The memory device 300 may include: an I/O and physical layer interface block 380, a command decoder and control logic block 391, a configuration and status registers block 392, an internal data processing block 360, a pattern-check and data comparison block 399, a bank group logic and timing block 310, a row access and refresh control block 340, a column decoder and multiplexer block 350, and a memory core block 320. The memory device 300 may be a DRAM device, and may be a DDR6 DRAM device, a DDR5 DRAM device, an LPDDR5 DRAM device, an LPDDR6 DRAM device, or a memory device conforming to another memory interface standard. The arrangement of blocks shown in FIG. 3 is a non-limiting example; implementations may combine, subdivide, or distribute these blocks across one or more physical die. Description of some aspects may refer to components introduced in accordance with FIG. 1 and FIG. 2 instead of reintroducing that component here, for brevity. It is further to be noted that FIG. 3 does not depict each and every connection between blocks and components described herein.

The I/O and physical layer interface block 380 may manage high-speed and low-speed physical communication between the memory device 300 and the memory controller 200. The I/O and physical layer block 380 may include respective mixed analog and digital circuitry. For example, the transceivers, DFE, and reference voltage logic may be analog or mixed-signal circuits. The write clock receiver and clocking tree may be analog/mixed-signal circuits (delay-locked loop or phase-locked loop). The sideband logic is digital circuitry. The block 380 may include four interfaces to the physical memory channel 121: a data lane interface 301 including a plurality of data lanes on which write data is received and read data is driven, a write clock or strobe input 302 that carries the timing reference used to determine unit interval boundaries on the data lanes, a command and address input 303 on which command and address signals are received from the memory controller 200. The I/O and physical layer interface block 380 may further include a sideband input and output 394a through which low-speed control and status signals are exchanged independently of the high-speed data lanes.

The block 380 may include input/output transceiver circuits that receive incoming write data signals from the data lane interface 301 at each unit interval boundary defined by the write clock or strobe input 302, and driver circuits that drive outgoing read data signals onto the data lane interface 301 during read operations. The transceiver circuits may transmit and receive data using non-return-to-zero signaling, and the driver circuits may be configurable with respect to drive strength and output impedance to adapt the transmit characteristics of the memory device 300 to the electrical properties of the physical memory channel 121. In some examples, the transceiver circuits may transmit and receive data using pulse amplitude modulation 4-level (PAM4) signaling.

The I/O and physical layer interface block 380 may further include decision feedback equalization circuitry and reference voltage logic within its receiver circuits. At high data rates, the physical memory channel 121 introduces inter-symbol interference, whereby the logic level of a received bit is influenced by the logic levels of preceding bits due to the finite bandwidth of the channel. The decision feedback equalization circuitry may compensate for this inter-symbol interference by applying calibrated correction terms, derived from previously received and resolved bits, to the incoming signal at the sampling point of each receiver circuit. The reference voltage logic establishes and maintains the voltage threshold at which each receiver circuit distinguishes a received logic one from a received logic zero. The reference voltage applied by the reference voltage logic may be set by the memory controller 200 via a configuration-register command received at the command and address input 303 and processed by the command decoder and control logic block 391, and may be adjusted as part of a link calibration procedure to maximize the voltage margin at the receiver sampling point.

The I/O and physical layer interface block 380 may further include a write clock receiver and internal clocking tree that receives the write clock or strobe signal at the write clock or strobe input 302 and generates from that signal the internal timing references used by the transceiver circuits to determine the unit interval boundaries at which incoming write data bits are sampled. The internal clocking tree distributes these timing references across the data lane interface 301 with low skew, so that all receiver circuits capture their respective data lane signals at substantially the same phase of the write clock or strobe signal. The write clock receiver may incorporate delay-locked loop or phase-locked loop circuitry to align the internal sampling clock with the incoming write clock or strobe signal. The sideband control logic within block 380 handles low-speed communication on the sideband input and output 394a, exchanging thermal telemetry, power state transition signals, and device status information between the memory device 300 and external components including the memory controller 200 and the PMIC 253, independently of the high-speed data lane interface 301.

The command decoder and control logic block 391 is coupled to the command and address input 303 of the I/O and physical layer interface block 380 and serves as the primary internal controller of the memory device 300. The command decoder and control logic block 391 receives command and address signals forwarded from the block 380, decodes those signals into internal control signals, and distributes those control signals to all other functional blocks of the memory device 300. Commands decoded by the command decoder and control logic block 391 may include row activation commands directed to the row access and refresh control block 340, column read and write commands directed to the column decoder and multiplexer block 350, precharge commands directed to the bank group logic and timing block 310, refresh commands directed to the row access and refresh control block 340, and configuration-register commands of a write or read type directed to the configuration and status registers block 392. The command decoder and control logic block 391 may validate command timing by checking that received commands satisfy the timing constraints maintained by the bank group logic and timing block 310 before forwarding those commands to the targeted functional blocks.

The configuration and status registers block 392 includes a configuration register file portion and a status register portion, and is coupled to the command decoder and control logic block 391. The configuration register file portion includes a plurality of addressable registers into which the memory controller 200 may write values by issuing configuration-register commands of a write type, decoded and forwarded by the command decoder and control logic block 391. The values held in the configuration register file portion may govern the operating parameters and modes of the memory device 300, including but not limited to data rate settings, latency parameters, power-state configuration, and operating mode selection. The configuration register file portion distributes the governing parameter values to other functional blocks of the memory device 300, so that those blocks operate in accordance with the configuration established by the memory controller 200. The memory controller 200 may read the current contents of the configuration register file portion by issuing a configuration-register command of a read type, which causes the configuration and status registers block 392 to return the addressed register contents as a data payload on the data lane interface 301.

The status register portion of the configuration and status registers block 392 holds values written by internal logic blocks of the memory device 300 to record internal conditions, measurements, or event counts that the memory controller 200 may subsequently retrieve. Whereas the configuration register file portion holds values written by the memory controller 200 to govern the behavior of the memory device 300, the status register portion holds values produced internally, such as temperature readings supplied by the thermal sensor circuits within the row access and refresh control block 340, error event information supplied by the on-die error-correcting code logic within the internal data processing block 360, or comparison status information supplied by the pattern-check and data comparison block 399. The memory controller 200 may read the contents of the status register portion by issuing a configuration-register read command specifying the address of the desired status register, which causes the configuration and status registers block 392 to return the addressed status register contents to the memory controller 200 via the data lane interface 301. The status register portion may include one or more status registers that store per-lane error indications determined by the pattern-check circuitry during a write data training mode. The per-lane error indications stored in the one or more status registers are accessible to the memory controller via configuration-register read commands issued to the memory device.

The internal data processing block 360 handles internal data movement, buffering, serialization, deserialization, and error correction for data transferred between the I/O and physical layer interface block 380 and the memory core block 320. The block 360 includes a serializer that receives wide parallel read data assembled from the memory core block 320 and converts that data to a serial bit stream on each data lane of the data lane interface 301, clocking out successive bits at the operating data rate over the duration of one burst. The block 360 further includes a deserializer that receives the serial bit stream arriving on each data lane of the data lane interface 301 during a write burst and converts that stream into a parallel data word by capturing successive unit intervals of the incoming burst into respective storage elements. The deserializer may operate in a multi-phase fashion, in which the incoming bit stream on each data lane is captured by a plurality of parallel sampling circuits, each assigned to a respective subset of unit intervals within the burst that are spaced apart by the number of parallel sampling phases. For example, a quarter-rate deserializer may produce four parallel outputs per data lane, each output corresponding to a respective set of unit intervals within the burst spaced four unit intervals apart.

The internal data processing block 360 may further include a prefetch buffer and first-in first-out buffer that bridges the frequency difference between the memory core block 320, which operates at a relatively low internal clock frequency, and the data lane interface 301, which operates at a higher data rate. For each column read access, the prefetch buffer within block 360 captures a wide parallel data word from the memory core block 320 via the column decoder and multiplexer block 350. This wide parallel word includes a number of bits equal to the product of the external data lane width and the burst length, so that a single internal array access supplies all the data needed to populate one complete burst on the external data lanes. In one example applicable to a DDR6 DRAM device, the prefetch buffer may hold sixteen times, twenty-four times, or thirty two times the external data width per access. For write operations, the prefetch buffer accumulates the incoming burst data from the deserializer until a complete parallel word is assembled, and then delivers the parallel word to the memory core block 320 via the column decoder and multiplexer block 350. The block 360 additionally includes an on-die error-correcting code engine that computes and appends parity bits to data being written to the memory core block 320, and computes syndromes, identifies errors, and corrects single-bit errors in data being read from the memory core block 320, before the corrected data is passed to the serializer. The on-die error-correcting code engine within block 360 is distinct from the system-level error-correcting code engine 260 of the memory controller 200 described with reference to FIG. 2.

The pattern-check and data comparison block 399 is a logic circuit within the memory device 300 that may be configured to compare data received at the data lane interface 301 against reference data generated or stored within the memory device 300, and to produce a status output indicating whether the received data matches the reference data. The pattern-check and data comparison block 399 may be coupled to the deserializer output within the internal data processing block 360, so that the comparison is performed on write data after deserialization into a parallel representation, and is coupled to the configuration and status registers block 392, into the status register portion of which the status output is written and from which the status output is accessible to the memory controller 200 via configuration-register read commands. The pattern-check and data comparison block 399 may be activated under the control of the configuration and status registers block 392, in response to an operating mode selection written by the memory controller 200 via a configuration-register command decoded by the command decoder and control logic block 391. The pattern-check and data comparison block 399 may report comparison results on a per-data-lane basis. The specific operating behavior, configuration, and pattern-generation aspects of the pattern-check and data comparison block 399 in the context of write data link calibration are further described herein. In accordance with various aspects described herein, a memory device may include processing circuitry configured to compare, for each data lane of a plurality of data lanes, write data received on that data lane against a respective expected data pattern and to determine a respective per-lane error indication, and one or more status registers configured to store the per-lane error indications such that the per-lane error indications are accessible to the memory controller. The processing circuitry may include the pattern-check and data comparison block 399 described herein. The one or more status registers may correspond to the status register portion of the configuration and status registers block 392 described herein.

The bank group logic and timing block 310 organizes the internal storage capacity of the memory device 300 into a plurality of banks and enforces the timing constraints that govern operations across those banks. Banks may be further organized into bank groups, where banks within the same bank group share timing constraints that are more restrictive than those applicable between banks in different bank groups. In one example applicable to a DDR6 DRAM device, the memory device 300 may include sixty-four banks organized into a plurality of bank groups. The bank group logic and timing block 310 receives control signals from the command decoder and control logic block 391 and maintains a real-time record of the state of each bank, including whether the bank is in a precharged state with no row open, an active state with a specific row open in the row buffer within the memory core block 320, or a transitional state in which a precharge or activation operation is in progress. The bank group logic and timing block 310 enforces timing constraints between successive operations directed to the same bank or bank group, including the minimum time between successive row activations within the same bank group, the minimum time between successive row activations across bank groups, and the maximum number of row activations permitted within a specified time window across all banks.

The row access and refresh control block 340 incorporates the row decoder and wordline driver circuits, the adaptive refresh controller, and the thermal sensor circuits of the memory device 300. The row decoder and wordline driver portion of block 340 receives a row address from the command decoder and control logic block 391 and translates that row address into a physical wordline selection signal. The row decoder decodes the binary row address into a one-of-N selection among the wordlines of the memory core block 320. The wordline driver applies a voltage sufficient to fully open the access transistors of all memory cells connected to the selected wordline within the operating timing constraints specified by the memory interface standard. Wordline voltage levels may differ from the core supply voltage of the memory device 300 and may be generated by internal charge pump circuits within the row access and refresh control block 340.

The thermal sensor circuits within the row access and refresh control block 340 measure the temperature of the memory device 300 die and produce a digital representation of the measured temperature. The adaptive refresh controller within block 340 uses the temperature measurements supplied by the thermal sensor circuits to adjust the refresh interval dynamically. At lower die temperatures, where charge leakage from storage capacitors in the memory core block 320 is slower, the adaptive refresh controller may extend the interval between refresh operations, reducing the proportion of memory bandwidth and power consumed by refresh activity. At higher die temperatures, the adaptive refresh controller shortens the refresh interval to ensure charge is restored before it falls below a detectable threshold. The adaptive refresh controller issues refresh commands to the bank group logic and timing block 310 and directs the row decoder and wordline driver portion of block 340 to perform the corresponding wordline activation. Temperature measurements from the thermal sensor circuits may be reported to the status register portion of the configuration and status registers block 392 and may be conveyed externally via the sideband control logic within the I/O and physical layer interface block 380.

The column decoder and multiplexer block 350 is coupled between the configuration and status registers block 392, from which it receives column address and control signals forwarded by the command decoder and control logic block 391, and the memory core block 320 and the internal data processing block 360. The column decoder and multiplexer block 350 selects specific columns from the sense amplifiers and row buffer within the memory core block 320, corresponding to the column address provided by the command decoder and control logic block 391. For a read operation, the column decoder and multiplexer block 350 selects the addressed columns and passes the corresponding data bits from the sense amplifiers of the memory core block 320 to the prefetch buffer within the internal data processing block 360. For a write operation, the column decoder and multiplexer block 350 receives the parallel write data word from the prefetch buffer within the internal data processing block 360 and routes the data to the corresponding sense amplifier positions within the memory core block 320, from which the data is subsequently written back to the memory cell array. The number of columns selected per column access command is determined by the internal data path width and the prefetch depth of the internal data processing block 360.

The memory core block 320 includes the core storage elements of the memory device 300, including the memory cell array and the sense amplifiers and row buffer. The memory cell array portion of block 320 includes a two-dimensional grid of memory cells, each memory cell storing one bit of data. Each memory cell includes a storage capacitor and an access transistor connected such that asserting the wordline of the memory cell opens the access transistor and connects the storage capacitor to the corresponding bitline. A plurality of memory cells sharing a common wordline connection form a row of the memory cell array, and a plurality of memory cells sharing a common bitline connection form a column of the memory cell array. Wordlines are driven by the row access and refresh control block 340, and bitlines connect the memory cell array to the sense amplifiers described below. The physical density of the memory cell array is determined by the lithographic process used to fabricate the memory device 300. The charge stored on each storage capacitor diminishes over time due to leakage, necessitating the periodic refresh operations managed by the adaptive refresh controller within the row access and refresh control block 340.

The sense amplifiers and row buffer portion of the memory core block 320 are connected to the bitlines of the memory cell array. When a wordline is asserted by the row access and refresh control block 340, the charge stored on the storage capacitors of all memory cells connected to that wordline is shared with the corresponding bitlines, producing a small voltage perturbation on each bitline that is proportional to the ratio of the cell capacitance to the bitline capacitance. The sense amplifiers detect this voltage perturbation, amplify it to a full logic level, and latch the result. Following sense amplifier activation, the latched data for the entire activated row is held in the sense amplifiers, collectively forming a row buffer from which the column decoder and multiplexer block 350 may perform column-level read and write operations without requiring a repeated row activation. The row buffer remains valid until the bank is precharged by a precharge command decoded by the command decoder and control logic block 391 and processed by the bank group logic and timing block 310.

The per-sub-channel domain 397 is a logical and physical grouping within the memory device 300, shown in FIG. 3 as a dashed enclosure, that corresponds to a subset of the data lanes of the data lane interface 301, together with the associated internal circuits that serve those data lanes. In one example, a memory device 300 configured as an x6 device may be organized into two per-sub-channel domains 397, designated PSD0 and PSD1, each serving three data lanes. In another example, a memory device 300 configured as an x3 device may include a single per-sub-channel domain 397 serving three data lanes. Other configurations, including x12 or other data lane widths, are within the scope of the present disclosure. The dashed enclosure in FIG. 3 encompasses the I/O and physical layer interface block 380, the internal data processing block 360, and the pattern-check and data comparison block 399, reflecting the per-domain instantiation of these blocks. The per-sub-channel domain 397 organization is relevant to the allocation of internal logic resources including pattern-generation and status-reporting circuits.

The logic blocks illustrated in FIG. 3 and described herein represent a non-limiting example of the internal organization of the memory device 300. In various implementations, one or more of the described blocks may be combined into a single circuit, a single described block may be distributed across multiple physical locations on the memory device 300 die, or certain blocks may be duplicated per per-sub-channel domain 397. The memory device 300 may include one or more physical DRAM die; in a multi-die configuration, individual die may each contain a full complement of the functional blocks described above, or certain blocks may be shared across die within the same package. Any specific device configuration described in the preceding paragraphs, including device width, number of per-sub-channel domains 397, bank count, and prefetch depth, is a non-limiting example. The aspects described with reference to the memory device 300 apply to memory devices conforming to DDR6, DDR5, LPDDR5, LPDDR6, or other memory interface standards that employ a source-synchronous parallel write data interface including a plurality of data lanes.

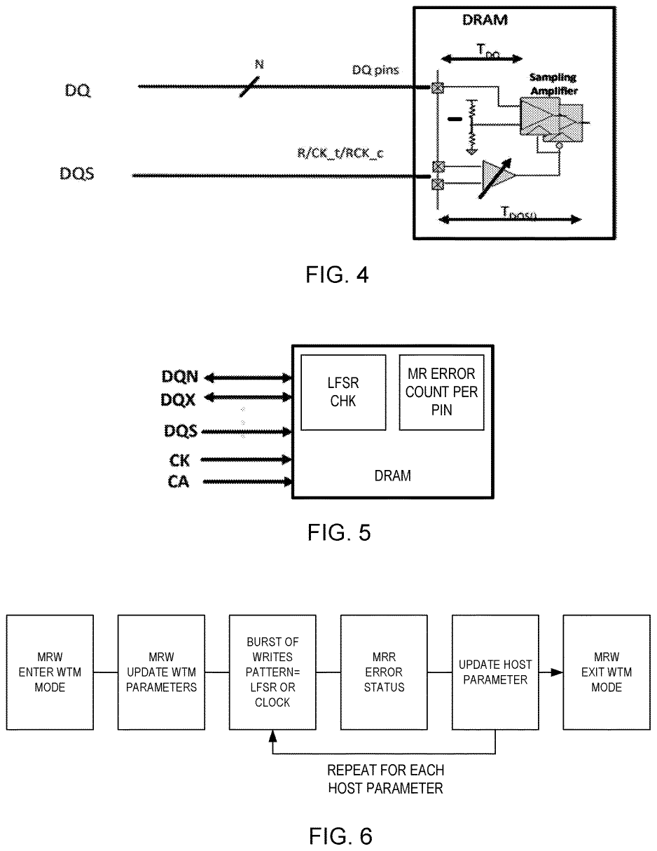

FIG. 4 illustrates a physical receive interface of a DRAM device (e.g., the memory device 300). It depicts the physical receive interface of a DRAM device. On the left, N parallel DQ data lines and a differential DQS strobe signal (labeled R/CK_t/RCK_c) arrive at the DRAM boundary. Inside the DRAM, each DQ pin connects to a sampling amplifier. In one example, the DQS strobe signal drives a clock input to the sampling amplifier, providing the timing reference at which the DQ data is sampled. Two timing parameters are indicated: T_DQ, measuring the data valid window at the DQ pins, and T_DQS( ), measuring the strobe timing.

FIG. 5 illustrates an example internal architecture of a DRAM device (e.g., the memory device 300). On the left of FIG. 5, five external signals enter the DRAM: DQN and DQX (bidirectional data signals), DQS (the strobe signal), CK (the clock), and CA (the command and address bus). Inside the DRAM, two internal blocks are shown. In an example, the first block, labeled “LFSR Chk”, receives the incoming DQN and DQX data signals and implements the pattern-check function, comparing received write data against an internally generated LFSR pattern. The second block, labeled “MR Error Count Per Pin”, receives the output of the LFSR Chk block and stores the resulting per-pin error count information in mode registers, from which the memory controller can retrieve the error status via mode register read commands. The diagram illustrates the end-to-end write data training mode data flow from the physical data pins through the pattern-check logic to the mode register error status storage.

This section describes how DDR6 WDTM works.
Write Data Training Mode Sequence
   Perform MRW to enter WTM
   Host to perform MRW to pick LFSR or clock pattern
      Host to program LFSR settings, if required
   For each unique value of the host parameters,
      Issue a series of write bursts (BL 24), with either LFSR or clock pattern
         DRAM to internally check LFSR pattern per lane
         DRAM to log error status/error counts on a per lane basis.
      Host to read out the error logs through MRRs
      Clear the error status
   Repeat the above steps for the next value/parameter.
   Perform MRW to exit WTM
Usage
   The host (e.g., the processor 102 can choose to perform this training during initialization phase and/or periodically during mission mode

FIG. 6 illustrates an example of a write data training mode sequence as described herein. It depicts the write data training mode sequence as an exemplary linear flow of six steps represented by circles connected by arrows. The sequence proceeds left to right as follows: a mode register write command (MRW) is generated and sent to enter the write data training mode. Then, a (further) mode register write command to update the write data training mode parameters. Then, the memory controller (e.g., the memory controller 200) issues a burst of write data transmissions using either an LFSR or clock pattern. Then, the memory controller may issue a mode register read command (MRR) to retrieve the error status (e.g., error indication(s) in accordance with issued burst(s) of write data transmissions. Then, the memory controller 200 may perform an update of the host transmit parameter to the next candidate value. Finally, a mode register write command may be issued to exit the write data training mode. A curved arrow above the sequence connects the MRR error status step back to the burst of writes step, indicating that the sequence from burst transmission through error status readout and host parameter update may be repeated iteratively for each host parameter value before the mode is exited.

In some further aspects described herein, in the write data training mode, the memory controller 200 may issue a write command on the command and address conductors of the physical memory channel 121 to initiate each burst of write data transmitted to the memory device 300. In response to the write command, the physical layer circuit 291 of the memory controller 200 drives a write preamble period, referred to as tWPRE, on the data strobe conductor of the relevant sub-channel, during which the data strobe transitions from an idle state to an active toggling state. Following the write preamble, the physical layer circuit 291 may drive the burst of write data onto the data lanes of the sub-channel, with each unit interval of write data aligned to the data strobe with a timing relationship referred to as tDQS2DQ between data strobe transitions and data valid windows at each unit interval boundary. The memory device 300 samples the incoming write data at each unit interval boundary defined by the write clock or strobe input 302 of the I/O and physical layer interface block 380. After the final unit interval of the burst, the physical layer circuit 291 drives a write postamble period, referred to as tWPST, on the data strobe conductor, after which the data strobe returns to its idle state. The write preamble and write postamble framing during the write data training mode correspond to the framing used during normal write operations of the memory device 300, so that the memory device 300 samples write data during the write data training mode using the same receiver timing as during normal write operations. Between successive write commands issued during the write data training mode, the memory controller 200 may issue deselect commands on the command and address conductors.

In some further aspects described herein, during the iterative transmit parameter sweep within the write data training mode, the memory controller 200 may issue one or more bursts of write data at a given transmit parameter setting, and may then issue one or more configuration-register read commands via the command and address generator 292 to retrieve the error indication stored in the memory device 300. The timing between successive configuration-register read commands during the write data training mode may conform to a dedicated timing parameter referred to as tMRR_WTM, which may differ from the timing parameter applicable to configuration-register read commands during normal operation of the memory device 300. The command decoder and control logic block 391 may enforce the tMRR_WTM timing when the write data training mode is active. After reading the error indication via the response capture path within the training and calibration engine 294, the memory controller 200 may issue a command to clear the error indication stored in the configuration and status registers block 392. The memory controller 200 may then update the transmit parameter setting via the transmit parameter control logic within the training and calibration engine 294, configuring the transmitter circuits of the physical layer circuit 291 to the next candidate value. The memory controller 200 proceeds to issue the next burst of write data at the updated transmit parameter setting and to read the corresponding error indication. The training and calibration engine 294 may store each error indication associated with each transmit parameter setting in the internal result storage structure and, after completing the sweep across the plurality of transmit parameter settings, may select a transmit parameter setting associated with reliable data reception for use during normal operation.

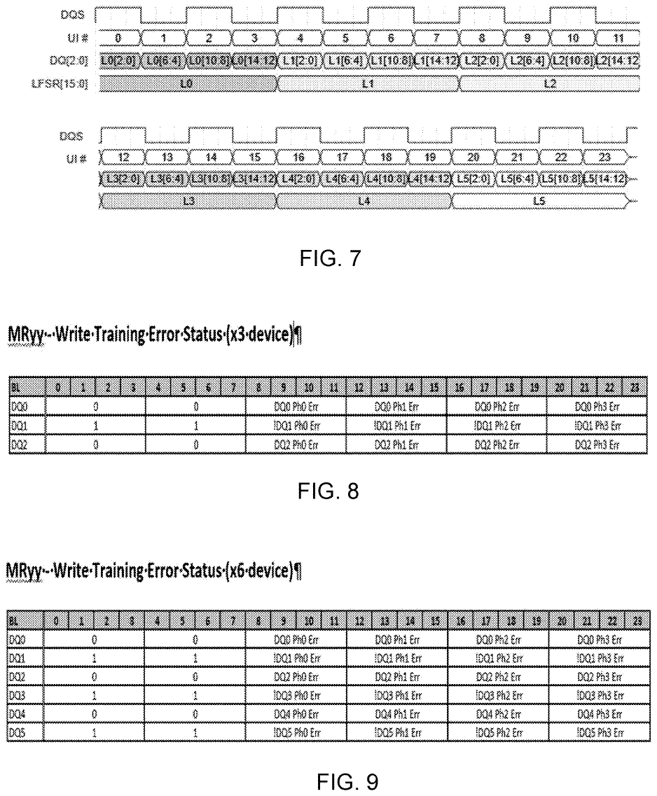

FIG. 7 illustrates a timing diagram with respect to the pattern associated with the write data training mode described herein, noting that timing diagram for UIs between 0 and 11 are provided at the upper region and UIs between 12 and 23 are provided below at the lower region below.

### Pattern Details:

LFSR: 16-bit LFSR pattern per x3
   PRBS16 polynomial with taps TBD
DRAM to internally check LFSR pattern per lane and report errors, if any, through MR;

Note: DQ LFSR (16-bit) is different from CA LFSR (16-bit) and not shared.

### Error Logging Details:

Each DQ lane will implement status registers for error status.
   Allocate 4 bits to report errors on Ph0, Ph1, Ph2 and Ph3 respectively
   Ph0 error status reports any error in UI [0,4,8,12,16,20]
   Ph1 error status reports any error in UI [1,5,9,13,17,21]
   Ph2 error status reports any error in UI [2,6,10,14,18,22]
   Ph3 error status reports any error in UI [3,7,11,15,19,23]

FIG. 8 illustrates an example of mode register layout. It depicts the mode register layout for the Write Training Error Status register (MRyy) for an x3 memory device.

FIG. 9 illustrates an example of mode register layout. It depicts the mode register layout for the Write Training Error Status register (MRyy) for an x6 memory device.

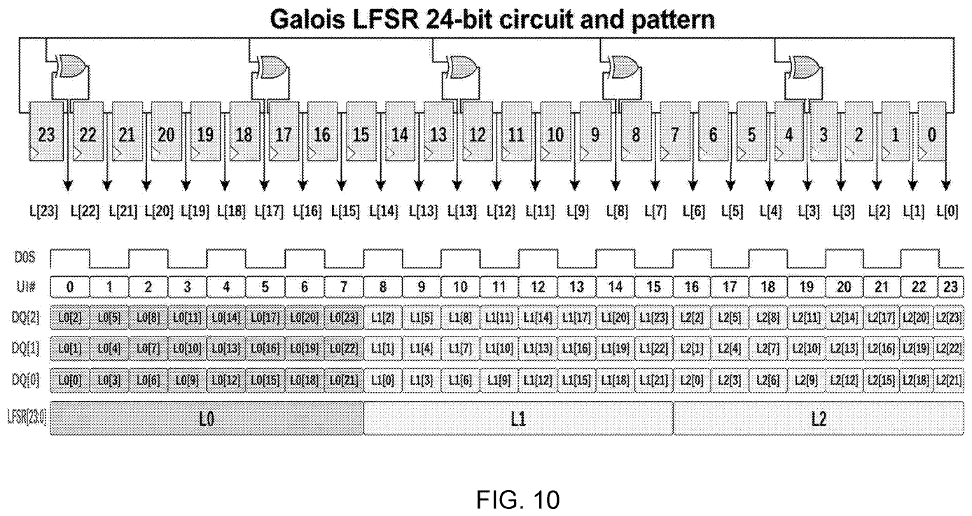

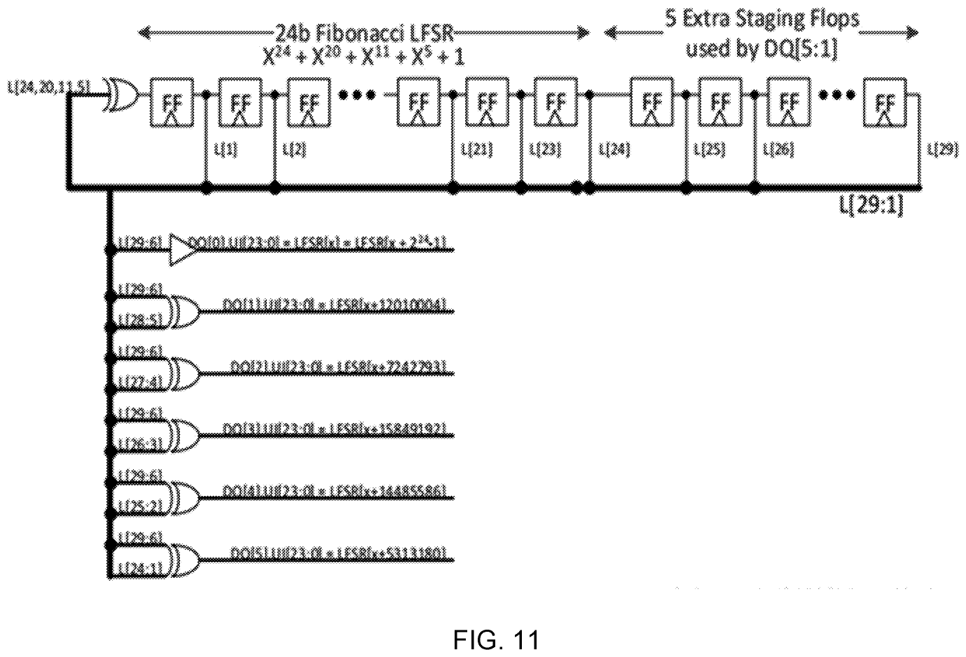

In an example, the write training error mode uses a common LFSR for both Write and Read DQ training. FIG. 10 illustrates a 24-bit Galois LFSR circuit and its corresponding timing diagram that can be used for the write training error mode. The upper portion shows the circuit schematic: a chain of 24 flip-flop stages numbered 23 down to 0 from left to right, with XOR gates inserted at specific tap positions corresponding to the feedback polynomial. Each flip-flop stage produces an output labeled L[23] through L[0]. The feedback path runs from the output of the last stage back through the XOR gates at the tap positions to create the linear feedback structure characteristic of a Galois implementation.

In an example, the write training error mode uses one Single 24 bit G-LFSR (Galois-LFSR) and the LFSR update is every 4tCK (per x3 DQ lane). In another example, the LFSR update is every 12tCK.

FIG. 11 illustrates an example of an LFSR circuit to implement Fibonacci LFSR. The depicted LFSR circuit is a 24-bit Fibonacci LFSR circuit configured to implement the polynomial X²⁴+X²⁰+X¹¹+X³+1, extended with five additional staging flip-flops, and the per-DQ XOR-tap assignments that derive the expected data pattern for each of the six data lanes of an x6 device.

The upper portion shows the circuit: a chain of 24 flip-flop stages labeled L[1] through L[23], implementing the Fibonacci LFSR with feedback taps at positions corresponding to the polynomial, fed back through an XOR gate at the input. Five additional staging flip-flops extend the chain to L[29], producing outputs L[24] through L[29] that are used by data lanes DQ[5:1].

The lower portion shows six XOR-tap assignment expressions, one per data lane. Each expression takes two inputs from the extended flip-flop chain—one from L[29:6] and one from a lane-specific tap position—and XOR-combines them to produce the 24-unit-interval expected data pattern for that lane across the BL24 burst:

$$DQ [ 0 ] UI [ 23 : 0 ] = LFSR [ x ] = LFSR [ x + {2}^{{2}^{4}} - 1 ]$$

$$DQ [ 1 ] UI [ 23 : 0 ] = LFSR [ x + 12010004 ]$$

$$DQ [ 2 ] UI [ 23 : 0 ] = LFSR [ x + 7242793 ]$$

$$DQ [ 3 ] UI [ 23 : 0 ] = LFSR [ x + 15849192 ]$$

$$DQ [ 4 ] UI [ 23 : 0 ] = LFSR [ x + 14485586 ]$$

$$DQ [ 5 ] UI [ 23 : 0 ] = LFSR [ x + 5313180 ]$$

Each data lane thus receives a distinct pseudo-random bit sequence derived from a different XOR combination of taps of the single shared Fibonacci LFSR, without requiring a separate LFSR instance per data lane. Extra bits can be assigned to 00000 or 11111.

It is to be noted that:
General Fibonacci LFSR property: For (X!=Y), (Tap[X] XOR Tap[Y]) produces Tap[Z] from same polynomial.
Whereas X and Y are usually <24, Z is a large integer (1 to 224−1) and random looking across (X,Y) combos.
Although Fibonacci XOR is slower, XOR count is the same as Galois and speed isn't an issue for BL24 operation.

### Advantages:

This uses only one LFSR per PSD to support x6 DQs
2p6 needs 2 LFSR (per Die), x3 (2p3) will have 3 unused LFSR outputs
Supports independent LFSR pattern on each DQ lanes, no need to have 6/12 different LFSR registers and multiple LFSR to save gate count and die area/cost/power etc.
To support 1p12 we need 2 LFSRs (per Die)

In accordance with various aspects described herein, the write data training mode may refer to Write DQ Training Mode, (WTM). In WTM, initial DQ link training is critical with respect to the link performance with multiple modes to enhance IO scaling and training time in system. DDR6 DRAM may require pattern capability, better pattern type that increases robustness for signal integrity interactions. The Write Training Mode provides the ability to select two pattern types with error count per pin for system level optimization. The two pattern types include LFSR independent per pin and clock pattern.

### WTM Pattern:

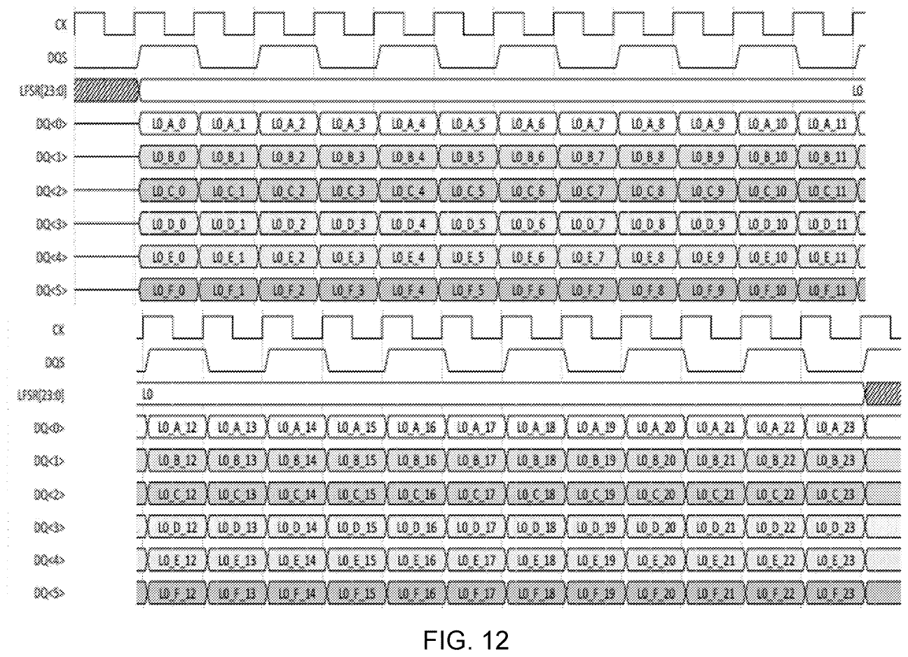

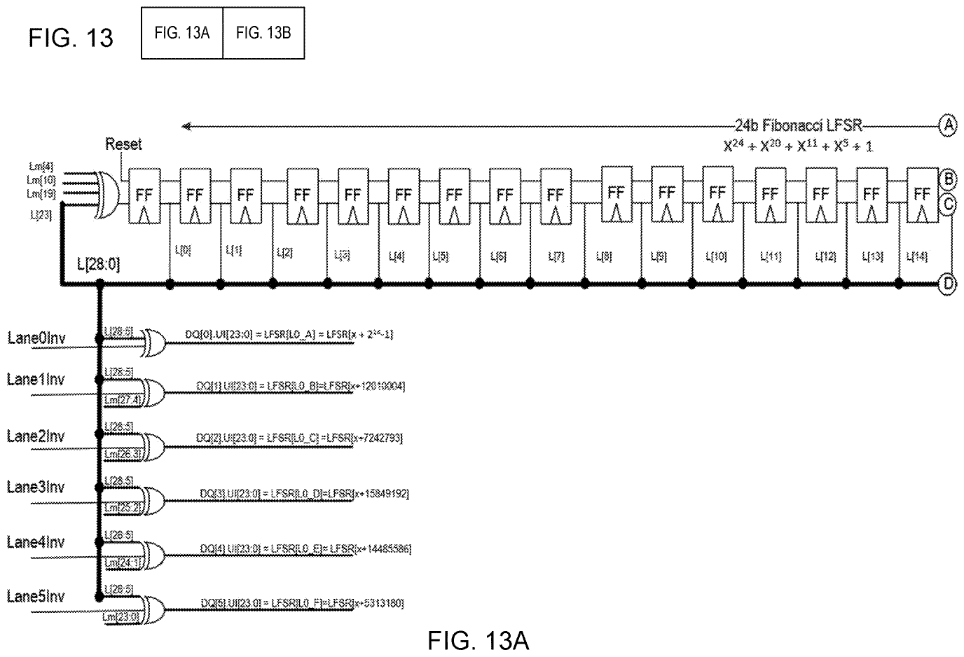

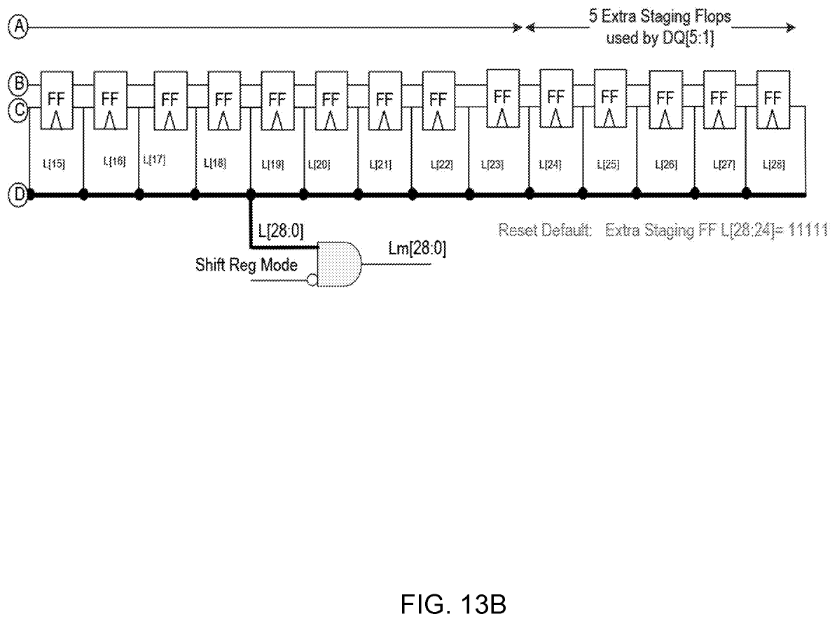

WTM can select the pattern type between clock vs LFSR with MR setting (MRyy). The LFSR mode provides an independent (different pattern) per lane using a single 24-bit Fibonacci LFSR per pseudo split die (PSD). The polynomial for the Fibonacci LFSR is x\hat{ }24+x\hat{ }20+x\hat{ }11+x\hat{ }5+1. The user (Ex: Clock) pattern would operate at the DQ rate for another option for system optimization on drift terms like Rx DQS2DQ. Each mode provides a per pin error count logging. FIG. 12 shows the Fibonacci LFSR-24 pattern details. FIG. 13 shows the details about Fibonacci LFSR circuit for (X!=Y), (Tap[X] XOR Tap[Y]) produces Tap[Z] from same polynomial, whereas X and Y are usually <24, Z is a large integer (1 to 2\hat{ }24−1) and random looking across (X,Y) combos.

FIG. 12 shows an example of Fibonacci LFSR-24 pattern details. It is an exemplary depiction of a timing diagram showing the Fibonacci LFSR 24-bit pattern mapping across a BL24 burst for an x6 device, noting that the diagram is presented in two horizontal halves covering unit intervals 0 through 11 and unit intervals 12 through 23 respectively.

FIG. 13 shows an example of a Fibonacci LFSR circuit. It composes of FIG. 13A and FIG. 13B. FIG. 13 depicts another example of 24-bit Fibonacci LFSR circuit implementing the polynomial X²⁴+X²⁰+X¹¹+X⁵+1, extended with five additional staging flip-flops, and the per-lane XOR-tap assignments for six DQ lanes.

The circuit includes 29 flip-flop stages labeled L[0] through L[28], with feedback taps at positions corresponding to the polynomial fed through an XOR gate at the input. A reset input is shown at the left, with the default LFSR seed value LFSR [23:0] loaded at reset and the five staging flip-flops L[28:24] initialized to 11111 by default. A shift register mode input is shown controlling a multiplexer that selects between normal LFSR operation and shift register loading mode using Lm[28:0].

Six per-lane XOR-tap assignment expressions are shown below the circuit, each combining L[28:5] with a lane-specific tap via an XOR gate, followed by a per-lane inversion control (Lane0Inv through Lane5Inv):

$$DQ [ 0 ] UI [ 23 : 0 ] = LFSR [ L0\_A ] = LFSR [ x + {2}^{24} - 1 ]$$

$$DQ [ 1 ] UI [ 23 : 0 ] = LFSR [ L0\_B ] = LFSR [ x + 12010004 ]$$

$$DQ [ 2 ] UI [ 23 : 0 ] = LFSR [ L0\_C ] = LFSR [ x + 7242793 ]$$

$$DQ [ 3 ] UI [ 23 : 0 ] = LFSR [ L0\_D ] = LFSR [ x + 15849192 ]$$

$$DQ [ 4 ] UI [ 23 : 0 ] = LFSR [ L0\_E ] = LFSR [ x + 14485586 ]$$

$$DQ [ 5 ] UI [ 23 : 0 ] = LFSR [ L0\_F ] = LFSR [ x + 5313180 ]$$

In accordance with various aspects described herein, a pattern generation circuitry for the WTM may include PRBS Pattern Generator for WTM. PRBS generator will start with the default seed (Example 24b LFSR Seed: F7310E) and the below LFSR pattern table shows the example of shift mode where each DQ lanes gets different pattern on the lane. Table 1 below illustrates the mapping of the pattern to DQ[5:0].

In some further aspects described herein, In various aspects described herein, the extended 29-stage Fibonacci LFSR includes 24 flip-flop stages implementing the main LFSR and five additional staging flip-flops designated L[28:24]. Upon a seed reset operation, the five staging flip-flops L[28:24] may be initialized to a default value of 11111. When programming the LFSR seed via configuration-register commands of a write type, the memory controller may program the seed bits corresponding to positions [23:5] via the LFSR seed registers within the configuration and status registers block 392 of the memory device 300. The seed bits corresponding to positions [4:0] may be to be calculated by the memory controller to correctly initialize the LFSR, taking into account the fixed initialization value of the staging flip-flops. This constraint can arise because the staging flip-flops are loaded to the default value upon reset, and the values of the first five positions of the LFSR are determined by the LFSR polynomial and the values loaded into positions [23:5]. This seed programming constraint may apply to both the write data training mode and the host receiver training mode when the same LFSR hardware is shared between the two modes, as described herein. The memory controller may program the LFSR seed independently per per-sub-channel domain 397 of the memory device 300, so that different per-sub-channel domains 397 may operate with different seed values during the same training sequence. A default seed value, for example F7310E in hexadecimal notation, may be defined for the LFSR, and the memory controller may use the default seed value or may program a different seed value as appropriate for the training sequence.

TABLE 1
LFSR Pattern for Write Training Mode:

| | L0 | L1 | L2 | L3 | L4 | L5 | L6 | L7 | L8 | L9 | L10 | L11 | L12 | L13 | L14 |
|---|---|---|---|---|---|---|---|---|---|---|---|---|---|---|---|
| LFSRSeed | 0 | 1 | 1 | 1 | 0 | 0 | 0 | 0 | 1 | 0 | 0 | 0 | 1 | 1 | 0 |
| UI | 0 | 1 | 2 | 3 | 4 | 5 | 6 | 7 | 8 | 9 | 10 | 11 | 12 | 13 | 14 |
| DQ0 | 0 | 0 | 0 | 1 | 0 | 0 | 0 | 1 | 1 | 0 | 0 | 1 | 1 | 1 | 0 |
| DQ1 | 0 | 0 | 0 | 1 | 1 | 0 | 0 | 1 | 0 | 1 | 0 | 1 | 0 | 0 | 1 |
| DQ2 | 1 | 0 | 0 | 1 | 0 | 1 | 0 | 1 | 1 | 1 | 1 | 1 | 1 | 0 | 1 |
| DQ3 | 1 | 1 | 0 | 1 | 0 | 0 | 1 | 1 | 1 | 0 | 1 | 0 | 1 | 1 | 1 |
| DQ4 | 1 | 1 | 1 | 1 | 0 | 0 | 0 | 0 | 1 | 0 | 0 | 0 | 0 | 1 | 0 |
| DQ5 | 0 | 1 | 1 | 0 | 0 | 0 | 0 | 1 | 0 | 0 | 0 | 1 | 0 | 0 | 0 |
| | L15 | L16 | L17 | L18 | L19 | L20 | L21 | L22 | L23 | L24 | L25 | L26 | L27 | L28 | |
| LFSRSeed | 0 | 1 | 1 | 1 | 0 | 1 | 1 | 1 | 1 | 1 | 1 | 1 | 1 | 1 | |
| UI | 15 | 16 | 17 | 18 | 19 | 20 | 21 | 22 | 23 | | | | | | |
| DQ0 | 1 | 1 | 1 | 1 | 1 | 1 | 1 | 1 | 1 | | | | | | |
| DQ1 | 1 | 0 | 0 | 0 | 0 | 0 | 0 | 0 | 0 | | | | | | |
| DQ2 | 0 | 1 | 0 | 0 | 0 | 0 | 0 | 0 | 0 | | | | | | |
| DQ3 | 0 | 0 | 1 | 0 | 0 | 0 | 0 | 0 | 0 | | | | | | |
| DQ4 | 0 | 0 | 0 | 1 | 0 | 0 | 0 | 0 | 0 | | | | | | |
| DQ5 | 1 | 0 | 0 | 0 | 1 | 0 | 0 | 0 | 0 | | | | | | |
| | L0 | L1 | L2 | L3 | L4 | L5 | L6 | L7 | L8 | L9 | L10 | L11 | L12 | L13 | L14 |
| Shift1 | 1 | 0 | 1 | 1 | 1 | 0 | 0 | 0 | 0 | 1 | 0 | 0 | 0 | 1 | 1 |
| UI | 24 | 25 | 26 | 27 | 28 | 29 | 30 | 31 | 32 | 33 | 34 | 35 | 36 | 37 | 38 |
| DQ0 | 0 | 0 | 0 | 0 | 1 | 0 | 0 | 0 | 1 | 1 | 0 | 0 | 1 | 1 | 1 |
| DQ1 | 1 | 0 | 0 | 0 | 1 | 1 | 0 | 0 | 1 | 0 | 1 | 0 | 1 | 0 | 0 |
| DQ2 | 1 | 1 | 0 | 0 | 1 | 0 | 1 | 0 | 1 | 1 | 1 | 1 | 1 | 1 | 0 |
| DQ3 | 1 | 1 | 1 | 0 | 1 | 0 | 0 | 1 | 1 | 1 | 0 | 1 | 0 | 1 | 1 |
| DQ4 | 0 | 1 | 1 | 1 | 1 | 0 | 0 | 0 | 0 | 1 | 0 | 0 | 0 | 0 | 1 |
| DQ5 | 1 | 0 | 1 | 1 | 0 | 0 | 0 | 0 | 1 | 0 | 0 | 0 | 1 | 0 | 0 |
| | L15 | L16 | L17 | L18 | L19 | L20 | L21 | L22 | L23 | L24 | L25 | L26 | L27 | L28 | |
| Shift1 | 0 | 0 | 1 | 1 | 1 | 0 | 1 | 1 | 1 | 1 | 1 | 1 | 1 | 1 | |
| UI | 39 | 40 | 41 | 42 | 43 | 44 | 45 | 46 | 47 | | | | | | |
| DQ0 | 0 | 1 | 1 | 1 | 1 | 1 | 1 | 1 | 1 | | | | | | |
| DQ1 | 1 | 1 | 0 | 0 | 0 | 0 | 0 | 0 | 0 | | | | | | |
| DQ2 | 1 | 0 | 1 | 0 | 0 | 0 | 0 | 0 | 0 | | | | | | |
| DQ3 | 1 | 0 | 0 | 1 | 0 | 0 | 0 | 0 | 0 | | | | | | |
| DQ4 | 0 | 0 | 0 | 0 | 1 | 0 | 0 | 0 | 0 | | | | | | |
| DQ5 | 0 | 1 | 0 | 0 | 0 | 1 | 0 | 0 | 0 | | | | | | |
| | L0 | L1 | L2 | L3 | L4 | L5 | L6 | L7 | L8 | L9 | L10 | L11 | L12 | L13 | L14 |
| Shift2 | 1 | 1 | 0 | 1 | 1 | 1 | 0 | 0 | 0 | 0 | 1 | 0 | 0 | 0 | 1 |
| UI | 48 | 49 | 50 | 51 | 52 | 53 | 54 | 55 | 56 | 57 | 58 | 59 | 60 | 61 | 62 |
| DQ0 | 1 | 0 | 0 | 0 | 0 | 1 | 0 | 0 | 0 | 1 | 1 | 0 | 0 | 1 | 1 |
| DQ1 | 0 | 1 | 0 | 0 | 0 | 1 | 1 | 0 | 0 | 1 | 0 | 1 | 0 | 1 | 0 |
| DQ2 | 0 | 1 | 1 | 0 | 0 | 1 | 0 | 1 | 0 | 1 | 1 | 1 | 1 | 1 | 1 |
| DQ3 | 1 | 1 | 1 | 1 | 0 | 1 | 0 | 0 | 1 | 1 | 1 | 0 | 1 | 0 | 1 |
| DQ4 | 0 | 0 | 1 | 1 | 1 | 1 | 0 | 0 | 0 | 0 | 1 | 0 | 0 | 0 | 0 |
| DQ5 | 0 | 1 | 0 | 1 | 5 | 0 | 0 | 0 | 0 | 1 | 0 | 0 | 0 | 1 | 0 |
| | L15 | L16 | L17 | L18 | L19 | L20 | L21 | L22 | L23 | L24 | L25 | L26 | L27 | L28 | |
| Shift2 | 1 | 0 | 0 | 1 | 1 | 1 | 0 | 1 | 1 | 1 | 1 | 1 | 1 | 1 | |
| UI | 63 | 64 | 65 | 66 | 67 | 68 | 69 | 70 | 71 | | | | | | |
| DQ0 | 1 | 0 | 1 | 1 | 1 | 1 | 1 | 1 | 1 | | | | | | |
| DQ1 | 0 | 1 | 1 | 0 | 0 | 0 | 0 | 0 | 0 | | | | | | |
| DQ2 | 0 | 1 | 0 | 1 | 0 | 0 | 0 | 0 | 0 | | | | | | |
| DQ3 | 1 | 1 | 0 | 0 | 1 | 0 | 0 | 0 | 0 | | | | | | |
| DQ4 | 1 | 0 | 0 | 0 | 0 | 1 | 0 | 0 | 0 | | | | | | |
| DQ5 | 0 | 0 | 1 | 0 | 0 | 0 | 1 | 0 | 0 | | | | | | |
| | L0 | L1 | L2 | L3 | L4 | L5 | L6 | L7 | L8 | L9 | L10 | L11 | L12 | L13 | L14 |
| Shift3 | 0 | 1 | 1 | 0 | 1 | 1 | 1 | 0 | 0 | 0 | 0 | 1 | 0 | 0 | 0 |
| UI | 72 | 73 | 74 | 75 | 76 | 77 | 78 | 79 | 80 | 81 | 82 | 83 | 84 | 85 | 86 |
| DQ0 | 1 | 1 | 0 | 0 | 0 | 0 | 1 | 0 | 0 | 0 | 1 | 1 | 0 | 0 | 1 |
| DQ1 | 0 | 0 | 1 | 0 | 0 | 0 | 1 | 1 | 0 | 0 | 1 | 0 | 1 | 0 | 1 |
| DQ2 | 1 | 0 | 1 | 1 | 0 | 0 | 1 | 0 | 1 | 0 | 1 | 1 | 1 | 1 | 1 |
| DQ3 | 0 | 1 | 1 | 1 | 1 | 0 | 1 | 0 | 0 | 1 | 1 | 1 | 0 | 1 | 0 |
| DQ4 | 0 | 0 | 0 | 1 | 1 | 1 | 1 | 0 | 0 | 0 | 0 | 1 | 0 | 0 | 0 |
| DQ5 | 1 | 0 | 1 | 0 | 1 | 1 | 0 | 0 | 0 | 0 | 1 | 0 | 0 | 0 | 1 |
| | L15 | L16 | L17 | L18 | L19 | L20 | L21 | L22 | L23 | L24 | L25 | L26 | L27 | L28 | |
| Shift3 | 1 | 1 | 0 | 0 | 1 | 1 | 1 | 0 | 1 | 1 | 1 | 1 | 1 | 1 | |
| UI | 87 | 88 | 89 | 90 | 91 | 92 | 93 | 94 | 95 | | | | | | |
| DQ0 | 1 | 1 | 0 | 1 | 1 | 1 | 1 | 1 | 1 | | | | | | |
| DQ1 | 0 | 0 | 1 | 1 | 0 | 0 | 0 | 0 | 0 | | | | | | |
| DQ2 | 1 | 0 | 1 | 0 | 1 | 0 | 0 | 0 | 0 | | | | | | |
| DQ3 | 1 | 1 | 1 | 0 | 0 | 1 | 0 | 0 | 0 | | | | | | |
| DQ4 | 0 | 1 | 0 | 0 | 0 | 0 | 1 | 0 | 0 | | | | | | |
| DQ5 | 0 | 0 | 0 | 1 | 0 | 0 | 0 | 1 | 0 | | | | | | |
| | L0 | L1 | L2 | L3 | L4 | L5 | L6 | L7 | L8 | L9 | L10 | L11 | L12 | L13 | L14 |
| Shift4 | 1 | 0 | 1 | 1 | 0 | 1 | 1 | 1 | 0 | 0 | 0 | 0 | 1 | 0 | 0 |
| UI | 96 | 97 | 98 | 99 | 100 | 101 | 102 | 103 | 104 | 105 | 106 | 107 | 108 | 109 | 110 |
| DQ0 | 1 | 1 | 1 | 0 | 0 | 0 | 0 | 1 | 0 | 0 | 0 | 1 | 1 | 0 | 0 |
| DQ1 | 1 | 0 | 0 | 1 | 0 | 0 | 0 | 1 | 1 | 0 | 0 | 1 | 0 | 1 | 0 |
| DQ2 | 0 | 1 | 0 | 1 | 1 | 0 | 0 | 1 | 0 | 1 | 0 | 1 | 1 | 1 | 1 |
| DQ3 | 0 | 0 | 1 | 1 | 1 | 1 | 0 | 1 | 0 | 0 | 1 | 1 | 1 | 0 | 1 |
| DQ4 | 1 | 0 | 0 | 0 | 1 | 1 | 1 | 1 | 0 | 0 | 0 | 0 | 1 | 0 | 0 |
| DQ5 | 0 | 1 | 0 | 1 | 0 | 1 | 1 | 0 | 0 | 0 | 0 | 1 | 0 | 0 | 0 |
| | L15 | L16 | L17 | L18 | L19 | L20 | L21 | L22 | L23 | L24 | L25 | L26 | L27 | L28 | |
| Shift4 | 0 | 1 | 1 | 0 | 0 | 1 | 1 | 1 | 0 | 1 | 1 | 1 | 1 | 1 | |
| UI | 111 | 112 | 113 | 114 | 115 | 116 | 117 | 118 | 119 | | | | | | |
| DQ0 | 1 | 1 | 1 | 0 | 1 | 1 | 1 | 1 | 1 | | | | | | |
| DQ1 | 1 | 0 | 0 | 1 | 1 | 0 | 0 | 0 | 0 | | | | | | |
| DQ2 | 1 | 1 | 0 | 1 | 0 | 1 | 0 | 0 | 0 | | | | | | |
| DQ3 | 0 | 1 | 1 | 1 | 0 | 0 | 1 | 0 | 0 | | | | | | |
| DQ4 | 0 | 0 | 1 | 0 | 0 | 0 | 0 | 1 | 0 | | | | | | |
| DQ5 | 1 | 0 | 0 | 0 | 1 | 0 | 0 | 0 | 1 | | | | | | |

In accordance with various aspects described herein, an entry and exit for WTM includes the following: To enter Write Training Mode (WTM), the host memory controller shall issue a Mode Register Write (MRW) command targeting MRyy OP[2]=1B, with the Write Training Mode entry opcode. When the DRAM is in Write Training mode, commands are still actively processed. To exit Write Training Mode, the host memory controller shall issue an MRW command to MRyy OP [2]=OB, with the Write Training Mode Exit opcode.

In accordance with various aspects described herein, in WTM Operation:
The host enters WTM using MRW command and follows the sequence below;
   1. Perform MRW to enter WTM
   2. Host to perform MRW to pick LFSR (24-bit) or User pattern
   a. Host to program LFSR seed settings
   3. For each unique value of the host parameters,
   a. Issue a series of Write bursts (BL 24), with either LFSR or User pattern
      i. DRAM to internally check LFSR pattern per DQ lane
      ii. DRAM to log error status/error counts on a per lane basis
   b. Host to read out the error logs through MRRs
      1. MRR to MRR timing in WTM shall use tMRR_WTM timing parameter as described in Mode register read section x.x.X.X.
   c. Clear the error status
   4. Repeat the above steps for the next value/parameter.
   5. Perform MRW to exit WTM

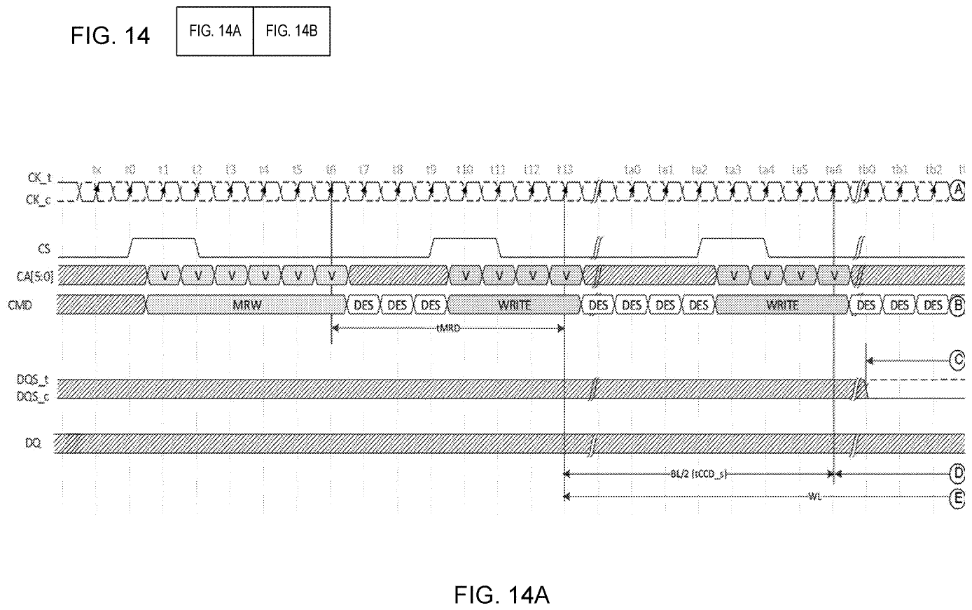

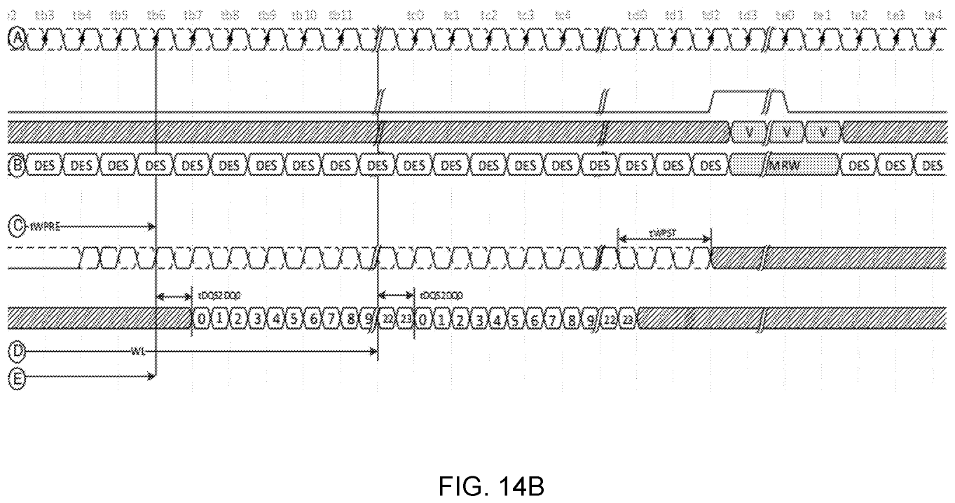

FIG. 14 shows an example of Write DQ Training Mode Timing.

Write Training Mode Registers may be configured as the following:

### MRxx OP[7:0]—Write Training Mode Register

| OP[7] | OP[6] | OP[5] | OP[4] | OP[3] | OP[2] | OP[1] | OP[0] |
|---|---|---|---|---|---|---|---|
| RFU | RFU | Shift | RFU | LFSR | Clear | WTM | LFSR/Write |
| | | Reg Mode | | Reset | Errors | Enable | Training |
| | | | | | | | Pattern |
| | | | | | | | Selection |

| Function | Register Type | Operand | Data | Notes |
|---|---|---|---|---|
| Write | R/W | OP[0] | 1b0: User | |
| Training | | | defined | |
| Pattern | | | write pattern | |
| Selection | | | 1b1: LFSR | |
| WTM | R/W | OP[1] | 1b0: Disable | |
| Enable | | | 1b1: Enable | |
| Clear | R/W | OP[2] | 1b0: | |
| Errors | | | 1b1: | |
| Seed | R/W | OP[3] | 1b0: Disable | |
| Reset | | | 1b1: Reset to | |
| | | | default both | |
| | | | LFSR and | |
| | | | 5b-Staging | |
| | | | Flip flops | |
| | | | (auto clears | |
| | | | after resetting) | |
| RFU | R/W | OP[4] | RFU | |
| Shift Reg | R/W | OP[5] | 0-Disable | |
| Mode | | | 1-Enable | |
| RFU | R/W | OP[6] | RFU | |
| RFU | R/W | OP[7] | RFU | |

An independent 24-bit Fibonacci LFSR generator provides patterns for up to 6 DQ lanes. The source of the DQ output pattern shall be selected via MRxx:OP[0], where this field selects between LFSR output and the user-defined read pattern resource. When MRxx:OP[5]=1, the LFSR shift-register mode shall be enabled. The WTM function shall be enabled or disabled through a Mode Register Write (MRW) to MRxx:OP[1]. The MRxx[3] field shall be used to reset the LFSR seed value and associated staging flip-flops. Upon reset, the 5-bit staging flip-flops shall be initialized to their default value of 11111.

If MRxx[0] is set to 1b0, MRxy0 to MRxy2 contains the user-defined pattern (Read Pattern).

If MRXX[O] is set to 1b1 and MRxx[2] is set to 1b0, then the training shall use LFSR generator and The MRyz0-MRyz3 registers allow users to select LFSR Seed register UI23-0 and MRzz0 is used to assign Pattern Inversion per DQ lane.

Note: For 2p3/2p6/1p6 configurations need one 3 mode registers and to support 1p12 configuration. It needs additional 3 more mode registers to support DQ<11:6> (since it needs 2 LFSR per PSD)

MRxy0—LFSR Seed/Write Pattern Register 0 may be configured as the following:

| | | | | | | | |
|---|---|---|---|---|---|---|---|
| OP[7] | OP[6] | OP[5] | OP[4] | OP[3] | OP[2] | OP[1] | OP[0] |

LFSR Seed/Write Pattern UI[7:0]

| | Register | Oper- | | |
|---|---|---|---|---|
| Function | Type | and | Data | Notes |
| LFSR | R/W | OP[0] | | |
| Seed/Write | | | | |
| Pattern UI0 | | | | |
| LFSR | R/W | OP[1] | | |
| Seed/Write | | | | |
| Pattern UI1 | | | | |
| LFSR | R/W | OP[2] | | |
| Seed/Write | | | | |
| Pattern UI2 | | | | |
| LFSR | R/W | OP[3] | | |
| Seed/Write | | | | |
| Pattern UI3 | | | | |
| LFSR | R/W | OP[4] | | |
| Seed/Write | | | | |
| Pattern UI4 | | | | |
| LFSR | RFU | OP[5] | | |
| Seed/Write | | | | |
| Pattern UI5 | | | | |
| LFSR | R/W | OP[6] | | |
| Seed/Write | | | | |
| Pattern UI6 | | | | |
| LFSR | R/W | OP[7] | | |
| Seed/Write | | | | |
| Pattern UI7 | | | | |

### MRxy1—LFSR Seed/Write Pattern Register 1

| | | | | | | |
|---|---|---|---|---|---|---|
| OP[7] | OP[6] | OP[5] | OP[4] | OP[3] | OP[2] | OP[1] |

LFSR Seed/Write Pattern UI[15:8]

| [0001] Funcion | [0002] Registe | [0003] | [0004] | [[0005] N |
|---|---|---|---|---|
| [symbol] | [symbol] | [symbol] | [symbol] | [symbol] |
| [0006] LFSR | [0008] R/W | [0009] | [0010] | [0011] |
| [symbol] | | [symbol] | | |
| [0012] LFSR | [0014] R/W | [0015] | [0016] | [0017] |
| [symbol] | | [symbol] | | |
| [0018] LFSR | [0020] R/W | [0021] | [0022] | [0023] |
| [symbol] | | [symbol] | | |
| [0024] LFSR | [0026] R/W | [0027] | [0028] | [0029] |
| [symbol] | | [symbol] | | |
| [0030] LFSR | [0032] R/W | [0033] | [0034] | [0035] |
| [symbol] | | [symbol] | | |
| [0036] LFSR | [0038] RFU | [0039] | [0040] | [004]] |
| [symbol] | | [symbol] | | |
| [0042] LFSR | [0044] R/W | [0045] | [0046] | [0047] |
| [symbol] | | [symbol] | | |
| [0048] LFSR | [0050] R/W | [0051] | ([0052] | [0053] |
| [symbol] | | [symbol] | | |

[symbol]

indicates data missing or illegible when filed

### MRxy1—LFSR Seed/Write Pattern Register 2

| | | | | | | | |
|---|---|---|---|---|---|---|---|
| OP[7] | OP[6] | OP[5] | OP[4] | OP[3] | OP[2] | OP[1] | OP[0] |

LFSR Seed/Write Pattern UI[23:16]

| | Register | Oper- | | |
|---|---|---|---|---|
| Function | Type | and | Data | Notes |
| LFSR | R/W | OP[0] | | |
| Seed/Write | | | | |
| Pattern UI16 | | | | |
| LFSR | R/W | OP[1] | | |
| Seed/Write | | | | |
| Pattern UI17 | | | | |
| LFSR | R/W | OP[2] | | |
| Seed/Write | | | | |
| Pattern UI18 | | | | |
| LFSR | R/W | OP[3] | | |
| Seed/Write | | | | |
| Pattern UI19 | | | | |
| LFSR | R/W | OP[4] | | |
| Seed/Write | | | | |
| Pattern UI20 | | | | |
| LFSR | RFU | OP[5] | | |
| Seed/Write | | | | |
| Pattern UI21 | | | | |
| LFSR | R/W | OP[6] | | |
| Seed/Write | | | | |
| Pattern UI22 | | | | |
| LFSR | R/W | OP[7] | | |
| Seed/Write | | | | |
| Pattern UI23 | | | | |

Note:
If a per DQ lane pattern register is required, then replicate MRxy > 2:0 > for all DQ lanes.

### MRzz—Pattern Inversion Control Register 0

| OP[7] | OP[6] | OP[5] | OP[4] | OP[3] | OP[2] | OP[1] | OP[0] |
|---|---|---|---|---|---|---|---|
| RFU | RFU | Pattern | Pattern | Pattern | Pattern | Pattern | Pattern |
| | | Inver- | Inver- | Inver- | Inver- | Inver- | Inver- |
| | | sion | sion | sion | sion | sion | sion |
| | | DQ5 | DQ4 | DQ3 | DQ2 | DQ1 | DQ0 |

| | Register | Oper- | | |
|---|---|---|---|---|
| Function | Type | and | Data | Notes |
| Pattern | R/W | OP[0] | 1b0: Normal | |
| Inversion DQ0 | | | 1b1: Invert | |
| Pattern | R/W | OP[1] | 1b0: Normal | |
| Inversion DQ1 | | | 1b1: Invert | |
| Pattern | R/W | OP[2] | 1b0: Normal | |
| Inversion DQ2 | | | 1b1: Invert | |
| Pattern | R/W | OP[3] | 1b0: Normal | |
| Inversion DQ3 | | | 1b1: Invert | |
| Pattern | R/W | OP[4] | 1b0: Normal | |
| Inversion DQ4 | | | 1b1: Invert | |
| Pattern | R/W | OP[5] | 1b0: Normal | |
| Inversion DQ5 | | | 1b1: Invert | |
| RFU | RFU | OP[6] | RFU | |
| RFU | RFU | OP[7] | RFU | |

### MRzz—Pattern Inversion Control Register

| OP[7] | OP[6] | OP[5] | OP[4] | OP[3] | OP[2] | OP[1] | OP[0] |
|---|---|---|---|---|---|---|---|
| RFU | RFU | Pattern | Pattern | Pattern | Pattern | Pattern | Pattern |
| | | Inver- | Inver- | Inver- | Inver- | Inver- | Inver- |
| | | sion | sion | sion | sion | sion | sion |
| | | DQ11 | DQ10 | DQ9 | DQ8 | DQ7 | DQ6 |

| | Register | Oper- | | |
|---|---|---|---|---|
| Function | Type | and | Data | Notes |
| Pattern | R/W | OP[0] | 1b0: Normal | |
| Inversion | | | 1b1: Invert | |
| DQ6 | | | | |
| Pattern | R/W | OP[1] | 1b0: Normal | |
| Inversion | | | 1b1: Invert | |
| DQ7 | | | | |
| Pattern | R/W | OP[2] | 1b0: Normal | |
| Inversion | | | 1b1: Invert | |
| DQ8 | | | | |
| Pattern | R/W | OP[3] | 1b0: Normal | |
| Inversion | | | 1b1: Invert | |
| DQ9 | | | | |
| Pattern | R/W | OP[4] | 1b0: Normal | |
| Inversion | | | 1b1: Invert | |
| DQ10 | | | | |
| Pattern | R/W | OP[5] | 1b0: Normal | |
| Inversion | | | 1b1: Invert | |
| DQ11 | | | | |
| RFU | RFU | OP[6] | RFU | |
| RFU | RFU | OP[7] | RFU | |

Error Logging: Each DQ lane will implement status registers for error status. DRAM shall allocate 2UI for DQ lane to report phase errors Ph0 and Ph1 as described below:
Ph0 error status reports any error in Even UI [0,2,4,6,8,10,12,14,16,18,20,22]
Ph1 error status reports any error in Odd UI [1,3,5,7,9,11,13,15,17,19,21,23]

| OP7 | OP6 | OP5 | OP4 | OP3 | OP2 | OP1 | OP0 |
|---|---|---|---|---|---|---|---|
| RFU | RFU | DQ2Ph1 | DQ2Ph0 | DQ1Ph1 | DQ1Ph0 | DQ0Ph1 | DQ0Ph0 |
| RFU | RFU | DQ5Ph1 | DQ5Ph0 | DQ4Ph1 | DQ4Ph0 | DQ3Ph1 | DQ3Ph0 |
| RFU | RFU | DQ8Ph1 | DQ8Ph0 | DQ7Ph1 | DQ7Ph0 | DQ6Ph1 | DQ6Ph0 |
| RFU | RFU | DQ11Ph1 | DQ11Ph0 | DQ10Ph1 | DQ10Ph0 | DQ9Ph1 | DQ9Ph0 |

In another example, the memory device allocates four bits per data lane to report phase errors designated Ph0, Ph1, Ph2, and Ph3. In this four-phase configuration, Ph0 reports an error in unit intervals [0, 4, 8, 12, 16, 20], Ph1 reports an error in unit intervals [1, 5, 9, 13, 17, 21], Ph2 reports an error in unit intervals [2, 6, 10, 14, 18, 22], and Ph3 reports an error in unit intervals [3, 7, 11, 15, 19, 23].

The mode register architecture described herein, may provide an exemplary implementation of the configuration-register command mechanism, by which the memory controller 200 enters and exits the write data training mode, selects the expected data pattern type, programs the LFSR seed, and clears error indications within the memory device 300. The write data training mode enable function, the pattern selection function, the error clear function, the seed reset function, and the shift register mode function may each be assigned to a dedicated operand bit within a write training mode control register accessible via configuration-register commands of a write type generated by the command and address generator 292 of the memory controller 200, and decoded by the command decoder and control logic block 391 of the memory device 300. The LFSR seed value, covering all 24 unit intervals of the burst length, can be loadable across three dedicated seed and write pattern registers via configuration-register commands of a write type, providing the seed loading mechanism identified as an enablement requirement in the aspects described herein. A default seed value may be defined for the LFSR, and the five staging flip-flops of the extended 29-stage circuit are initialized to a default value of 11111 upon reset, ensuring a known starting state at the beginning of each write data training mode invocation without requiring explicit seed programming by the memory controller 200 in every training sequence.

The per-lane pattern inversion control may further correspond to the expected data pattern, in which the expected data pattern for a given data lane of the plurality of data lanes may be the logical inverse of the pattern produced by the LFSR tap combination assigned to that lane. The pattern inversion function may be configurable independently per data lane via a dedicated pattern inversion control register accessible by configuration-register commands of a write type issued by the memory controller 200. In the context of the memory device 300, the per-lane inversion control signals, designated Lane0Inv through Lane5Inv, can be applied within the pattern-check and data comparison block 399 between the XOR-tap output of the shared LFSR and the comparison logic for each respective data lane of the data lane interface 301. This inversion capability may support the respective expected data patterns for different data lanes differing from one another, and extend that differentiation beyond the XOR-tap offset mechanism to include configurable polarity control on a per-lane basis. The per-lane inversion control may be programmable via the configuration and status registers block 392 of the memory device 300, under the control of the command decoder and control logic block 391.

The error logging architecture may correspond to the phase-specific error indications, in which two phase-specific error indications are allocated per data lane of the plurality of data lanes: a first phase-specific error indication designated Ph0, associated with the subset of even-numbered unit intervals within the burst, e.g., unit intervals 0, 2, 4, 6, 8, 10, 12, 14, 16, 18, 20, and 22, and a second phase-specific error indication designated Ph1, associated with the subset of odd-numbered unit intervals, e.g., unit intervals 1, 3, 5, 7, 9, 11, 13, 15, 17, 19, 21, and 23. Each phase-specific error indication may occupy one bit of a write training mode error status register within the status register portion of the configuration and status registers block 392 of the memory device 300, with three data lanes packed per eight-bit register and two bits allocated per data lane for Ph0 and Ph1 respectively. The memory controller 200 retrieves the phase-specific error indications by issuing configuration-register read commands decoded by the command decoder and control logic block 391 and forwarded to the configuration and status registers block 392, with the resulting status payload returned on the data lane interface 301 and captured by the response capture path within the training and calibration engine 294 of the memory controller 200.

Aspects described herein with reference to the write data training mode, which may involve address calibration of the write data link from the memory controller 200 to the memory device 300. In this mode, the memory device 300 may receive write data transmitted by the memory controller 200, compare the received write data against an expected data pattern generated internally within the memory device 300, and make the resulting error indication accessible to the memory controller 200 via configuration-register read commands. In some aspects, the memory controller 200 and the memory device 300 may operate in accordance with a complementary calibration technique in the opposite direction of the physical memory channel 121.

In this complementary calibration, the read data link from the memory device 300 to the memory controller 200, over which the memory device 300 may drive read data to the memory controller 200, may additionally or alternatively, apply calibration of the receiver circuits within the memory controller 200 against the electrical characteristics of the physical memory channel 121 as seen from the memory controller 200 receive side. This complementary calibration direction may be referred to as a Host Receiver Training mode. In the Host Receiver Training mode, the memory device 300 may drive a known training pattern onto the data lane interface 301 in response to read commands issued by the memory controller 200, and the memory controller 200 may check the received pattern against an expected data pattern on the memory controller 200 side, using the receiver circuits and the training and calibration engine 294. In some examples, the memory device 300 may not need to report an error indication via configuration-register read commands as described herein.

For example, in the write data training mode, the physical layer circuit 291 of the memory controller 200 transmits write data bursts and the I/O and physical layer interface block 380 of the memory device 300 receives and checks them. In the Host Receiver Training mode, the I/O and physical layer interface block 380 of the memory device 300 may drive training pattern data onto the data lane interface 301 and the physical layer circuit 291 of the memory controller 200 may receive and check them. The computing system 100 may implement only one or both of these modes. Any pattern-related disclosure made for the write data training mode, including patterns may apply to the Host Receiver Training mode. For example, in both modes, the pattern source may be a 24-bit Fibonacci LFSR implementing the polynomial X²⁴+X²⁰+X¹¹+X⁵+1, shared among the plurality of data lanes of the relevant per-sub-channel domain 397 of the memory device 300, with respective expected data patterns for different data lanes derived from different XOR combinations of taps of the shared LFSR, as described herein. The same default seed value, staging flip-flop initialization, shift register mode, and per-lane pattern inversion control may apply to both modes.

The operational sequence of the Host Receiver Training mode may differ from that of the write data training mode as follows: the Host Receiver Training mode sequence may include a read command issued by the memory controller 200 that causes the memory device 300 to drive the training pattern data onto the data lane interface 301. The term “driving data onto data lanes” may refer to causing electrical signals representing the data (e.g., the training pattern data) to be output on the data lanes. This includes that the memory device 300 outputs training pattern data on the plurality of data lanes and/or the memory device 300 causes signals representative of a data pattern to be provided on the plurality of data lanes.

In some examples, driving the training pattern data is with the timing and strobe sequence of the returned data matching that of a regular read operation, so that successive read commands produce back-to-back training pattern bursts on the data lane interface 301. Because the pattern checking in the Host Receiver Training mode may be performed by the receiver circuits of the physical layer circuit 291 and the training and calibration engine 294 of the memory controller 200, no configuration-register read command to the memory device 300 may be required to retrieve an error indication. The error indication may be determined and held within the training and calibration engine 294 of the memory controller 200 directly. Entry into and exit from the Host Receiver Training mode may be affected by configuration-register commands of a write type issued by the memory controller 200 and decoded by the command decoder and control logic block 391 of the memory device 300, consistently with the configuration-register command mechanism described herein.

In some further aspects described herein, the operational sequence of the host receiver training mode may proceed as follows. The memory controller 200 may issue one or more configuration-register commands of a write type to configure the host receiver training control register within the configuration and status registers block 392, including selecting the training pattern data source between a pseudo-random bit sequence generated by pattern-generation circuitry and a user-defined read pattern, and programming the LFSR seed if the pseudo-random bit sequence is selected. The memory controller 200 may issue a configuration-register command of a write type to enter the host receiver training mode by setting the host receiver training enable bit. The memory controller 200 then issues one or more read commands to the memory device 300, causing the memory device 300 to drive training pattern data onto the data lane interface 301. The memory controller 200 receives the training pattern data (e.g., via the receiver circuits of the physical layer circuit 291) and determines, (e.g., within the training and calibration engine 294), an error indication based on the received training pattern data and an expected data pattern. The memory controller 200 then adjusts a receiver parameter setting (e.g., via the receiver parameter control logic within the training and calibration engine 294). The steps of issuing read commands, receiving training pattern data, determining the error indication, and adjusting the receiver parameter setting may be repeated for successive receiver parameter settings. Upon completion, the memory controller 200 may issue a configuration-register command of a write type to exit the host receiver training mode by clearing the host receiver training enable bit. During the host receiver training mode, the memory device 300 can continue to process commands received on the command and address input 303.

In some further aspects described herein, in the host receiver training mode, the memory controller 200 may issue a read command on the command and address conductors of the physical memory channel 121. In response to the read command, the memory device 300 drives training pattern data onto the data lane interface 301, which may be preceded by a read preamble period, referred to as tRPRE, on the data strobe conductor associated with the data lanes. During the read preamble, the data strobe transitions from an idle state to an active toggling state. Following the read preamble, the memory device 300 drives the burst of training pattern data onto the data lanes, with each unit interval of training pattern data aligned to the data strobe with a timing relationship referred to as tDQS2DQ between data strobe transitions and data valid windows at each unit interval boundary. After the final unit interval of the burst, the memory device 300 drives a read postamble period, referred to as tRPST, on the data strobe conductor. The timing and strobe sequence of the training pattern data returned by the memory device 300 during the host receiver training mode correspond to those of a regular read operation of the memory device 300. The receiver circuits of the physical layer circuit 291 of the memory controller 200 capture the training pattern data using the same strobe-based sampling mechanism as for regular read data, acquiring strobe lock during the read preamble and sampling at each unit interval boundary. Successive read commands issued by the memory controller 200 during the host receiver training mode can produce successive back-to-back bursts of training pattern data on the data lanes, correspondingly enabling accumulation of multiple bursts at each receiver parameter setting. Between successive read commands, the memory controller 200 may issue deselect commands.

In some further aspects described herein, entry into the host receiver training mode may be affected by the memory controller 200 issuing a configuration-register command of a write type. The issuance may target the host receiver training control register within the configuration and status registers block 392. The command decoder and control logic block 391 may decode the command and set the host receiver training enable bit. Exit from the host receiver training mode may be instructed by the memory controller 200 issuing a corresponding command that clears the host receiver training enable bit. When the memory device 300 is in the host receiver training mode, the command decoder and control logic block 391 can continue to process commands received on the command and address input 303, including read commands that cause the memory device 300 to drive training pattern data, configuration-register commands for parameter updates, and other commands. The host receiver training enable bit and the write data training mode enable bit may be in separate configuration registers within the configuration and status registers block 392, permitting the memory controller 200 to enter and exit the host receiver training mode independently of the write data training mode, and vice versa. The error indication in the host receiver training mode may be determined within the memory controller 200 by the training and calibration engine 294.

The mode register architecture governing the Host Receiver Training mode may include the same categories of registers as the write data training mode. This may include at least one, a combination of, or all of: a Host Receiver Training control register providing pattern selection, mode enable, seed reset, and shift register mode functions; three LFSR seed and read pattern registers covering all 24 unit intervals of the burst length; and a pattern inversion control register providing per-lane configurable inversion of the expected data pattern independently for each data lane of the plurality of data lanes, for up to twelve data lanes across two per-sub-channel domains 397. The pattern table, the per-lane XOR-tap assignments, and the default seed value F7310E of the LFSR may be identical to those of the write data training mode, as described herein. In an example, the same LFSR hardware within the memory device 300 may serve both the write data training mode and the Host Receiver Training mode.

In accordance with various aspects described herein, the Host Receiver Training mode may refer to Host Receiver Training (HRT) Mode. In the HRT mode, DRAM may support a Host Receiver Training function similar to Write Training Mode, to maintain robust link performance, especially in systems that employ multiple operating modes to enhance I/O scalability and reduce training time. This DRAM feature may enable the host to perform receiver data training including internal receiver drift compensation and maintain optimal signal integrity throughout system operation.

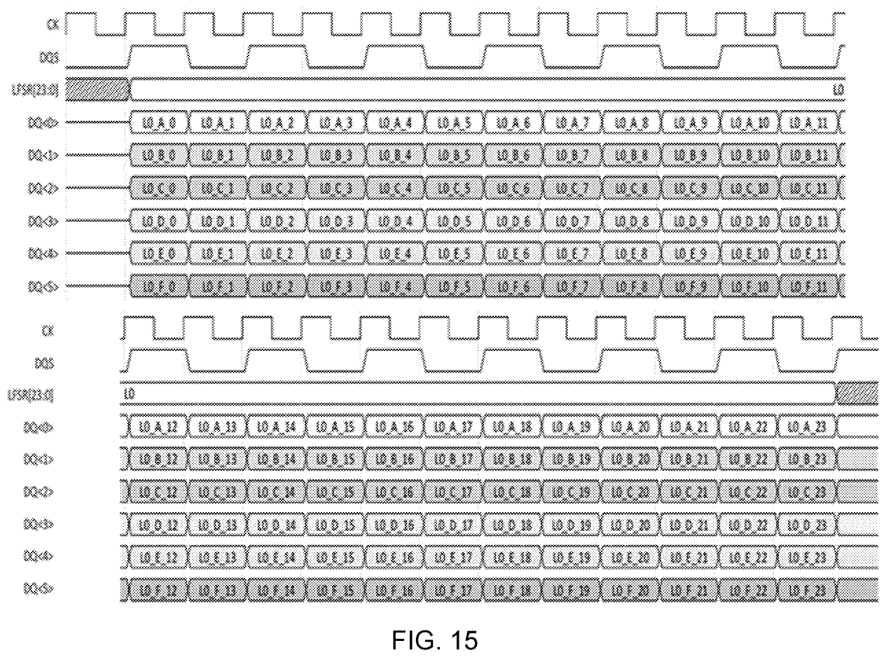

In various aspects, HRTM (HRT Mode) can select the pattern type between user defined pattern (ex: clock pattern) vs PRBS with MR setting (MRxx). The PRBS mode provides an independent (different pattern) per DQ lane using a 24-bit Fibonacci LFSR. One 24-bit F-LFSR generator will support x6 (max) DQ lanes. The polynomial for the Fibonacci LFSR is x\hat{ }24+x\hat{ }20+x\hat{ }11+x\hat{ }5+1. For the Host DQ Receiver drift improvements, the DRAM shall drive user defined pattern and/or LFSR pattern during idle time. FIG. 14 and FIG. 15 show the 24-bit PRBS pattern and Fibonacci LFSR hardware details.

FIG. 15 shows an example of Fibonacci LFSR-24 pattern details for the HTM. It is an exemplary depiction of a timing diagram showing the Fibonacci LFSR 24-bit pattern mapping across a BL24 burst for an x6 device, noting that the diagram is presented in two horizontal halves covering unit intervals 0 through 11 and unit intervals 12 through 23 respectively.

Referring back to FIG. 13, the Fibonacci LFSR circuit described in accordance with the HTM usage.

In accordance with various aspects described herein, a pattern generation circuitry for the HRT may include PRBS Pattern Generator for HRT. PRBS generator will start with the default seed (Example 24b LFSR Seed: F7310E) and the below LFSR pattern table shows the example of shift mode where each DQ lanes gets different pattern on the lane. Table 2 below illustrates the mapping of the pattern to DQ[5:0].

TABLE 2

| | L0 | L1 | L2 | L3 | L4 | L5 | L6 | L7 | L8 | L9 | L10 | L11 | L12 | L13 | L14 |
|---|---|---|---|---|---|---|---|---|---|---|---|---|---|---|---|
| LFSRSeed | 0 | 1 | 1 | 1 | 0 | 0 | 0 | 0 | 1 | 0 | 0 | 0 | 1 | 1 | 0 |
| UI | 0 | 1 | 2 | 3 | 4 | 5 | 6 | 7 | 8 | 9 | 10 | 11 | 12 | 13 | 14 |
| DQ0 | 0 | 0 | 0 | 1 | 0 | 0 | 0 | 1 | 1 | 0 | 0 | 1 | 1 | 1 | 0 |
| DQ1 | 0 | 0 | 0 | 1 | 1 | 0 | 0 | 1 | 0 | 1 | 0 | 1 | 0 | 0 | 1 |
| DQ2 | 1 | 0 | 0 | 1 | 0 | 1 | 0 | 1 | 1 | 1 | 1 | 1 | 1 | 0 | 1 |
| DQ3 | 1 | 1 | 0 | 1 | 0 | 0 | 1 | 1 | 1 | 0 | 1 | 0 | 1 | 1 | 1 |
| DQ4 | 1 | 1 | 1 | 1 | 0 | 0 | 0 | 0 | 1 | 0 | 0 | 0 | 0 | 1 | 0 |
| DQ5 | 0 | 1 | 1 | 0 | 0 | 0 | 0 | 1 | 0 | 0 | 0 | 1 | 0 | 0 | 0 |
| | L15 | L16 | L17 | L18 | L19 | L20 | L21 | L22 | L23 | L24 | L25 | L26 | L27 | L28 | |
| LFSRSeed | 0 | 1 | 1 | 1 | 0 | 1 | 1 | 1 | 1 | 1 | 1 | 1 | 1 | 1 | |
| UI | 15 | 16 | 17 | 18 | 19 | 20 | 21 | 22 | 23 | | | | | | |
| DQ0 | 1 | 1 | 1 | 1 | 1 | 1 | 1 | 1 | 1 | | | | | | |
| DQ1 | 1 | 0 | 0 | 0 | 0 | 0 | 0 | 0 | 0 | | | | | | |
| DQ2 | 0 | 1 | 0 | 0 | 0 | 0 | 0 | 0 | 0 | | | | | | |
| DQ3 | 0 | 0 | 1 | 0 | 0 | 0 | 0 | 0 | 0 | | | | | | |
| DQ4 | 0 | 0 | 0 | 1 | 0 | 0 | 0 | 0 | 0 | | | | | | |
| DQ5 | 1 | 0 | 0 | 0 | 1 | 0 | 0 | 0 | 0 | | | | | | |
| | L0 | L1 | L2 | L3 | L4 | L5 | L6 | L7 | L8 | L9 | L10 | L11 | L12 | L13 | L14 |
| Shift1 | 1 | 0 | 1 | 1 | 1 | 0 | 0 | 0 | 0 | 1 | 0 | 0 | 0 | 1 | 1 |
| UI | 24 | 25 | 26 | 27 | 28 | 29 | 30 | 31 | 32 | 33 | 34 | 35 | 36 | 37 | 38 |
| DQ0 | 0 | 0 | 0 | 0 | 1 | 0 | 0 | 0 | 1 | 1 | 0 | 0 | 1 | 1 | 1 |
| DQ1 | 1 | 0 | 0 | 0 | 1 | 1 | 0 | 0 | 1 | 0 | 1 | 0 | 1 | 0 | 0 |
| DQ2 | 1 | 1 | 0 | 0 | 1 | 0 | 1 | 0 | 1 | 1 | 1 | 1 | 1 | 1 | 0 |
| DQ3 | 1 | 1 | 1 | 0 | 1 | 0 | 0 | 1 | 1 | 1 | 0 | 1 | 0 | 1 | 1 |
| DQ4 | 0 | 1 | 1 | 1 | 1 | 0 | 0 | 0 | 0 | 1 | 0 | 0 | 0 | 0 | 1 |
| DQ5 | 1 | 0 | 1 | 1 | 0 | 0 | 0 | 0 | 1 | 0 | 0 | 0 | 1 | 0 | 0 |
| | L15 | L16 | L17 | L18 | L19 | L20 | L21 | L22 | L23 | L24 | L25 | L26 | L27 | L28 | |
| Shift1 | 0 | 0 | 1 | 1 | 1 | 0 | 1 | 1 | 1 | 1 | 1 | 1 | 1 | 1 | |
| UI | 39 | 40 | 41 | 42 | 43 | 44 | 45 | 46 | 47 | | | | | | |
| DQ0 | 0 | 1 | 1 | 1 | 1 | 1 | 1 | 1 | 1 | | | | | | |
| DQ1 | 1 | 1 | 0 | 0 | 0 | 0 | 0 | 0 | 0 | | | | | | |
| DQ2 | 1 | 0 | 1 | 0 | 0 | 0 | 0 | 0 | 0 | | | | | | |
| DQ3 | 1 | 0 | 0 | 1 | 0 | 0 | 0 | 0 | 0 | | | | | | |
| DQ4 | 0 | 0 | 0 | 0 | 1 | 0 | 0 | 0 | 0 | | | | | | |
| DQ5 | 0 | 1 | 0 | 0 | 0 | 1 | 0 | 0 | 0 | | | | | | |
| | L0 | L1 | L2 | L3 | L4 | L5 | L6 | L7 | L8 | L9 | L10 | L11 | L12 | L13 | L14 |
| Shift2 | 1 | 1 | 0 | 1 | 1 | 1 | 0 | 0 | 0 | 0 | 1 | 0 | 0 | 0 | 1 |
| UI | 48 | 49 | 50 | 51 | 52 | 53 | 54 | 55 | 56 | 57 | 58 | 59 | 60 | 61 | 62 |
| DQ0 | 1 | 0 | 0 | 0 | 0 | 1 | 0 | 0 | 0 | 1 | 1 | 0 | 0 | 1 | 1 |
| DQ1 | 0 | 1 | 0 | 0 | 0 | 1 | 1 | 0 | 0 | 1 | 0 | 1 | 0 | 1 | 0 |
| DQ2 | 0 | 1 | 1 | 0 | 0 | 1 | 0 | 1 | 0 | 1 | 1 | 1 | 1 | 1 | 1 |
| DQ3 | 1 | 1 | 1 | 1 | 0 | 1 | 0 | 0 | 1 | 1 | 1 | 0 | 1 | 0 | 1 |
| DQ4 | 0 | 0 | 1 | 1 | 1 | 1 | 0 | 0 | 0 | 0 | 1 | 0 | 0 | 0 | 0 |
| DQ5 | 0 | 1 | 0 | 1 | 5 | 0 | 0 | 0 | 0 | 1 | 0 | 0 | 0 | 1 | 0 |
| | L15 | L16 | L17 | L18 | L19 | L20 | L21 | L22 | L23 | L24 | L25 | L26 | L27 | L28 | |
| Shift2 | 1 | 0 | 0 | 1 | 1 | 1 | 0 | 1 | 1 | 1 | 1 | 1 | 1 | 1 | |
| UI | 63 | 64 | 65 | 66 | 67 | 68 | 69 | 70 | 71 | | | | | | |
| DQ0 | 1 | 0 | 1 | 1 | 1 | 1 | 1 | 1 | 1 | | | | | | |
| DQ1 | 0 | 1 | 1 | 0 | 0 | 0 | 0 | 0 | 0 | | | | | | |
| DQ2 | 0 | 1 | 0 | 1 | 0 | 0 | 0 | 0 | 0 | | | | | | |
| DQ3 | 1 | 1 | 0 | 0 | 1 | 0 | 0 | 0 | 0 | | | | | | |
| DQ4 | 1 | 0 | 0 | 0 | 0 | 1 | 0 | 0 | 0 | | | | | | |
| DQ5 | 0 | 0 | 1 | 0 | 0 | 0 | 1 | 0 | 0 | | | | | | |
| | L0 | L1 | L2 | L3 | L4 | L5 | L6 | L7 | L8 | L9 | L10 | L11 | L12 | L13 | L14 |
| Shift3 | 0 | 1 | 1 | 0 | 1 | 1 | 1 | 0 | 0 | 0 | 0 | 1 | 0 | 0 | 0 |
| UI | 72 | 73 | 74 | 75 | 76 | 77 | 78 | 79 | 80 | 81 | 82 | 83 | 84 | 85 | 86 |
| DQ0 | 1 | 1 | 0 | 0 | 0 | 0 | 1 | 0 | 0 | 0 | 1 | 1 | 0 | 0 | 1 |
| DQ1 | 0 | 0 | 1 | 0 | 0 | 0 | 1 | 1 | 0 | 0 | 1 | 0 | 1 | 0 | 1 |
| DQ2 | 1 | 0 | 1 | 1 | 0 | 0 | 1 | 0 | 1 | 0 | 1 | 1 | 1 | 1 | 1 |
| DQ3 | 0 | 1 | 1 | 1 | 1 | 0 | 1 | 0 | 0 | 1 | 1 | 1 | 0 | 1 | 0 |
| DQ4 | 0 | 0 | 0 | 1 | 1 | 1 | 1 | 0 | 0 | 0 | 0 | 1 | 0 | 0 | 0 |
| DQ5 | 1 | 0 | 1 | 0 | 1 | 1 | 0 | 0 | 0 | 0 | 1 | 0 | 0 | 0 | 1 |
| | L15 | L16 | L17 | L18 | L19 | L20 | L21 | L22 | L23 | L24 | L25 | L26 | L27 | L28 | |
| Shift3 | 1 | 1 | 0 | 0 | 1 | 1 | 1 | 0 | 1 | 1 | 1 | 1 | 1 | 1 | |
| UI | 87 | 88 | 89 | 90 | 91 | 92 | 93 | 94 | 95 | | | | | | |
| DQ0 | 1 | 1 | 0 | 1 | 1 | 1 | 1 | 1 | 1 | | | | | | |
| DQ1 | 0 | 0 | 1 | 1 | 0 | 0 | 0 | 0 | 0 | | | | | | |
| DQ2 | 1 | 0 | 1 | 0 | 1 | 0 | 0 | 0 | 0 | | | | | | |
| DQ3 | 1 | 1 | 1 | 0 | 0 | 1 | 0 | 0 | 0 | | | | | | |
| DQ4 | 0 | 1 | 0 | 0 | 0 | 0 | 1 | 0 | 0 | | | | | | |
| DQ5 | 0 | 0 | 0 | 1 | 0 | 0 | 0 | 1 | 0 | | | | | | |
| | L0 | L1 | L2 | L3 | L4 | L5 | L6 | L7 | L8 | L9 | L10 | L11 | L12 | L13 | L14 |
| Shift4 | 1 | 0 | 1 | 1 | 0 | 1 | 1 | 1 | 0 | 0 | 0 | 0 | 1 | 0 | 0 |
| UI | 96 | 97 | 98 | 99 | 100 | 101 | 102 | 103 | 104 | 105 | 106 | 107 | 108 | 109 | 110 |
| DQ0 | 1 | 1 | 1 | 0 | 0 | 0 | 0 | 1 | 0 | 0 | 0 | 1 | 1 | 0 | 0 |
| DQ1 | 1 | 0 | 0 | 1 | 0 | 0 | 0 | 1 | 1 | 0 | 0 | 1 | 0 | 1 | 0 |
| DQ2 | 0 | 1 | 0 | 1 | 1 | 0 | 0 | 1 | 0 | 1 | 0 | 1 | 1 | 1 | 1 |
| DQ3 | 0 | 0 | 1 | 1 | 1 | 1 | 0 | 1 | 0 | 0 | 1 | 1 | 1 | 0 | 1 |
| DQ4 | 1 | 0 | 0 | 0 | 1 | 1 | 1 | 1 | 0 | 0 | 0 | 0 | 1 | 0 | 0 |
| DQ5 | 0 | 1 | 0 | 1 | 0 | 1 | 1 | 0 | 0 | 0 | 0 | 1 | 0 | 0 | 0 |
| | L15 | L16 | L17 | L18 | L19 | L20 | L21 | L22 | L23 | L24 | L25 | L26 | L27 | L28 | |
| Shift4 | 0 | 1 | 1 | 0 | 0 | 1 | 1 | 1 | 0 | 1 | 1 | 1 | 1 | 1 | |
| UI | 111 | 112 | 113 | 114 | 115 | 116 | 117 | 118 | 119 | | | | | | |
| DQ0 | 1 | 1 | 1 | 0 | 1 | 1 | 1 | 1 | 1 | | | | | | |
| DQ1 | 1 | 0 | 0 | 1 | 1 | 0 | 0 | 0 | 0 | | | | | | |
| DQ2 | 1 | 1 | 0 | 1 | 0 | 1 | 0 | 0 | 0 | | | | | | |
| DQ3 | 0 | 1 | 1 | 1 | 0 | 0 | 1 | 0 | 0 | | | | | | |
| DQ4 | 0 | 0 | 1 | 0 | 0 | 0 | 0 | 1 | 0 | | | | | | |
| DQ5 | 1 | 0 | 0 | 0 | 1 | 0 | 0 | 0 | 1 | | | | | | |

Memory devices (e.g., DDR6 DRAM devices) implement a Host Receiver Training (HRT) function that drives training patterns onto the DQ signal pins. The HRT output pattern shall be sourced either from a user-defined read pattern or from an internally generated LFSR (LFSR) sequence.

An independent 24-bit Fibonacci LFSR generator provides patterns for up to 6 DQ lanes. The source of the DQ output pattern shall be selected via MRxx:OP[0], where this field selects between LFSR output and the user-defined read pattern resource. When MRxx:OP[5]=1, the LFSR shift-register mode shall be enabled. The HRT function shall be enabled or disabled through a Mode Register Write (MRW) to MRxx:OP[1]. The MRxx[3] field shall be used to reset the LFSR seed value and associated staging flip-flops. Upon reset, the 5-bit staging flip-flops shall be initialized to their default value of 11111.

To enter Host Receiver Training Mode (HRT), the host memory controller shall issue a Mode Register Write (MRW) command targeting MRxx OP [1]=1B, with the HRT Mode entry opcode. When the DRAM is in Receiver Training mode, commands are still actively processed. To exit HRT Mode, the host memory controller shall issue an MRW command to MRxx OP [1]=OB, with the HRT Mode Exit opcode.

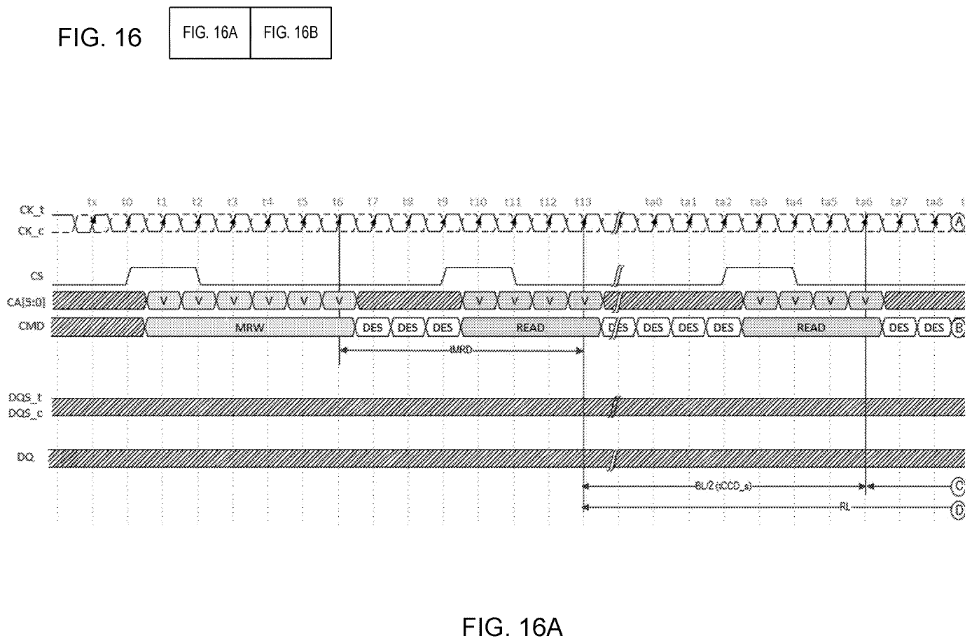

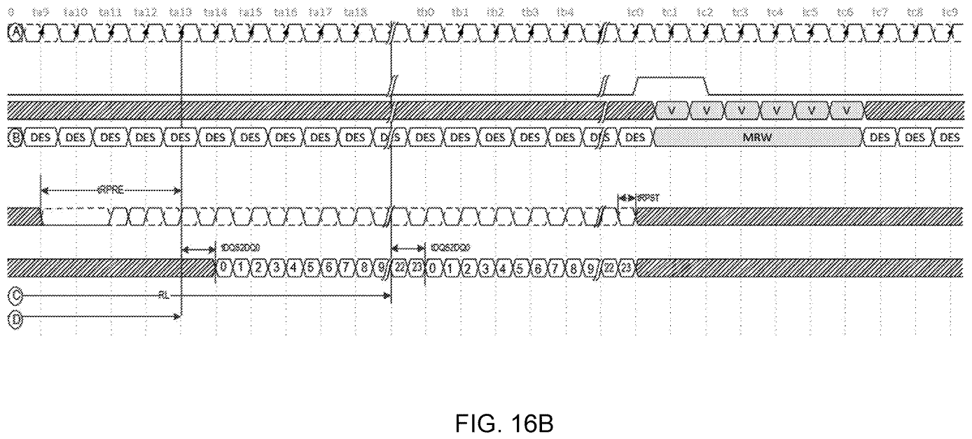

Host to configure mode register with read pattern or LFSR details and this training is entered by issuing an MRW command. Host to issue a READ command, which causes the DDR6 DRAM to drive the MR content depending on the mode register settings (LFSR vs Read pattern). The timing of data return and strobe sequence match a regular Read operation which supports back-to-back read the user read pattern/LFSR data. HRT mode is exited by issuing an MRW command. FIG. 16 shows an example of HRT timing.

HRT registers may be configured as follows:

### MRxx OP[7:0]—Host Receiver Training Control Register

| OP[7] | OP[6] | OP[5] | OP[4] | OP[3] | OP[2] | OP[1] | OP[0] |
|---|---|---|---|---|---|---|---|
| RFU | RFU | Shift | RFU | LFSR | RFU | HRT | LFSR/ |
| | | Reg | | Reset | | Enable | Read |
| | | Mode | | | | | Training |
| | | | | | | | Pattern |
| | | | | | | | Selection |

| | Register | Oper- | | |
|---|---|---|---|---|
| Function | Type | and | Data | Notes |
| Read | R/W | OP[0] | 1b0: User defined | |
| Training | | | read pattern | |
| Pattern | | | 1b1: LFSR | |
| Selection | | | | |
| HRT | R/W | OP[1] | 1b0: Disable | |
| Enable | | | 1b1: Enable | |
| RFU | R/W | OP[2] | RFU | |
| Seed | R/W | OP[3] | 1b0: Disable | |
| Reset | R/W | OP[4] | 1b1: Reset to | |
| RFU | | | default both | |
| | | | LFSR and | |
| | | | 5b-Staging Flip | |
| | | | flops (auto clears | |
| | | | after resetting) | |
| | | | RFU | |
| Shift Reg | R/W | OP[5] | 0-Disable | |
| Mode | | | 1-Enable | |
| RFU | R/W | OP[6] | RFU | |
| RFU | R/W | OP[7] | RFU | |

If MRxx[0] is set to 1b0, MRxy0 to MRxy2 contains the user-defined pattern (Read Pattern). If MRxx[0] is set to 1b1 and MRxx[2] is set to 1b0, then the training shall use LFSR generator and The MRyz0-MRyz3 registers allow users to select LFSR Seed register UI23-0 and MRzz0 is used to assign Pattern Inversion per DQ lane.

Note: For 2p3/2p6/1p6 configurations need one 3 mode registers and to support 1p12 configuration. It needs additional 3 more mode registers to support DQ<11:6> (since it needs 2 LFSR per PSD).

### MRxy0—LFSR Seed/Read Pattern Register 0

| | | | | | | | |
|---|---|---|---|---|---|---|---|
| OP[7] | OP[6] | OP[5] | OP[4] | OP[3] | OP[2] | OP[1] | OP[0] |

LFSR Seed/Read Pattern UI[7:0]

| | Register | Oper- | | |
|---|---|---|---|---|
| Function | Type | and | Data | Notes |
| LFSR Seed/Read | R/W | OP[0] | | |
| Pattern UIO | | | | |
| LFSR Seed/Read | R/W | OP[1] | | |
| Pattern UI1 | | | | |
| LFSR Seed/Read | R/W | OP[2] | | |
| Pattern UI2 | | | | |
| LFSR Seed/Read | R/W | OP[3] | | |
| Pattern UI3 | | | | |
| LFSR Seed/Read | R/W | OP[4] | | |
| Pattern UI4 | | | | |
| LFSR Seed/Read | RFU | OP[5] | | |
| Pattern UI5 | | | | |
| LFSR Seed/Read | R/W | OP[6] | | |
| Pattern UI6 | | | | |
| LFSR Seed/Read | R/W | OP[7] | | |
| Pattern UI7 | | | | |

### MRxy1—LFSR Seed/Read Pattern Register 1

| | | | | |
|---|---|---|---|---|
| Function | Register Type | Operand | Data | Notes |

| | | |
|---|---|---|
| LFSR Seed/Read | R/W | OP[0] |
| Pattern UI8 | | |
| LFSR Seed/Read | R/W | OP[1] |
| Pattern UI9 | | |
| LFSR Seed/Read | R/W | OP[2] |
| Pattern UI10 | | |
| LFSR Seed/Read | R/W | OP[3] |
| Pattern UI11 | | |
| LFSR Seed/Read | R/W | OP[4] |
| Pattern UI12 | | |
| LFSR Seed/Read | RFU | OP[5] |
| Pattern UI13 | | |
| LFSR Seed/Read | R/W | OP[6] |
| Pattern UI14 | | |
| LFSR Seed/Read | R/W | OP[7] |
| Pattern UI15 | | |

### MRxy2—LFSR Seed/Read Pattern Register 2

| | | | | |
|---|---|---|---|---|
| Function | Register Type | Operand | Data | Notes |

| | | |
|---|---|---|
| LFSR Seed/Read | R/W | OP[0] |
| Pattern UI16 | | |
| LFSR Seed/Read | R/W | OP[1] |
| Pattern UI17 | | |
| LFSR Seed/Read | R/W | OP[2] |
| Pattern UI18 | | |
| LFSR Seed/Read | R/W | OP[3] |
| Pattern UI19 | | |
| LFSR Seed/Read | R/W | OP[4] |
| Pattern UI20 | | |
| LFSR Seed/Read | RFU | OP[5] |
| Pattern UI21 | | |
| LFSR Seed/Read | R/W | OP[6] |
| Pattern UI22 | | |
| LFSR Seed/Read | R/W | OP[7] |
| Pattern UI23 | | |

### MRzz—Pattern Inversion Control Register 0

| OP[7] | OP[6] | OP[5] | OP[4] | OP[3] | OP[2] | OP[1] | OP[0] |
|---|---|---|---|---|---|---|---|
| RFU | RFU | Pattern | Pattern | Pattern | Pattern | Pattern | Pattern |
| | | Inver- | Inver- | Inver- | Inver- | Inver- | Inver- |
| | | sion | sion | sion | sion | sion | sion |
| | | DQ5 | DQ4 | DQ3 | DQ2 | DQ1 | DQ0 |

| | Register | Oper- | | |
|---|---|---|---|---|
| Function | Type | and | Data | Notes |
| Pattern | R/W | OP[0] | 1b0: Normal | |
| Inversion DQ0 | | | 1b1: Invert | |
| Pattern | R/W | OP[1] | 1b0: Normal | |
| Inversion DQ1 | | | 1b1: Invert | |
| Pattern | R/W | OP[2] | 1b0: Normal | |
| Inversion DQ2 | | | 1b1: Invert | |
| Pattern | R/W | OP[3] | 1b0: Normal | |
| Inversion DQ3 | | | 1b1: Invert | |
| Pattern | R/W | OP[4] | 1b0: Normal | |
| Inversion DQ4 | | | 1b1: Invert | |
| Pattern | R/W | OP[5] | 1b0: Normal | |
| Inversion DQ5 | | | 1b1: Invert | |
| RFU | RFU | OP[6] | RFU | |
| RFU | RFU | OP[7] | RFU | |

### MRzz—Pattern Inversion Control Register 1

| OP[7] | OP[6] | OP[5] | OP[4] | OP[3] | OP[2] | OP[1] | OP[0] |
|---|---|---|---|---|---|---|---|
| RFU | RFU | Pattern | Pattern | Pattern | Pattern | Pattern | Pattern |
| | | Inver- | Inver- | Inver- | Inver- | Inver- | Inver- |
| | | sion | sion | sion | sion | sion | sion |
| | | DQ11 | DQ10 | DQ9 | DQ8 | DQ7 | DQ6 |

| | Register | Oper- | | |
|---|---|---|---|---|
| Function | Type | and | Data | Notes |
| Pattern | R/W | OP[0] | 1b0: Normal | |
| Inversion DQ6 | | | 1b1: Invert | |
| Pattern | R/W | OP[1] | 1b0: Normal | |
| Inversion DQ7 | | | 1b1: Invert | |
| Pattern | R/W | OP[2] | 1b0: Normal | |
| Inversion DQ8 | | | 1b1: Invert | |
| Pattern | R/W | OP[3] | 1b0: Normal | |
| Inversion DQ9 | | | 1b1: Invert | |
| Pattern | R/W | OP[4] | 1b0: Normal | |
| Inversion DQ10 | | | 1b1: Invert | |
| Pattern | R/W | OP[5] | 1b0: Normal | |
| Inversion DQ11 | | | 1b1: Invert | |
| RFU | RFU | OP[6] | RFU | |
| RFU | RFU | OP[7] | RFU | |

HRT Timing may be as follows: Host to configure mode register with read pattern or LFSR details and this training is entered by issuing an MRW. Host to issue a READ command, which causes the DDR6 DRAM to drive the MR content depending on the mode register settings (LFSR vs Read pattern). The timing of data return and strobe sequence match a regular Read operation which supports back-to-back read the user read pattern/LFSR data.

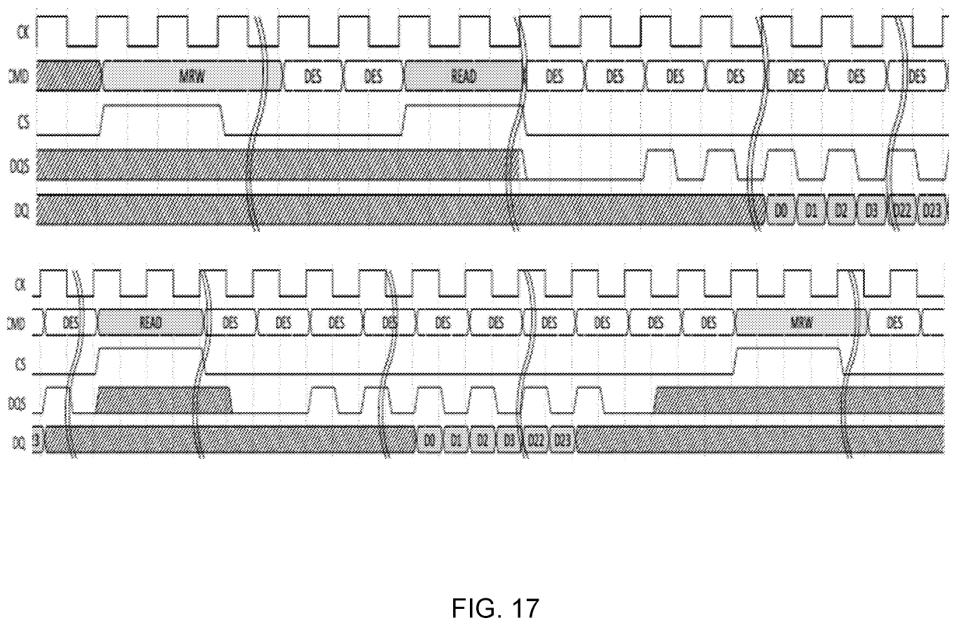

FIG. 17 shows an example of HRT timing, noting that the diagram is presented in two horizontal halves.

Circuitry of the memory device 300 (e.g. the I/O and physical layer interface block 380 of the memory device 300) may provide the structural basis for the pattern driving function of the Host Receiver Training mode. During the Host Receiver Training mode, the driver circuits within the I/O and physical layer interface block 380 may drive the training pattern data produced by the pattern-generation circuitry associated with the pattern-check and data comparison block 399 onto the data lane interface 301 in response to read commands decoded by the command decoder and control logic block 391. The training pattern data may be serialized through the internal data processing block 360 and driven onto the data lane interface 301 with the timing and strobe characteristics of a regular read operation, so that the physical layer circuit 291 of the memory controller 200 may capture the pattern using its standard receiver circuits. The per-lane pattern inversion control and the XOR-tap assignment structure of the shared LFSR within the per-sub-channel domain 397 of the memory device 300 apply in the same manner as in the write data training mode, providing an independent expected data pattern per data lane of the plurality of data lanes of the data lane interface 301 from a single LFSR instance per per-sub-channel domain 397.

Circuitry of the memory controller 200 (e.g., the training and calibration engine 294 of the memory controller 200) may implement the receiver-side checking function of the Host Receiver Training mode. The training and calibration engine 294 may generate the expected data pattern, e.g., using the same LFSR polynomial, seed, and per-lane tap combination as the memory device 300, and may compare the pattern received via the physical layer circuit 291 against the locally generated expected data pattern, producing an error indication within the training and calibration engine 294 without requiring a configuration-register read command to the memory device 300. The transmit parameter control logic within the training and calibration engine 294 may in this context be directed to adjusting receiver-side parameters of the physical layer circuit 291, such as reference voltage, equalization coefficients, and sampling phase offset, across a plurality of successive bursts of read data driven by the memory device 300, consistently with the iterative transmit parameter setting sweep as described herein, applied here to the receive side of the memory controller 200. The entry into and exit from the Host Receiver Training mode may be orchestrated by the command and address generator 292 of the memory controller 200 issuing configuration-register commands of a write type to the memory device 300, decoded by the command decoder and control logic block 391 and processed by the configuration and status registers block 392, consistently with the configuration-register command mechanism described herein.

The Host Receiver Training mode may be invoked during the initialization phase of the computing system 100, as described herein, and may additionally be invoked periodically during the mission mode 161 of the memory device 300 to compensate for drift in the electrical characteristics of the read data link that may occur during sustained operation, for example, due to thermal variation or end-of-life degradation of the physical memory channel 121, which may involve the periodic mission mode invocation as described herein for the write data training mode. The Host Receiver Training mode may operate irrespective of whether the coupling between the memory controller 200 and the memory device 300 via the plurality of data lanes of the physical memory channel 121 is direct or traverses a registering clock driver, a data buffer, or both, as described herein.

In accordance with various aspects described herein, the data lane interface 301 of the I/O and physical layer interface block 380 includes a plurality of data lanes over which write data is received by the memory device 300 from the memory controller 200. Each data lane of the data lane interface 301 carries write data as a serial bit stream at the operating data rate of the physical memory channel 121, with unit interval boundaries defined by the write clock or strobe input 302. In one example, each data lane may be a DQ lane, associated with a DQ pin of a DRAM device (e.g., a DDR6 DRAM device) implementing the memory device 300. The plurality of data lanes may be organized into one or more per-sub-channel domains 397, so that a subset of the total plurality of data lanes is served by a respective instance of the I/O and physical layer interface block 380 and the internal data processing block 360. The error indication determined by the pattern-check and data comparison block 399 may be determined for a data lane of the plurality of data lanes. This might not require that the determination be performed for every data lane of the plurality simultaneously. The binding described in this paragraph applies to any one data lane of the data lane interface 301 for which an error indication is determined, consistently with the per-data-lane granularity as described herein.

The pattern-check and data comparison block 399 of the memory device 300 may implement the circuitry configured to determine, based on write data received on a data lane and an expected data pattern, an error indication. The pattern-check and data comparison block 399 may be digital logic circuitry including combinational comparison logic that operates on write data received at the data lane interface 301 after deserialization within the internal data processing block 360. The logic circuitry may compare that write data against an expected data pattern known within the memory device 300. The expected data pattern against which the pattern-check and data comparison block 399 compares received write data may be common across the plurality of data lanes, for example, when a clock pattern is selected as the expected data pattern, or may differ between data lanes of the plurality of data lanes, for example, when respective expected data patterns are derived from different combinations of outputs of a shared pattern-generation circuit within the pattern-check and data comparison block 399. Both the lane-common and lane-specific cases fall within the scope of the aspects described herein and are consistent with the expected data pattern described herein. The pattern-check and data comparison block 399 can be activated under the control of the configuration and status registers block 392 in response to an operating mode selection established by the memory controller 200 via a configuration-register command as described herein.

The status register portion of the configuration and status registers block 392 of the memory device 300 may provide a mechanism by which an error indication determined by the pattern-check and data comparison block 399 is accessible to the memory controller 200. The error indication produced by the pattern-check and data comparison block 399 may be written into the status register portion of the configuration and status registers block 392 and may be retrieved by the memory controller 200 by any mechanism by which the contents of the configuration and status registers block 392 are made available externally.

The accessibility of the error indication to the memory controller 200 may involve any mechanism to facilitate the accessibility. In an example, the error indication may be stored in one or more status registers within the status register portion of the configuration and status registers block 392, and the memory controller 200 may access the error indication by issuing a configuration-register read command, which may be decoded by the command decoder and control logic block 391, that can cause the configuration and status registers block 392 to return the contents of the addressed status register to the memory controller 200 as a data payload on the data lane interface 301. In a further example, the memory controller 200 may cause the error indication to be cleared by issuing a command to the memory device 300, which may be decoded by the command decoder and control logic block 391 and processed by the configuration and status registers block 392, that resets the contents of the addressed status register.

In an example, entry into and exit from the write data training mode may be affected by one or more configuration-register commands received at the command and address input 303 of the I/O and physical layer interface block 380 of the memory device 300, decoded by the command decoder and control logic block 391, and processed by the configuration and status registers block 392. A configuration-register command of a write type, for example a mode register write command, directed to a specified address within the configuration register file portion of the configuration and status registers block 392 may cause the memory device 300 to enter the write data training mode by setting an operating mode flag within the configuration register file portion, which the command decoder and control logic block 391 interprets as an instruction to activate the pattern-check and data comparison block 399. A subsequent configuration-register command of a write type directed to the same or a related address may cause the memory device 300 to exit the write data training mode by clearing the operating mode flag. Additional configuration-register commands of a write type may be issued by the memory controller 200 during the write data training mode to update pattern-generation parameters, as described with reference to FIG. 4 through FIG. 11. On the memory controller side, the command and address generator 292 of the memory controller 200 may generate the configuration-register commands used to enter, configure, and exit the write data training mode, under the direction of the training and calibration engine 294.

The multi-phase deserializer within the internal data processing block 360 of the memory device 300 may provide the structural basis for the plurality of phase-specific error indications as described herein. The deserializer within the internal data processing block 360 may operate in a multi-phase fashion, producing a plurality of parallel outputs per data lane, each output corresponding to a respective subset of unit intervals within a burst of write data that are spaced apart by the number of parallel sampling phases. For example, a quarter-rate deserializer within the internal data processing block 360 may produce four parallel outputs per data lane, designated Ph0, Ph1, Ph2, and Ph3, corresponding respectively to unit intervals at positions congruent to 0, 1, 2, and 3 modulo 4 within the burst. The pattern-check and data comparison block 399 may compare received write data against the expected data pattern independently for each of these parallel phase outputs, producing a respective phase-specific error indication for each phase output. The phase-specific error indications may be written into the status register portion of the configuration and status registers block 392 and are accessible to the memory controller 200 via configuration-register read commands. The specific unit interval subsets associated with each phase-specific error indication in embodiments employing a burst length of 24 unit intervals are described herein.

Pattern-generation circuitry within or associated with the pattern-check and data comparison block 399 of the memory device 300, described with reference to FIG. 3, may implement the pattern-generation circuitry that generates, within the memory device 300, the expected data pattern as a pseudo-random bit sequence. In aspects described herein, the pattern-generation circuitry may include a LFSR arranged within the memory device 300 on a per-sub-channel domain 397 basis, such that one LFSR is instantiated per per-sub-channel domain 397 and serves all data lanes within that per-sub-channel domain 397. The LFSR may be a Fibonacci LFSR, and may implement the polynomial X²⁴+X²⁰+X¹¹+X⁵+1 or another suitable polynomial.

The pattern-generation circuitry may provide respective expected data patterns to different data lanes of the plurality of data lanes based on different respective combinations, by XOR operations, of taps of the shared LFSR. The expected data patterns so derived are provided to the comparison logic within the pattern-check and data comparison block 399 for each data lane independently, enabling the pattern-check and data comparison block 399 to determine a respective error indication for each data lane without requiring a separate LFSR per data lane. The per-sub-channel domain organization of the memory device 300 and the sharing of a single LFSR across multiple data lanes within each per-sub-channel domain 397 are further described.

A burst of write data can be received at the data lane interface 301 of the I/O and physical layer interface block 380 of the memory device 300. The receiver circuits within the I/O and physical layer interface block 380 capture the incoming write data signals on each data lane at each unit interval boundary defined by the write clock or strobe input 302. The captured bits may be passed from the receiver circuits to the internal data processing block 360, where the deserializer assembles the serial bit stream received on each data lane across the plurality of unit intervals of the burst into a parallel data word. The parallel data word produced by the deserializer within the internal data processing block 360 is then available to the pattern-check and data comparison block 399 for comparison against the expected data pattern. The burst of write data therefore traverses the I/O and physical layer interface block 380 as a high-speed serial signal and is converted into a parallel representation within the internal data processing block 360 before the comparison performed by the pattern-check and data comparison block 399 takes place. On the memory controller side, write data constituting the burst of write data may be driven onto the physical memory channel 121 by the transmitter circuits of the physical layer circuit 291 of the memory controller 200, under the control of the training and calibration engine 294.

The training and calibration engine 294 of the memory controller 200, together with the command and address generator 292 and the physical layer circuit 291, may implement the circuitry configured to cause the memory device 300 to enter a write data training mode, to transmit write data to the memory device 300 via the plurality of data lanes during the write data training mode, and to access from the memory device 300 an error indication determined by the memory device 300 based on the transmitted write data and an expected data pattern. The finite-state machine within the training and calibration engine 294 can cause the memory device 300 to enter the write data training mode by directing the command and address generator 292 to issue one or more configuration-register commands to the memory device 300. Write data is transmitted to the memory device 300 via the plurality of data lanes of the physical memory channel 121 by the transmitter circuits of the physical layer circuit 291 during the write data training mode. The training and calibration engine 294 accesses the error indication from the memory device 300 by directing the command and address generator 292 to issue a configuration-register read command to the memory device 300 and by capturing the error indication returned by the memory device 300 via the response capture path within the training and calibration engine 294. The transmit parameter control logic within the training and calibration engine 294 sets respective transmit parameter settings of the physical layer circuit 291 for successive bursts of write data, and the training and calibration engine 294 accesses respective error indications from the memory device 300 for each successive burst.

The initialization phase and the mission mode of the computing system 100 may correspond respectively to the initialization phase and the mission mode. During the initialization phase, the memory controller 200 may configure the memory device 300 and perform link calibration sequences, which may include invocation of the write data training mode, before the computing system 100 transitions to the mission mode for normal memory access operations. During the mission mode, the memory controller 200 may additionally invoke the write data training mode periodically, for example to compensate for drift in the electrical characteristics of the physical memory channel 121 that may occur during sustained operation due to thermal variation, supply voltage variation, or end-of-life degradation of the physical channel. This periodic re-invocation during the mission mode might not require the computing system 100 to return to the initialization phase and may be performed by the training and calibration engine 294 of the memory controller 200 concurrently with or between normal memory access operations. The write data training mode therefore can support both the initialization phase and the mission mode as alternative or complementary contexts of invocation.

The coupling between the memory controller 200 and the memory device 300 via the plurality of data lanes of the physical memory channel 121 may be a direct coupling or an indirect coupling traversing one or more intermediate components. The physical memory channel 121 between the memory controller 200 and the memory device 300 may include a registering clock driver, which receives and re-drives command and address signals from the memory controller 200 to the memory device 300, and may further include a data buffer, which receives and re-drives data signals between the memory controller 200 and the memory device 300. The logical content of write data transmitted by the physical layer circuit 291 of the memory controller 200 and of configuration-register commands generated by the command and address generator 292 may be preserved by any such intermediate components. Accordingly, the write data training mode described herein operates in the same manner irrespective of whether the coupling between the memory controller 200 and the memory device 300 is direct or traverses a registering clock driver, a data buffer, or both. The presence or absence of such intermediate components in the physical memory channel 121 does not alter the functional relationship between the memory controller 200 and the memory device 300 with respect to write data transmission, error indication determination, and configuration-register access as described herein.

The per-lane pattern inversion control introduced in the new content provides a further implementation of the expected data pattern as described herein, in which the expected data pattern for a given data lane of the plurality of data lanes may be the logical inverse of the pattern produced by the LFSR tap combination assigned to that lane. The pattern inversion function is configurable independently per data lane via a dedicated pattern inversion control register accessible by configuration-register commands of a write type issued by the memory controller 200. In the context of the memory device 300 described with reference to FIG. 3, the per-lane inversion control signals, e.g., designated Lane0Inv through Lane5Inv, are applied within the pattern-check and data comparison block 399 between the XOR-tap output of the shared LFSR and the comparison logic for each respective data lane of the data lane interface 301. This inversion capability supports the respective expected data patterns for different data lanes differing from one another, as described herein, and extends that differentiation beyond the XOR-tap offset mechanism to include configurable polarity control on a per-lane basis. The per-lane inversion control is programmable via the configuration and status registers block 392 of the memory device 300, under the control of the command decoder and control logic block 391.

The error logging architecture disclosed in the new content provides a concrete implementation of the phase-specific error indications, as defined herein, in which two phase-specific error indications are allocated per data lane of the plurality of data lanes: a first phase-specific error indication designated Ph0, associated with the subset of even-numbered unit intervals within the burst—unit intervals 0, 2, 4, 6, 8, 10, 12, 14, 16, 18, 20, and 22—and a second phase-specific error indication designated Ph1, associated with the subset of odd-numbered unit intervals—unit intervals 1, 3, 5, 7, 9, 11, 13, 15, 17, 19, 21, and 23. Each phase-specific error indication occupies one bit of a write training mode error status register within the status register portion of the configuration and status registers block 392 of the memory device 300, as described with reference to FIG. 3, with three data lanes packed per eight-bit register and two bits allocated per data lane for Ph0 and Ph1 respectively. The memory controller 200 retrieves the phase-specific error indications by issuing configuration-register read commands decoded by the command decoder and control logic block 391 and forwarded to the configuration and status registers block 392, with the resulting status payload returned on the data lane interface 301 and captured by the response capture path within the training and calibration engine 294 of the memory controller 200, as described with reference to FIG. 2. This two-phase error partitioning represents one embodiment of the plurality of phase-specific error indications described herein, where the number of phases m is two, corresponding to the even and odd unit interval subsets of the BL24 burst.

In some further aspects described herein, In various aspects described herein, a memory device (e.g., the memory device 300) may include circuitry configured to drive training pattern data onto at least one data lane of a plurality of data lanes in a host receiver training mode of the memory device. The processing circuitry may drive the training pattern data in response to a read command received from the memory controller. The training pattern data may be generated within the memory device by pattern-generation circuitry, or may be sourced from one or more configuration registers storing a user-defined read pattern. The host receiver training mode enables the memory controller to evaluate reception quality at the receiver circuits of the memory controller by comparing the received training pattern data against an expected data pattern within the memory controller. The memory device may drive the training pattern data on a per-burst basis, where each burst of training pattern data spans a plurality of unit intervals corresponding to the burst length of the memory interface. This circuitry configured to drive training pattern data in the host receiver training mode may operate in combination with circuitry configured to determine an error indication based on write data received from the memory controller in a write data training mode as described herein, or may operate independently of such circuitry. In an example, the circuitry configured to drive training pattern data may include circuitry within the I/O and physical layer interface block 380, the internal data processing block 360, and the pattern-generation circuitry within or associated with the pattern-check and data comparison block 399 of the memory device 300, as further described herein.

In an example, the memory device 300 drives training pattern data onto the data lane interface 301 in the host receiver training mode in response to a read command received from the memory controller 200. The read command may be received at the command and address input 303 of the I/O and physical layer interface block 380 and may be decoded by the command decoder and control logic block 391. In response to the decoded read command, the command decoder and control logic block 391 directs the pattern-generation circuitry within or associated with the pattern-check and data comparison block 399 to generate the training pattern data. The training pattern data may be passed from the pattern-generation circuitry to the internal data processing block 360, where the serializer converts a parallel training pattern word into a serial bit stream on each data lane. The serial bit stream may be driven onto the data lane interface 301 by the driver circuits of the I/O and physical layer interface block 380, with a timing and strobe sequence determined by the internal clocking tree within the I/O and physical layer interface block 380. Each of the pattern-generation circuitry, the serializer, and the driver circuits may be instantiated within a per-sub-channel domain 397 of the memory device 300, so that the training pattern data is generated and driven independently per sub-channel. The training pattern data driven during the host receiver training mode can follow the same path from the pattern-generation circuitry through the serializer to the driver circuits as read data follows from the prefetch buffer through the serializer to the driver circuits during a normal read operation, with the distinction that the data source during the host receiver training mode is the pattern-generation circuitry rather than the memory core block 320.

In an example, the memory device 300 enters or exits the host receiver training mode in response to one or more configuration-register commands received from the memory controller 200. Entry into the host receiver training mode may be initiated by a configuration-register command of a write type directed to the host receiver training control register within the configuration register file portion of the configuration and status registers block 392, decoded by the command decoder and control logic block 391, which sets the host receiver training enable bit. The host receiver training control register may be, or may include, a mode register of the memory device 300. Exit from the host receiver training mode may be initiated by a corresponding configuration-register command of a write type that clears the host receiver training enable bit. The host receiver training control register is a register separate from the write training mode control register within the configuration and status registers block 392 of the memory device 300. Accordingly, the memory device 300 may enter or exit the host receiver training mode without entering or exiting the write data training mode, and may enter or exit the write data training mode without entering or exiting the host receiver training mode. On the memory controller side, the command and address generator 292 of the memory controller 200, under the direction of the training and calibration engine 294, generates the configuration-register commands used to enter, configure, and exit the host receiver training mode. The configuration-register commands for the host receiver training mode are transmitted over the command and address conductors of the physical memory channel 121 and are decoded by the memory device 300 independently of data transfers on the data lanes.

In an example, the training pattern data driven onto the data lane interface 301 during the host receiver training mode has a timing and strobe sequence corresponding to a regular read operation of the memory device 300. The serializer within the internal data processing block 360 of the memory device 300 clocks out the training pattern data at the operating data rate of the data lane interface 301, producing one bit per unit interval on each data lane. The data strobe driver within the I/O and physical layer interface block 380 generates the data strobe signal with the same read preamble period, read postamble period, and data-to-strobe timing relationship as for a regular read operation of the memory device 300. The memory controller 200 may capture the training pattern data using the same receiver circuits and strobe-based sampling within the physical layer circuit 291 as for regular read data. Because the timing and strobe sequence match those of a regular read operation, no modification to the physical layer circuit 291 receiver timing is required to sample training pattern data as compared to regular read data. Successive read commands issued by the memory controller 200 during the host receiver training mode produce successive bursts of the training pattern data on the data lane interface 301. The back-to-back burst capability can enable the memory controller 200 to accumulate multiple bursts of training pattern data at each receiver parameter setting, which may support averaging of error indications across multiple bursts. The successive bursts may follow the same inter-burst timing constraints as successive read operations during normal operation of the memory device 300.

In an example, the pattern-generation circuitry within or associated with the pattern-check and data comparison block 399 of the memory device 300 is shared between the write data training mode and the host receiver training mode. The same LFSR hardware may generate the expected data pattern against which received write data is compared during the write data training mode, and may generate the training pattern data that is driven onto the data lane interface 301 during the host receiver training mode. The shared LFSR may implement the polynomial X²⁴+X²⁰+X¹¹+X⁵+1 as described herein for the write data training mode pattern-generation circuitry. The per-lane XOR-tap assignments that derive respective expected data patterns for different data lanes, the default seed value, the staging flip-flop initialization, the shift register loading mode, and the per-lane pattern inversion control as described herein for the write data training mode are each applicable to the host receiver training mode when the shared pattern-generation circuitry is used. The configuration of the shared pattern-generation circuitry for the host receiver training mode may be affected via a separate set of configuration registers from those governing the write data training mode pattern-generation circuitry, so that the memory controller 200 may configure pattern parameters for the two modes independently.

In an example, the memory device 300 selects, in response to a configuration-register command of a write type received from the memory controller 200, between a pseudo-random bit sequence generated by the pattern-generation circuitry and a user-defined read pattern stored in configuration registers as the training pattern data driven during the host receiver training mode. The selection may be indicated by a pattern selection field within the host receiver training control register in the configuration and status registers block 392, which may be decoded by the command decoder and control logic block 391. When the pseudo-random bit sequence is selected, the training pattern data is derived from the LFSR outputs with per-lane XOR-tap combinations and optional per-lane inversion control as described herein for the pattern-generation circuitry. When the user-defined read pattern is selected, the training pattern data is read from dedicated read pattern configuration registers within the configuration and status registers block 392.

The user-defined read pattern may be, or may include, a clock pattern. The host receiver training pattern selection register is a register separate from the write data training mode pattern selection register within the configuration and status registers block 392, so that the memory controller 200 may select a pseudo-random bit sequence for one mode and a user-defined pattern for the other mode, or may select the same pattern source for both modes, independently. The dedicated read pattern configuration registers may be, or may include, three mode registers covering all 24 unit intervals of the burst length, consistent with the LFSR seed and write pattern registers described herein for the write data training mode.

In various aspects described herein, a memory controller (e.g., the memory controller 200) may comprise circuitry configured to cause a memory device to enter a host receiver training mode, to issue a read command to the memory device during the host receiver training mode, to receive training pattern data driven by the memory device onto a plurality of data lanes in response to the read command, and to determine, within the memory controller, an error indication based on the received training pattern data and an expected data pattern. The expected data pattern against which the memory controller compares the received training pattern data may be generated within the memory controller by a pattern-generation circuit, or may be stored in the memory controller as a fixed pattern. The error indication determined within the memory controller may be used to calibrate receiver parameter settings of the memory controller for the physical memory channel between the memory controller and the memory device. This circuitry configured for the host receiver training mode may operate in combination with circuitry configured to transmit write data during a write data training mode and to access an error indication from the memory device, or may operate independently of such circuitry. In an example, the circuitry may include the training and calibration engine 294, the command and address generator 292, and the physical layer circuit 291 of the memory controller 200.

In an example, the training and calibration engine 294 of the memory controller 200, together with the command and address generator 292 and the physical layer circuit 291, may implement the circuitry configured to cause the memory device 300 to enter the host receiver training mode, to issue read commands to the memory device 300, to receive training pattern data driven by the memory device 300, and to determine, within the memory controller 200, an error indication. The finite-state machine within the training and calibration engine 294 can direct the command and address generator 292 to issue configuration-register commands of a write type for host receiver training mode entry, pattern selection, seed programming, and mode exit, and to issue read commands to the memory device 300.

The memory controller 200 (e.g., via receiver circuits of the physical layer circuit 291) captures the training pattern data driven by the memory device 300 onto the data lanes of the physical memory channel 121. The response capture path within the training and calibration engine 294 routes the captured training pattern data from the physical layer circuit 291 to the comparison logic within the training and calibration engine 294. The comparison logic compares the captured training pattern data against an expected data pattern held internally by the expected data pattern source within the training and calibration engine 294. The expected data pattern source may be, or may include, a LFSR implementing the same characteristic polynomial as the LFSR within the memory device 300, or a stored copy of the user-defined read pattern. The comparison logic produces the error indication, which is stored in the internal result storage structure of the training and calibration engine 294.

In an example, the memory controller 200 (e.g., the training and calibration engine 294 of the memory controller 200) adjusts a receiver parameter setting of the memory controller 200 based on the error indication determined within the memory controller 200 during the host receiver training mode. The receiver parameter control logic within the training and calibration engine 294 may modify the operating characteristics of the receiver circuits within the physical layer circuit 291, for example adjusting receiver timing offset, reference voltage, or decision feedback equalization coefficients, on a per-lane or per-sub-channel basis. The adjustment may be performed after the training and calibration engine 294 has determined the error indication for one or more bursts of training pattern data received at a current receiver parameter setting. The receiver parameter control logic then advances to a next candidate receiver parameter setting.

The adjustment of receiver parameter settings based on the error indication determined within the memory controller 200 during the host receiver training mode is analogous to the adjustment of transmit parameter settings based on the error indication accessed from the memory device during the write data training mode, with the distinction that the error indication in the host receiver training mode is determined locally within the memory controller 200 rather than being retrieved from the memory device 300 via configuration-register read commands. In an example, the receiver parameter control logic may also direct the command and address generator 292 to issue configuration-register commands to the memory device 300 to modify receiver-side characteristics of the memory device 300, such as the reference voltage applied at the transmitter of the memory device 300, in combination with adjusting the receiver parameter settings of the memory controller 200.

In an example, the memory controller 200 (e.g., the training and calibration engine 294) issues a plurality of successive read commands to the memory device 300 during the host receiver training mode. For each successive read command or group of successive read commands, the memory device 300 drives a corresponding burst of training pattern data onto the data lane interface 301, and the memory controller 200 (e.g., the receiver circuits of the physical layer circuit 291) captures the training pattern data. The memory controller 200, via the training and calibration engine 294, determines respective error indications within the memory controller 200 for the training pattern data received in response to the successive read commands with different respective receiver parameter settings of the memory controller 200. The memory controller 200 (e.g., via the finite-state machine within the training and calibration engine 294) may orchestrate this sweep by setting a receiver parameter value via the receiver parameter control logic, directing the command and address generator 292 to issue one or more read commands, evaluating the training pattern data captured by the physical layer circuit 291 against the expected data pattern, storing the resulting error indication in the internal result storage structure, and advancing to the next receiver parameter value.

The memory controller 200 may perform this iterative receiver parameter calibration during an initialization phase of the computing system 100 and additionally or alternatively during a mission mode of the memory device, for example to compensate for receiver drift arising from thermal variation, supply voltage variation, or end-of-life degradation of the physical memory channel 121. The calibration results may be stored in the internal result storage structure and applied to the receiver parameter control logic for use during normal operation of the physical memory channel 121.

In aspects described herein, a memory device (e.g., via corresponding operations of the data lane interface 301, the I/O and physical layer interface block 380 including the driver circuits, the internal data processing block 360 including the serializer, the pattern-generation circuitry within or associated with the pattern-check and data comparison block 399, the configuration and status registers block 392, and the command decoder and control logic block 391) may implement the host receiver training mode as the sole training mode supported. The pattern-check and data comparison block 399 may be configured solely to generate training pattern data for driving onto the data lane interface 301. The configuration and status registers block 392 may include the host receiver training control register, the LFSR seed and read pattern registers, and the pattern inversion control registers as described herein.

In aspects described herein, the training and calibration engine 294, the command and address generator 292, and the physical layer circuit 291 may implement the host receiver training mode as the sole training mode supported. The training and calibration engine 294 may include the receiver parameter control logic, the expected data pattern source, and the comparison logic for determining the error indication within the memory controller, without including the transmit parameter sweep logic and the response capture path for configuration-register read commands described herein for the write data training mode. The physical layer circuit 291 may include the receiver circuits for capturing training pattern data, without including the transmit parameter control logic described herein for the write data training mode. The command and address generator 292 may be configured to generate read commands and configuration-register commands for host receiver training mode entry, configuration, and exit, without being configured to generate write commands for write data training mode bursts. This embodiment illustrates that the host receiver training mode may be a self-contained feature of the memory controller, implementable without dependency on the write data training mode circuitry.

In an example, the memory device may be configured to drive training pattern data onto at least one data lane of the plurality of data lanes during an idle period of a physical memory channel between the memory controller and the memory device. The idle period may be, or may include, a period during which no read data or write data associated with a normal memory access operation is being transferred on the data lanes of the physical memory channel. The driving of training pattern data during the idle period may be performed in the host receiver training mode as described herein. In the context of the memory device 300, the I/O and physical layer interface block 380 may drive the training pattern data generated by the pattern-generation circuitry within or associated with the pattern-check and data comparison block 399 onto the data lane interface 301 during idle periods identified by the command decoder and control logic block 391. The idle period may be, or may include, a period during the mission mode of the memory device in which the command decoder and control logic block 391 detects that no pending read or write commands are queued. Driving training pattern data during idle periods may support host DQ receiver drift compensation during the mission mode of the memory device, by permitting the memory controller 200 to receive training pattern data and calibrate receiver parameter settings without interrupting normal memory access operations. The memory controller 200 may invoke the host receiver training mode to coincide with detected idle periods on the physical memory channel 121.

In an example, a user-defined pattern used as an expected data pattern or as training pattern data may operate at a data rate of the data lanes. The user-defined pattern may be, or may include, a user-defined write pattern for the write data training mode or a user-defined read pattern for the host receiver training mode, as described herein. The user-defined pattern operating at the data rate of the data lanes may provide an option for system-level optimization on drift terms, including receiver data-to-strobe timing drift that may occur between a data strobe signal and data signals on the data lanes. In the context of the memory device 300, the pattern-check and data comparison block 399 may source the user-defined pattern from the configuration and status registers block 392 and apply the user-defined pattern at the operating data rate of the data lane interface 301, where each bit of the user-defined pattern corresponds to one unit interval. For the write data training mode, the user-defined write pattern stored in the configuration and status registers block 392 may be used as the expected data pattern against which received write data is compared. For the host receiver training mode, the user-defined read pattern stored in the configuration and status registers block 392 may be driven onto the data lane interface 301 as training pattern data. The user-defined pattern may be, or may include, a clock pattern as described herein, in which the pattern alternates between logic values at every unit interval.

In an example, the LFSR within the memory device may be configurable in a shift register loading mode in which a seed value is loaded into the register stages under control of a configuration-register command. The shift register loading mode may be, or may include, a mode selected by a shift register mode field within the write training mode control register or the host receiver training control register of the memory device 300, which may be decoded by the command decoder and control logic block 391. In the shift register loading mode, a multiplexer within the pattern-generation circuitry may select an external load input in preference to the normal feedback path of the LFSR, permitting the memory controller 200 to load arbitrary seed values into the LFSR via successive configuration-register commands of a write type. When the shift register mode field is cleared, the multiplexer may select the normal feedback path, and the LFSR may operate in its normal pattern-generation mode. The shift register loading mode may be applicable to both the write data training mode and the host receiver training mode, using the respective shift register mode field in the respective control register. In the context of the memory device 300, the shift register mode field may be, or may include, a bit at a designated operand position within the write training mode control register or the host receiver training control register of the configuration and status registers block 392, as described herein.

In an example, the memory device may be configured such that a timing constraint applicable to configuration-register read commands issued during the write data training mode differs from a timing constraint applicable to configuration-register read commands issued during normal operation of the memory device. The dedicated timing constraint applicable during the write data training mode may be referred to as tMRR_WTM. The command decoder and control logic block 391 of the memory device 300 may enforce the tMRR_WTM timing when the write data training mode is active, as indicated by the write data training mode enable bit in the configuration and status registers block 392. The memory controller 200 may observe the tMRR_WTM timing constraint when issuing successive configuration-register read commands via the command and address generator 292 during the write data training mode, as directed by the training and calibration engine 294. The tMRR_WTM timing constraint may be shorter than or longer than the timing constraint applicable to configuration-register read commands during normal operation, depending on the operating parameters of the memory interface standard in use. The use of a dedicated timing constraint during the write data training mode may permit the memory controller 200 to read error indications at a rate optimized for the training sequence, potentially reducing the overall duration of the write data training mode. The tMRR_WTM timing constraint may be, or may include, a minimum time between successive configuration-register read commands issued during the write data training mode.

In an example, the memory controller may be configured to drive, on a strobe conductor of the physical memory channel, a write preamble period preceding a burst of write data during the write data training mode and a write postamble period following the burst of write data during the write data training mode. The write preamble period and the write postamble period may correspond to those used during normal write operations of the memory device. The write preamble period may be, or may include, a period designated tWPRE during which the data strobe transitions from an idle state to an active toggling state, as described herein. The write postamble period may be, or may include, a period designated tWPST during which the data strobe returns to its idle state following the final unit interval of the burst, as described herein.

In the context of the memory controller 200, the physical layer circuit 291 drives the write preamble and write postamble on the write clock or strobe conductor of the physical memory channel 121. The memory device 300 uses the write preamble to acquire strobe lock via the write clock receiver within the I/O and physical layer interface block 380 before sampling the incoming write data at each unit interval boundary defined by the write clock or strobe input 302. The write preamble and write postamble may frame each burst of write data transmitted during the write data training mode.

In an example, the memory device may be configured to, in response to a configuration-register command received from the memory controller, selectively invert the expected data pattern for an individual data lane of the plurality of data lanes independently of a per-lane XOR-tap combination applied to that data lane by the pattern-generation circuitry. The per-lane pattern inversion may be, or may include, the per-lane inversion control described herein, in which a pattern inversion control register within the configuration and status registers block 392 of the memory device 300 provides a per-lane inversion bit for each data lane of the data lane interface 301.

The per-lane inversion bit may be set or cleared by a configuration-register command of a write type issued by the memory controller 200 and decoded by the command decoder and control logic block 391. The inversion may be applied within the pattern-check and data comparison block 399 between the XOR-tap output of the shared LFSR and the comparison logic, for the write data training mode, or between the XOR-tap output and the driving logic, for the host receiver training mode, for each data lane. The per-lane pattern inversion and the per-lane XOR-tap assignment are programmed via separate configuration-register commands and may be set independently of one another. Correspondingly, the memory controller 200 can vary the polarity of the expected data pattern or the training pattern data on a per-lane basis without altering the XOR-tap combination assigned to each data lane.

In an example, a number of LFSR instances within the memory device may be determined by a device width configuration of the memory device. A device width configuration in which the memory device exposes three data lanes per sub-channel, referred to as an x3 configuration, or six data lanes per sub-channel, referred to as an x6 configuration, may employ one LFSR per per-sub-channel domain 397 of the memory device. A device width configuration in which the memory device exposes twelve data lanes per sub-channel, referred to as an x12 configuration, may employ two LFSRs per per-sub-channel domain 397, one LFSR serving a first group of six data lanes and the other LFSR serving a second group of six data lanes.

In the context of the memory device 300, each LFSR instance resides within the pattern-generation circuitry of the pattern-check and data comparison block 399 of the respective per-sub-channel domain 397. The number of configuration registers associated with the LFSR may also be determined by the device width configuration: for the x3, x6, and related configurations, three mode registers may be allocated per per-sub-channel domain 397 for the LFSR seed, and for the x12 configuration, three additional mode registers may be allocated to support the second group of data lanes. This aspect applies to both the write data training mode and the host receiver training mode.

In an example, the memory device may be configured to drive, on a data strobe conductor associated with a data lane of the plurality of data lanes, a read preamble period preceding a burst of training pattern data during the host receiver training mode and a read postamble period following the burst of training pattern data. The read preamble period and the read postamble period may correspond to those driven during normal read operations of the memory device. The read preamble period may be, or may include, a period designated tRPRE during which the data strobe transitions from an idle state to an active toggling state, as described herein. The read postamble period may be, or may include, a period designated tRPST during which the data strobe returns to its idle state following the final unit interval of the burst, as described herein. In the context of the memory device 300, the data strobe driver within the I/O and physical layer interface block 380 generates the data strobe signal with the read preamble period and the read postamble period. The memory controller 200 uses the read preamble to acquire strobe lock via the receiver circuits of the physical layer circuit 291 before capturing the training pattern data at each unit interval boundary. The read preamble and read postamble may frame each burst of training pattern data driven during the host receiver training mode, analogously to how the write preamble and write postamble frame each burst of write data during the write data training mode as described herein.

In an example, the memory controller may be configured to invoke the host receiver training mode during a mission mode of the memory device to compensate for receiver drift at the memory controller. Receiver drift may be, or may include, a change in a receiver characteristic of the receiver circuits within the physical layer circuit 291 of the memory controller 200, arising from thermal variation, supply voltage variation, or aging of the physical memory channel 121 or of the memory controller 200 circuitry. The training and calibration engine 294 of the memory controller 200 may invoke the host receiver training mode periodically during the mission mode by issuing configuration-register commands to the memory device 300 to enter the host receiver training mode, issuing read commands to receive training pattern data, determining error indications within the training and calibration engine 294, and re-calibrating the receiver parameter settings. The updated receiver parameter settings may be applied to the receiver parameter control logic within the training and calibration engine 294 for continued use during normal memory access operations. This periodic re-invocation during the mission mode may be performed concurrently with or between normal memory access operations, and may not require the computing system 100 to return to the initialization phase. The mission mode invocation of the host receiver training mode is analogous to the mission mode invocation of the write data training mode as described herein.

In an example, the pattern-generation circuitry of the memory device may be configured to generate the expected data pattern for the write data training mode and to generate the training pattern data for the host receiver training mode using a common characteristic polynomial implemented by the LFSR. The common characteristic polynomial may be, or may include, the polynomial X²⁴+X²⁰+X¹¹+X⁵+1 as described herein. In the context of the memory device 300, the LFSR within the pattern-check and data comparison block 399 of each per-sub-channel domain 397 may implement the common characteristic polynomial for both modes. The common characteristic polynomial ensures that the pseudo-random bit sequence generated as training pattern data during the host receiver training mode has the same sequence properties and period as the pseudo-random bit sequence generated as the expected data pattern during the write data training mode. When the same LFSR hardware is shared between the two modes, the common characteristic polynomial is inherently the same. When separate LFSR instances are used for the two modes, the configuration registers governing the respective instances may specify the same characteristic polynomial. The common polynomial, in combination with the same default seed value and the same per-lane XOR-tap assignments, produces identical training pattern data and expected data pattern sequences for both the write data training mode and the host receiver training mode when initialized from the same seed state, as described herein.

In an example, the memory device may be configured to select, in response to a first configuration-register command, a pattern source for the write data training mode independently of a pattern source for the host receiver training mode, and to select, in response to a second configuration-register command, the pattern source for the host receiver training mode independently of the pattern source for the write data training mode. The first configuration-register command may target the write training mode control register within the configuration and status registers block 392 of the memory device 300, and the second configuration-register command may target the host receiver training control register within the configuration and status registers block 392. The pattern source for each mode may be, or may include, a pseudo-random bit sequence generated by the pattern-generation circuitry or a user-defined pattern stored in configuration registers, as described herein. Each control register includes a pattern selection field, and the pattern selection field of the write training mode control register is independent of the pattern selection field of the host receiver training control register. This independent selection permits the memory controller 200 to configure different pattern sources for the two modes. For example, the memory controller 200 may select a pseudo-random bit sequence as the expected data pattern for the write data training mode and a user-defined read pattern as the training pattern data for the host receiver training mode, or vice versa, according to the requirements of the link calibration strategy.

In an example, the memory device may be configured to, in response to a configuration-register command of a write type setting a seed reset field, reset a state of the LFSR to a default seed value and reset the staging flip-flops to a default staging value, and to automatically clear the seed reset field after the reset is performed. The seed reset field may be, or may include, a bit within the write training mode control register or the host receiver training control register within the configuration and status registers block 392 of the memory device 300. The command decoder and control logic block 391 decodes the configuration-register command and directs the pattern-generation circuitry within or associated with the pattern-check and data comparison block 399 to load the default seed value into the LFSR and to load the default staging value of 11111 into the five staging flip-flops. After the reset is performed, logic within the configuration and status registers block 392 or within the command decoder and control logic block 391 automatically clears the seed reset field without requiring a further configuration-register command from the memory controller 200. The automatic clear of the seed reset field ensures that a subsequent read of the control register reflects the idle state of the seed reset function. The default seed value may be F7310E in hexadecimal notation as described herein. The seed reset function with automatic clear applies to both the write data training mode and the host receiver training mode, using the respective seed reset field in the respective control register.

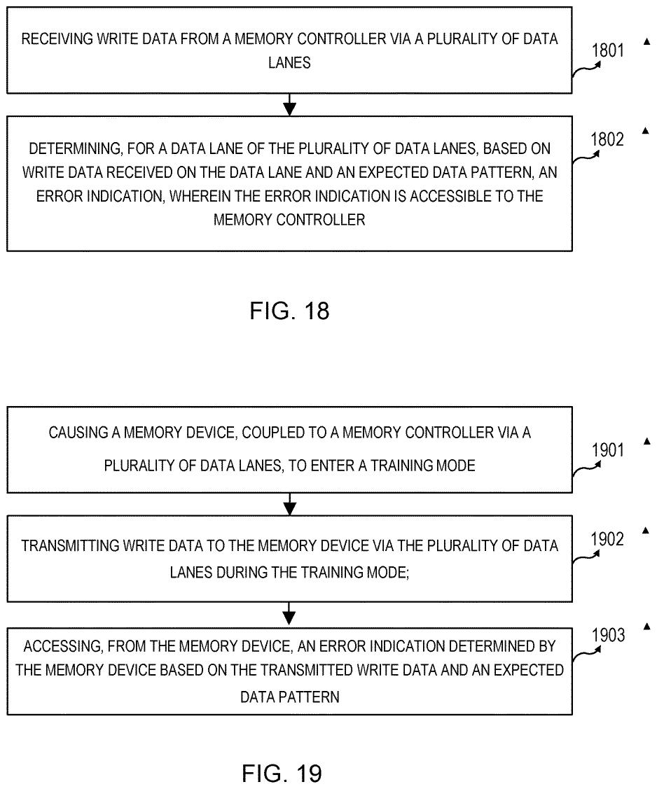

FIG. 18 shows an example of a method. The method includes receiving 1801 write data from a memory controller via a plurality of data lanes; and determining 1802, for a data lane of the plurality of data lanes, based on write data received on the data lane and an expected data pattern, an error indication, wherein the error indication is accessible to the memory controller. The method may be performed by a memory device coupled to the memory controller.

FIG. 19 shows an example of a method. The method includes causing 1901 a memory device, coupled to a memory controller via a plurality of data lanes, to enter a training mode; transmitting 1902 write data to the memory device via the plurality of data lanes during the training mode; and accessing 1903, from the memory device, an error indication determined by the memory device based on the transmitted write data and an expected data pattern. The method may be performed by the memory controller.

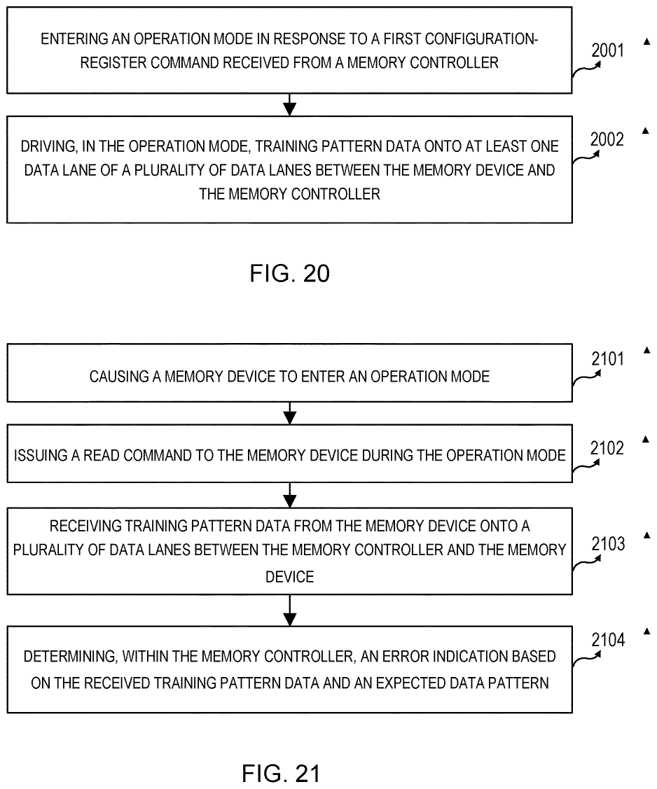

FIG. 20 shows an example of a method. The method includes entering 2001 an operation mode in response to a first configuration-register command received from a memory controller; and driving 2002, in the operation mode, training pattern data onto at least one data lane of a plurality of data lanes between the memory device and the memory controller. The method may be performed by the memory device.

FIG. 21 shows an example of a method. The method includes causing 2101 a memory device to enter an operation mode; issuing 2102 a read command to the memory device during the operation mode; receiving 2103 training pattern data from the memory device onto a plurality of data lanes between the memory controller and the memory device; and determining 2104, within the memory controller, an error indication based on the received training pattern data and an expected data pattern. The method may be performed by the memory controller.

The detailed description refers to the accompanying drawings that show, by way of illustration, specific details and aspects of this disclosure in which the disclosure may be practiced. Other aspects may be utilized and structural, logical, and electrical changes may be made without departing from the scope of the disclosure. The various aspects of this disclosure are not necessarily mutually exclusive, as some aspects of this disclosure can be combined with one or more other aspects of this disclosure to form new aspects.

Throughout the drawings, it should be noted that like reference numbers are used to depict the same or similar elements, features, and structures, unless otherwise noted.

The word “exemplary” is used herein to mean “serving as an example, instance, or illustration”. Any aspect or design described herein as “exemplary” is not necessarily to be construed as preferred or advantageous over other aspects or designs.

The phrase “at least one” and “one or more” may be understood to include a numerical quantity greater than or equal to one (e.g., one, two, three, four, [ . . . ], etc.). The phrase “at least one of” with regard to a group of elements may be used herein to mean at least one element from the group consisting of the elements. For example, the phrase “at least one of” with regard to a group of elements may be used herein to mean a selection of: one of the listed elements, a plurality of one of the listed elements, a plurality of individual listed elements, or a plurality of a multiple of individual listed elements.

The words “plural” and “multiple” in the description and in the claims expressly refer to a quantity greater than one. Accordingly, any phrases explicitly invoking the aforementioned words (e.g., “plural [elements]”, “multiple [elements]”) referring to a quantity of elements expressly refers to more than one of the said elements. For instance, the phrase “a plurality” may be understood to include a numerical quantity greater than or equal to two (e.g., two, three, four, five, [ . . . ], etc.).

The phrases “group (of)”, “set (of)”, “collection (of)”, “series (of)”, “sequence (of)”, “grouping (of)”, etc., in the description and in the claims, if any, refer to a quantity equal to or greater than one, i.e., one or more. The terms “proper subset”, “reduced subset”, and “lesser subset” refer to a subset of a set that is not equal to the set, illustratively, referring to a subset of a set that contains less elements than the set.

Further, spatially relative terms, such as “beneath,” “below,” “lower,” “above,” “upper” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly.

As used herein, unless otherwise specified the use of the ordinal adjectives “first”, “second”, “third” etc., to describe a common object, merely indicate that different instances of like objects are being referred to, and are not intended to imply that the objects so described must be in a given sequence, either temporally, spatially, in ranking, or in any other manner.

As utilized herein, terms “module”, “component,” “system,” “circuit,” “element,” “slice,” “circuitry,” and the like are intended to refer to a set of one or more electronic components, a computer-related entity, hardware, software (e.g., in execution), and/or firmware. For example, circuitry or a similar term can be a processor, a process running on a processor, a controller, an object, an executable program, a storage device, and/or a computer with a processing device. By way of illustration, an application running on a server and the server can also be circuitry. One or more circuits can reside within the same circuitry, and circuitry can be localized on one computer and/or distributed between two or more computers. A set of elements or a set of other circuits can be described herein, in which the term “set” can be interpreted as “one or more.”

It will be understood that when an element is referred to as being “connected” or “coupled” to another element, it can be physically connected or coupled to the other element such that current and/or electromagnetic radiation (e.g., a signal) can flow along a conductive path formed by the elements. Intervening conductive, inductive, or capacitive elements may be present between the element and the other element when the elements are described as being coupled or connected to one another. Further, when coupled or connected to one another, one element may be capable of inducing a voltage or current flow or propagation of an electro-magnetic wave in the other element without physical contact or intervening components. Further, when a voltage, current, or signal is referred to as being “applied” to an element, the voltage, current, or signal may be conducted to the element by way of a physical connection or by way of capacitive, electro-magnetic, or inductive coupling that does not involve a physical connection.

The following examples pertain to further aspects of this disclosure.

Example 1 includes the subject matter of a memory device, including: a plurality of data lanes configured to receive write data from a memory controller; processing circuitry configured to compare, for each data lane of the plurality of data lanes, write data received on the data lane against a respective expected data pattern to determine a respective per-lane error indication; and one or more status registers configured to store the per-lane error indicators, wherein the per-lane error indications are accessible to the memory controller.

Example 2 may include the memory device of example 1, wherein the processing circuitry is configured to determine the per-lane error indications in a write data training mode of the memory device.

Example 3 may include the memory device of example 2, wherein the memory device is configured to enter or exit the write data training mode in response to one or more configuration-register commands received from the memory controller.

Example 4 may include the memory device of any one of examples 1 to 3, wherein the memory device is configured to provide the per-lane error indications to the memory controller in response to a configuration-register read command received from the memory controller, and to clear the per-lane error indications in response to a command received from the memory controller.

Example 5 may include the memory device of any one of examples 1 to 4, wherein the write data received on the data lane is part of a burst of write data transmitted by the memory controller over a plurality of unit intervals.

Example 6 may include the memory device of example 5, wherein the per-lane error indications includes a plurality of phase-specific error indications, each phase-specific error indication being associated with a respective subset of the plurality of unit intervals.

Example 7 may include the memory device of any one of examples 1 to 6, wherein the memory device is configured to determine the per-lane error indications in response to a plurality of successive bursts of write data corresponding to different transmit parameter settings of the memory controller, during an initialization phase of a computing system including the memory device and/or during a mission mode of the memory device.

Example 8 may include the memory device of any one of examples 1 to 7, may further include pattern-generation circuitry configured to generate, within the memory device, the expected data pattern as a pseudo-random bit sequence.

Example 9 may include the memory device of example 8, wherein the memory device is configured to select, in response to a configuration-register command received from the memory controller, between the pseudo-random bit sequence and a clock pattern as the expected data pattern.

Example 10 may include the memory device of example 8, wherein the pattern-generation circuitry includes a linear feedback shift register, LFSR, shared among the plurality of data lanes, and wherein expected data patterns for different data lanes of the plurality of data lanes are derived from different combinations of taps of the LFSR.

Example 11 may include the memory device of example 10, wherein the LFSR is a Fibonacci LFSR implementing a polynomial X²⁴+X²⁰+X¹¹+X⁵+1.

Example 12 may include the memory device of example 10 or example 11, wherein the LFSR is configured to update a state thereof once every N clock periods of a clock signal of the memory device, where N is an integer greater than one.

Example 13 may include the memory device of any one of examples 1 to 12, wherein the processing circuitry is configured to, for each data lane of the plurality of data lanes, determine, based on write data received on that data lane and a respective expected data pattern for that data lane, a respective error indication, and wherein each respective error indication is accessible to the memory controller.

Example 14 may include the memory device of example 13, wherein the respective expected data patterns for different data lanes of the plurality of data lanes differ from one another.

Example 15 may include the memory device of example 14, may further include pattern-generation circuitry shared among the plurality of data lanes and configured to provide the respective expected data patterns based on different respective combinations of outputs of the pattern-generation circuitry.

Example 16 may include the memory device of any one of examples 1 to 15, wherein the memory device further includes circuitry configured to, in a host receiver training mode of the memory device, drive training pattern data onto at least one data lane of the plurality of data lanes in response to a read command received from the memory controller.

Example 17 may include the memory device of example 16, wherein the memory device is configured to enter or exit the host receiver training mode in response to one or more configuration-register commands received from the memory controller.

Example 18 may include the memory device of example 16 or example 17, wherein the training pattern data is driven onto the at least one data lane with a timing and strobe sequence corresponding to a regular read operation of the memory device, such that successive read commands produce successive bursts of the training pattern data on the at least one data lane.

Example 19 may include the memory device of any one of examples 16 to 18, may further include pattern-generation circuitry shared between the write data training mode and the host receiver training mode, the pattern-generation circuitry being configured to generate the expected data pattern for the write data training mode and to generate the training pattern data for the host receiver training mode.

Example 20 may include the memory device of any one of examples 16 to 19, wherein the memory device is configured to select, in response to a configuration-register command received from the memory controller, between a pseudo-random bit sequence generated by pattern-generation circuitry within the memory device and a user-defined read pattern as the training pattern data driven during the host receiver training mode.

Example 21 may include the subject matter of a memory controller, including circuitry configured to: cause a memory device, coupled to the memory controller via a plurality of data lanes, to enter a training mode; transmit write data to the memory device via the plurality of data lanes during the training mode; and access, from the memory device, an error indication determined by the memory device based on the transmitted write data and an expected data pattern.

Example 22 may include the memory controller of example 21, wherein the processing circuitry is configured to cause the memory device to enter or exit the write data training mode by issuing one or more configuration-register commands to the memory device.

Example 23 may include the memory controller of example 21 or example 22, wherein the processing circuitry is configured to access the error indication by issuing a configuration-register read command to the memory device, and to cause the memory device to clear the error indication by issuing a command to the memory device.

Example 24 may include the memory controller of any one of examples 21 to 23, wherein the processing circuitry is configured to transmit the write data as a burst of write data over a plurality of unit intervals, and to select, by issuing a configuration-register command to the memory device, between a pseudo-random bit sequence and a clock pattern as the expected data pattern.

Example 25 may include the memory controller of any one of examples 24 to 25, wherein the processing circuitry is configured to transmit a plurality of successive bursts of write data to the memory device with different respective transmit parameter settings of the memory controller, and to access respective error indications from the memory device for the plurality of successive bursts, during an initialization phase of a computing system including the memory controller and/or during a mission mode of the memory device.

Example 26 may include the memory controller of any one of examples 21 to 25, wherein the error indication includes a plurality of per-lane error indications each corresponding to a respective data lane of the plurality of data lanes, and wherein each per-lane error indication includes a plurality of phase-specific error indications each associated with a respective subset of unit intervals of a burst of the transmitted write data.

Example 27 may include the memory controller of any one of examples 21 to 26, wherein the processing circuitry is further configured to: cause the memory device to enter a host receiver training mode; issue a read command to the memory device during the host receiver training mode; receive training pattern data driven by the memory device onto the plurality of data lanes in response to the read command; and determine an error indication based on the received training pattern data and an expected data pattern.

Example 28 may include the memory controller of example 27, wherein the processing circuitry is configured to adjust a receiver parameter setting of the memory controller based on the error indication determined within the memory controller during the host receiver training mode.

Example 29 may include the memory controller of example 27 or example 28, wherein the processing circuitry is configured to issue a plurality of successive read commands to the memory device during the host receiver training mode, and to determine respective error indications within the memory controller with different respective receiver parameter settings, during an initialization phase of a computing system including the memory controller and/or during a mission mode of the memory device.

Example 30 may include a computing system including the memory device of any one of the examples 1 to 20 and the memory controller of any one of the examples 21 to 29.

Example 31 may include the subject matter of a method to be performed by a memory device, the method including: receiving write data from a memory controller via a plurality of data lanes; and comparing, for each data lane of the plurality of data lanes, write data received on the data lane against a respective expected data pattern to determine a respective per-lane error indication; storing the per-lane error indications, wherein the per-lane error indications are accessible to the memory controller.

Example 32 may include the method of example 31, wherein determining the per-lane error indications is performed in a write data training mode of the memory device.

Example 33 may include the method of example 32, further including entering or exiting the write data training mode in response to one or more configuration-register commands received from the memory controller.

Example 34 may include the method of any one of examples 31 to 33, further including storing the per-lane error indications in one or more status registers; providing the per-lane error indications to the memory controller in response to a configuration-register read command received from the memory controller; and clearing the per-lane error indications in response to a command received from the memory controller.

Example 35 may include the method of any one of examples 31 to 34, wherein the write data received on the data lane is part of a burst of write data transmitted by the memory controller over a plurality of unit intervals.

Example 36 may include the method of example 35, wherein the per-lane error indications includes a plurality of phase-specific error indications, each phase-specific error indication being associated with a respective subset of the plurality of unit intervals.

Example 37 may include the method of any one of examples 31 to 36, further including determining respective per-lane error indications in response to a plurality of successive bursts of write data corresponding to different transmit parameter settings of the memory controller, during an initialization phase of a computing system including the memory device and/or during a mission mode of the memory device.

Example 38 may include the method of any one of examples 31 to 37, further including generating, within the memory device, the expected data pattern as a pseudo-random bit sequence.

Example 39 may include the method of example 38, further including selecting, in response to a configuration-register command received from the memory controller, between the pseudo-random bit sequence and a clock pattern as the expected data pattern.

Example 40 may include the method of example 38, wherein generating the expected data pattern includes operating a linear feedback shift register, LFSR, shared among the plurality of data lanes, and deriving expected data patterns for different data lanes of the plurality of data lanes from different combinations of taps of the LFSR.

Example 41 may include the method of example 40, wherein the LFSR is a Fibonacci LFSR implementing a polynomial X²⁴+X²⁰+X¹¹+X⁵+1.

Example 42 may include the method of example 40 or example 41, further including updating a state of the LFSR once every N clock periods of a clock signal of the memory device, where N is an integer greater than one.

Example 43 may include the method of any one of examples 31 to 42, further including determining, for each data lane of the plurality of data lanes, based on write data received on that data lane and a respective expected data pattern for that data lane, a respective per-lane error indications, wherein each respective error indication is accessible to the memory controller.

Example 44 may include the method of example 43, wherein the respective expected data patterns for different data lanes of the plurality of data lanes differ from one another.

Example 45 may include the method of example 44, wherein the respective expected data patterns are provided by pattern-generation circuitry shared among the plurality of data lanes and configured to provide the respective expected data patterns based on different respective combinations of outputs of the pattern-generation circuitry.

Example 46 may include the method of any one of examples 31 to 45, further including, in a host receiver training mode of the memory device, driving training pattern data onto at least one data lane of the plurality of data lanes in response to a read command received from the memory controller.

Example 47 may include the method of example 46, further including entering or exiting the host receiver training mode in response to one or more configuration-register commands received from the memory controller.

Example 48 may include the method of example 46 or example 47, wherein the training pattern data is driven onto the at least one data lane with a timing and strobe sequence corresponding to a regular read operation of the memory device, such that successive read commands produce successive bursts of the training pattern data on the at least one data lane.

Example 49 may include the method of any one of examples 46 to 48, further including sharing pattern-generation circuitry between the write data training mode and the host receiver training mode; generating, via the pattern-generation circuitry, the expected data pattern for the write data training mode; and generating the training pattern data for the host receiver training mode.

Example 50 may include the method of any one of examples 46 to 49, further including selecting, in response to a configuration-register command received from the memory controller, between a pseudo-random bit sequence generated by pattern-generation circuitry within the memory device and a user-defined read pattern as the training pattern data driven during the host receiver training mode.

Example 51 may include the subject matter of a method to be performed by a memory controller, the method including: causing a memory device, coupled to the memory controller via a plurality of data lanes, to enter a training mode; transmitting write data to the memory device via the plurality of data lanes during the training mode; and accessing, from the memory device, an error indication determined by the memory device based on the transmitted write data and an expected data pattern.

Example 52 may include the method of example 51, wherein causing the memory device to enter or exit the write data training mode includes issuing one or more configuration-register commands to the memory device.

Example 53 may include the method of example 51 or example 52, wherein accessing the error indication includes issuing a configuration-register read command to the memory device, and further including causing the memory device to clear the error indication by issuing a command to the memory device.

Example 54 may include the method of any one of examples 51 to 53, wherein transmitting the write data includes transmitting the write data as a burst of write data over a plurality of unit intervals, and further including selecting, by issuing a configuration-register command to the memory device, between a pseudo-random bit sequence and a clock pattern as the expected data pattern.

Example 55 may include the method of any one of examples 51 to 54, further including transmitting a plurality of successive bursts of write data to the memory device with different respective transmit parameter settings of the memory controller, and accessing respective error indications from the memory device for the plurality of successive bursts, during an initialization phase of a computing system including the memory controller and/or during a mission mode of the memory device.

Example 56 may include the method of any one of examples 51 to 55, wherein the error indication includes a plurality of per-lane error indications each corresponding to a respective data lane of the plurality of data lanes, and wherein each per-lane error indication includes a plurality of phase-specific error indications each associated with a respective subset of unit intervals of a burst of the transmitted write data.

Example 57 may include the method of any one of examples 51 to 56, further including causing the memory device to enter a host receiver training mode; issuing a read command to the memory device during the host receiver training mode; receiving training pattern data driven by the memory device onto the plurality of data lanes in response to the read command; and determining an error indication based on the received training pattern data and an expected data pattern.

Example 58 may include the method of example 57, further including adjusting a receiver parameter setting of the memory controller based on the error indication determined within the memory controller during the host receiver training mode.

Example 59 may include the method of example 57 or example 58, further including issuing a plurality of successive read commands to the memory device during the host receiver training mode; and determining respective error indications within the memory controller with different respective receiver parameter settings, during an initialization phase of a computing system including the memory controller and/or during a mission mode of the memory device.

Example 60 may include a method to be performed by a memory device, the method including: entering an operation mode in response to a first configuration-register command received from a memory controller; and driving, in the operation mode, training pattern data onto at least one data lane of a plurality of data lanes between the memory device and the memory controller.

Example 61 may include the method of example 60, may further include driving the training pattern data onto the at least one data lane of the plurality of data lanes in response to a read command received from the memory controller.

Example 62 may include the method of example 61, wherein the operation mode is a host receiver training mode and wherein the method further includes entering or exiting the host receiver training mode in response to one or more configuration-register commands received from the memory controller.

Example 63 may include the method of any one of examples 60 to 62, wherein the training pattern data is driven onto the at least one data lane with a timing and strobe sequence corresponding to a regular read operation of the memory device, such that successive read commands produce successive bursts of the training pattern data on the at least one data lane.

Example 64 may include the method of any one of examples 60 to 63, further including sharing pattern-generation circuitry between a write data training mode and the operation mode; generating, via the pattern-generation circuitry, the expected data pattern for the write data training mode; and generating the training pattern data for the operating mode.

Example 65 may include the method of any one of examples 60 to 63, wherein the method further includes the method of any one of examples 31 to 50.

Example 66 may include a method to be performed by a memory controller, the method including: causing a memory device to enter an operation mode; issuing a read command to the memory device during the operation mode; receiving training pattern data from the memory device onto a plurality of data lanes between the memory controller and the memory device; and determining, within the memory controller, an error indication based on the received training pattern data and an expected data pattern.

Example 67 may include the method of example 66, may further include adjusting a receiver parameter setting of the memory controller based on the error indication determined within the memory controller during the host receiver training mode.

Example 68 may include the method of example 66 or 67 further including issuing a plurality of successive read commands to the memory device during the host receiver training mode; and determining respective error indications within the memory controller with different respective receiver parameter settings, during an initialization phase of a computing system including the memory controller and/or during a mission mode of the memory device.

Example 69 may include the method of any one of examples 66 to 68, wherein the method further includes the method of any one of examples 51 to 56.

Example 70 may include an apparatus including means to perform the methods of any one of examples 31 to 69.

A non-transitory computer-readable medium comprising instructions which, if executed by a processor, cause the processor to perform the method of any one of examples 31 to 69.

Example 71 may include a memory device including: a plurality of data lanes configured to communicate with a memory controller; and circuitry configured to enter an operation mode in response to a first configuration-register command received from the memory controller; and drive, in the operation mode, training pattern data onto at least one data lane of a plurality of data lanes between the memory device and the memory controller;

Example 72 may include the memory device of example 71, wherein the memory device is further configured to perform aspects described in any one of examples 1 to 20 or any other aspects described herein.

Example 73 may include a memory controller including: a plurality of data lanes configured to communicate with a memory device; and circuitry configured to: cause the memory device to enter an operation mode; issue a read command to the memory device during the operation mode; receive training pattern data from the memory device onto the plurality of data lanes; and determine, within the memory controller, an error indication based on the received training pattern data and an expected data pattern.

Example 74 may include a memory controller configured to perform any aspects described here, including write data training mode-related aspects and/or host receiver training mode-related aspects.

Example 75 may include a memory device configured to perform any aspects described here, including write data training mode-related aspects and/or host receiver training mode-related aspects.

Example 76 may include a computing system configured to perform any aspects described here, including write data training mode-related aspects and/or host receiver training mode-related aspects.

Example 77 includes a non-transitory computer-readable medium comprising instructions which, if executed by processing circuitry, cause the processing circuitry o perform the method of any one of examples 31 to 69.

What is claimed is:

1. A memory device, comprising:
a plurality of data lanes configured to receive write data from a memory controller;
processing circuitry configured to compare, for each data lane of the plurality of data lanes, write data received on the data lane against a respective expected data pattern to determine a respective per-lane error indication; and
one or more status registers configured to store the per-lane error indications, wherein the per-lane error indications are accessible to the memory controller.

2. The memory device of claim 1, wherein the processing circuitry is configured to determine the per-lane error indications in a write data training mode of the memory device.

3. The memory device of claim 2, wherein the memory device is configured to enter or exit the write data training mode in response to one or more configuration-register commands received from the memory controller.

4. The memory device of claim 1, wherein the memory device is configured to provide the per-lane error indications to the memory controller in response to a configuration-register read command received from the memory controller, and to clear the per-lane error indications in response to a command received from the memory controller.

5. The memory device of claim 1, wherein the memory device is configured to determine the per-lane error indications in response to a plurality of successive bursts of write data corresponding to different transmit parameter settings of the memory controller, during an initialization phase of a computing system comprising the memory device and/or during a mission mode of the memory device.

6. The memory device of claim 1, further comprising pattern-generation circuitry configured to generate, within the memory device, the expected data pattern as a pseudo-random bit sequence.

7. The memory device of claim 6, wherein the memory device is configured to select, in response to a configuration-register command received from the memory controller, between the pseudo-random bit sequence and a clock pattern as the expected data pattern.

8. The memory device of claim 6, wherein the pattern-generation circuitry comprises a linear feedback shift register, LFSR, shared among the plurality of data lanes, and wherein expected data patterns for different data lanes of the plurality of data lanes are derived from different combinations of taps of the LFSR.

9. The memory device of claim 8, wherein the LFSR is a Fibonacci LFSR implementing a polynomial X²⁴+X²⁰+X¹¹+X⁵+1.

10. The memory device of claim 1, wherein each respective error indication is accessible to the memory controller.

11. The memory device of claim 10, wherein the respective expected data patterns for different data lanes of the plurality of data lanes differ from one another.

12. The memory device of claim 1, wherein the memory device further comprises circuitry configured to, in a host receiver training mode of the memory device, drive training pattern data onto at least one data lane of the plurality of data lanes in response to a read command received from the memory controller.

13. A memory controller, comprising processing circuitry configured to:
cause a memory device, coupled to the memory controller via a plurality of data lanes, to enter a training mode;
transmit write data to the memory device via the plurality of data lanes during the training mode; and
access, from the memory device, an error indication determined by the memory device based on the transmitted write data and an expected data pattern.

14. The memory controller of claim 13, wherein the processing circuitry is configured to cause the memory device to enter or exit the write data training mode by issuing one or more configuration-register commands to the memory device.

15. The memory controller of claim 13, wherein the processing circuitry is configured to access the error indication by issuing a configuration-register read command to the memory device, and to cause the memory device to clear the error indication by issuing a command to the memory device.

16. The memory controller of claim 13, wherein the error indication comprises a plurality of per-lane error indications each corresponding to a respective data lane of the plurality of data lanes, and wherein each per-lane error indication comprises a plurality of phase-specific error indications each associated with a respective subset of unit intervals of a burst of the transmitted write data.

17. The memory controller of claim 13, wherein the processing circuitry is further configured to: cause the memory device to enter a host receiver training mode; issue a read command to the memory device during the host receiver training mode; receive training pattern data driven by the memory device onto the plurality of data lanes in response to the read command; and determine an error indication based on the received training pattern data and an expected data pattern.

18. The memory controller of claim 17, wherein the processing circuitry is configured to adjust a receiver parameter setting of the memory controller based on the error indication determined within the memory controller during the host receiver training mode.

19. A memory controller comprising:
a plurality of data lanes configured to communicate with a memory device; and
processing circuitry configured to: cause the memory device to enter an operation mode;
issue a read command to the memory device during the operation mode; receive training pattern data from the memory device onto the plurality of data lanes; and determine, within the memory controller, an error indication based on the received training pattern data and an expected data pattern.

20. The memory controller of claim 19, wherein the processing circuitry is configured to adjust a receiver parameter setting of the memory controller based on the error indication determined within the memory controller during the host receiver training mode.
